(19) United States
(12) Patent Application Publication
(10) Pub. No.: US 2019/0342874 A1
(43) Pub. Date: Nov. 7, 2019

(54) Interlace-Based Uplink Physical Channel Design for New Radio-Unlicensed (NR-U)

(71) Applicant: Intel Corporation, Santa Clara, CA (US)

(72) Inventors: Alexei Davydov, Nizhny Novgorod (RU); Alexey Vladimirovich Khoryaev, Nizhny Novgorod (RU); Alexander Sirotkin, Tel-Aviv (IL); Seunghee Han, San Jose, CA (US); Debdeep Chatterjee, San Jose, CA (US); Sergey Panteleev, Nizhny Novgorod (RU); Hong He, Beijing (CN); Gang Xiong, Beaverton, OR (US); Hwan-Joon Kwon, Portland, OR (US); Jeongho Jeon, San Jose, CA (US); Jie Cui, Santa Clara, CA (US); Sergey Sosnin, Zavolzhie (RU); Yi Guo, Shanghai (CN); Seau S. Lim, Swindon (GB); Fatemeh Hamidi-Sepehr, Santa Clara, CA (US); Bishwarup Mondal, San Ramon, CA (US); Lopamudra Kundu, Sunnyvale, CA (US); Yongjun Kwak, Portland, OR (US); Toufiqul Islam, Santa Clara, CA (US)

(21) Appl. No.: 16/402,480

(22) Filed: May 3, 2019

Related U.S. Application Data
(60) Provisional application No. 62/674,229, filed on May 21, 2018.
(60) Provisional application No. 62/672,391, filed on May 16, 2018.
(60) Provisional application No. 62/670,577, filed on May 11, 2018.
(60) Provisional application No. 62/670,645, filed on May 11, 2018.
(60) Provisional application No. 62/667,266, filed on May 4, 2018.

(51) Int. Cl. H04W 72/04; H04L 5/00

(52) U.S. Cl. CPC H04W 72/0413; H04L 5/0094

(57) ABSTRACT

A user equipment (UE) can include processing circuitry coupled to memory. To configure the UE for New Radio (NR) unlicensed band (NR-U) communications, the processing circuitry is to decode downlink control information (DCI) received via a physical downlink control channel (PDCCH). The DCI provides allocation of uplink frequency resources of a transmission bandwidth. The allocation is a block interleaved frequency division multiple access (B-IFDMA) allocation including a plurality of interleaved physical resource blocks (PRBs) forming M number of interlaces within the transmission bandwidth, and N number of PRBs within each interlace of the M number of interlaces, with N and M being integers greater than or equal to 1. Data is encoded for transmission to a base station via a physical uplink shared channel (PUSCH) using the B-IFDMA allocation of uplink frequency resources.

### PRIORITY CLAIM

This application claims the benefit of priority to the following applications:

U.S. Provisional Patent Application Ser. No. 62/672,391, filed May 16, 2018, and entitled “ENHANCED UE POSITIONING IN LTE AND NR RADIO ACCESS TECHNOLOGIES,”

U.S. Provisional Patent Application Ser. No. 62/667,266, filed May 4, 2018, and entitled “TWO-OPERATION RANDOM ACCESS CHANNEL (RACH) FOR NEW RADIO (NR) SYSTEMS;”

U.S. Provisional Patent Application Ser. No. 62/670,577, filed May 11, 2018, and entitled “TWO-OPERATION RANDOM ACCESS CHANNEL (RACH) FOR NEW RADIO (NR) SYSTEMS;”

U.S. Provisional Patent Application Ser. No. 62/670,645, filed May 11, 2018, and entitled “MECHANISMS FOR HANDLING PARALLEL DOWNLINK TRANSMISSIONS BY A USER EQUIPMENT (UE);” and

U.S. Provisional Patent Application Ser. No. 62/674,229, filed May 21, 2018, and entitled “RADIO RESOURCE MANAGEMENT RRM ENHANCEMENTS FOR UNLICENSED BAND OPERATION IN NEW RADIO (NR) SYSTEMS.”

Each of the above-identified provisional patent applications is incorporated herein by reference in its entirety.

### TECHNICAL FIELD

Aspects pertain to wireless communications. Some aspects relate to wireless networks including 3GPP (Third Generation Partnership Project) networks, 3GPP LTE (Long Term Evolution) networks, 3GPP LTE-A (LTE Advanced) networks, and fifth-generation (5G) networks including 5G new radio (NR) (or 5G-NR) networks and 5G-LTE networks. Other aspects are directed to systems and methods for enhanced UE positioning in LTE and NR radio access technologies. Additional aspects are directed to systems and methods for 2-step random access channel (RACH) design for NR. Yet other aspects are related to systems and methods for handling parallel downlink transmissions by a UE. Further aspects are related to NR radio resource management (RRM) enhancements for unlicensed band operation. Yet other aspects are directed to uniform and non-uniform interlace-based uplink (UL) physical channel design for NR-unlicensed band (NR-U) communications.

### BACKGROUND

Mobile communications have evolved significantly from early voice systems to today's highly sophisticated integrated communication platform. With the increase in different types of devices communicating with various network devices, usage of 3GPP LTE systems has increased. The penetration of mobile devices (user equipment or UEs) in modern society has continued to drive demand for a wide variety of networked devices in a number of disparate environments. Fifth generation (5G) wireless systems are forthcoming, and are expected to enable even greater speed, connectivity, and usability. Next generation 5G networks (or NR networks) are expected to increase throughput, coverage, and robustness and reduce latency and operational and capital expenditures. 5G-NR networks will continue to evolve based on 3GPP LTE-Advanced with additional potential new radio access technologies (RATs) to enrich people's lives with seamless wireless connectivity solutions delivering fast, rich content and services. As current cellular network frequency is saturated, higher frequencies, such as millimeter wave (mmWave) frequency, can be beneficial due to their high bandwidth.

Potential LTE operation in the unlicensed spectrum includes (and is not limited to) the LTE operation in the unlicensed spectrum via dual connectivity (DC), or DC-based LAA, and the standalone LTE system in the unlicensed spectrum, according to which LTE-based technology solely operates in unlicensed spectrum without requiring an “anchor” in the licensed spectrum, called MulteFire. MulteFire combines the performance benefits of LTE technology with the simplicity of Wi-Fi-like deployments. Additional operations in the unlicensed spectrum include NR-U type communications in the unlicensed band.

Further enhanced operation of LTE systems in the licensed as well as unlicensed spectrum is expected in future releases and 5G systems. Such enhanced operations can include techniques to address UE positioning, RACH procedure design, parallel downlink (DL) transmissions, NR RRM enhancements for unlicensed band operations, and interlace-based UL physical channel design for NR-U communications.

### BRIEF DESCRIPTION OF THE FIGURES

In the figures, which are not necessarily drawn to scale, like numerals may describe similar components in different views. Like numerals having different letter suffixes may represent different instances of similar components. The figures illustrate generally, by way of example, but not by way of limitation, various aspects discussed in the present document.

FIG. 1A illustrates an architecture of a network in accordance with some aspects.

FIG. 1B is a simplified diagram of an overall next generation (NG) system architecture in accordance with some aspects.

FIG. 1C illustrates an example MulteFire Neutral Host Network (NHN) 5G architecture in accordance with some aspects.

FIG. 1D illustrates a functional split between next generation radio access network (NG-RAN) and the 5G Core network (5GC) in accordance with some aspects.

FIG. 1E and FIG. 1F illustrate a non-roaming 5G system architecture in accordance with some aspects.

FIG. 1G illustrates an example Cellular Internet-of-Things (CIoT) network architecture in accordance with some aspects.

FIG. 1H illustrates an example Service Capability Exposure Function (SCEF) in accordance with some aspects.

FIG. 1I illustrates an example roaming architecture for SCEF in accordance with some aspects.

FIG. 1J illustrates an example Evolved Universal Terrestrial Radio Access (E-UTRA) New Radio Dual Connectivity (EN-DC) architecture in accordance with some aspects.

FIG. 2 illustrates example components of a device 200 in accordance with some aspects.

FIG. 3 illustrates example interfaces of baseband circuitry in accordance with some aspects.

FIG. 4 is an illustration of a control plane protocol stack in accordance with some aspects.

FIG. 5 is an illustration of a user plane protocol stack in accordance with some aspects.

FIG. 6 is a block diagram illustrating components, according to some example aspects, able to read instructions from a machine-readable or computer-readable medium (e.g., a non-transitory machine-readable storage medium) and perform any one or more of the methodologies discussed herein.

FIG. 7 is an illustration of an initial access procedure including PRACH preamble retransmission in accordance with some aspects.

FIG. 8 illustrates an example of communication exchange for the recording of received signal waveforms and reporting, in accordance with some aspects.

FIG. 9 illustrates an example of communication exchange for estimation and reporting of channel impulse response (CIR) or channel transfer function (CTF), in accordance with some aspects.

FIG. 10 illustrates a four-step PRACH procedure, in accordance with some aspects.

FIG. 11 illustrates a two-step PRACH procedure, in accordance with some aspects.

FIG. 12A illustrates resource configuration for two-step PRACH procedure, in accordance with some aspects.

FIG. 12B illustrates TDM multiplexing between Msg-1 and Msg-3 (inside Msg-A), in accordance with some aspects.

FIG. 12C illustrates FDM multiplexing between Msg-1 and Msg-3 (inside Msg-A), in accordance with some aspects.

FIG. 13 illustrates configuring symbols within a slot for receiving a non-preemptible low latency transmission, in accordance with some aspects.

FIG. 14 illustrates UE behavior for handling parallel downlink transmissions when assigned resources to two PDSCH are orthogonal, in accordance with some aspects.

FIG. 15 illustrates UE behavior for handling parallel downlink transmissions when assigned resources to three PDSCH are orthogonal, in accordance with some aspects.

FIG. 16 illustrates UE behavior for handling parallel downlink transmissions in connection with orthogonal resources assignment for parallel transmissions, in accordance with some aspects.

FIG. 17 illustrates UE behavior for handling parallel downlink transmissions in connection with overlapping resources assignment for parallel transmissions, in accordance with some aspects.

FIG. 18 illustrates UE behavior for handling parallel downlink transmissions in connection with overlapping resources assignment for parallel transmissions, in accordance with some aspects.

FIG. 19 illustrates UE behavior for handling parallel downlink transmissions in connection with overlapping resources assignment for parallel transmissions, in accordance with some aspects.

FIG. 20 illustrates NR wide channel bandwidth, in accordance with some aspects.

FIG. 21 illustrates an example of a PRB based uniform interlace including two interlaces with 12 PRBs per interlace, in accordance with some aspects.

FIG. 22 illustrates an example of sub-PRB based uniform interlace including six interlaces with 12 sub-PRBs per interlace, in accordance with some aspects.

FIG. 23A illustrates an example of PRB based non-uniform interlace including six interlaces with 11 PRBs per interlace and four interlaces with 10 PRBs per interlace, in accordance with some aspects.

FIG. 23B illustrates an example of PRB based non-uniform interlace for communications using 30 kHz subcarrier spacing (SCS), in accordance with some aspects.

FIG. 24 illustrates an example of numerology scalable, PRB based uniform and non-uniform interlace design, in accordance with some aspects.

FIG. 25 illustrates a block diagram of a communication device such as an evolved Node-B (eNB), a new generation Node-B (gNB), an access point (AP), a wireless station (STA), a mobile station (MS), or a user equipment (UE), in accordance with some aspects.

### DETAILED DESCRIPTION

The following description and the drawings sufficiently illustrate aspects to enable those skilled in the art to practice them. Other aspects may incorporate structural, logical, electrical, process, and other changes. Portions and features of some aspects may be included in or substituted for, those of other aspects. Aspects set forth in the claims encompass all available equivalents of those claims.

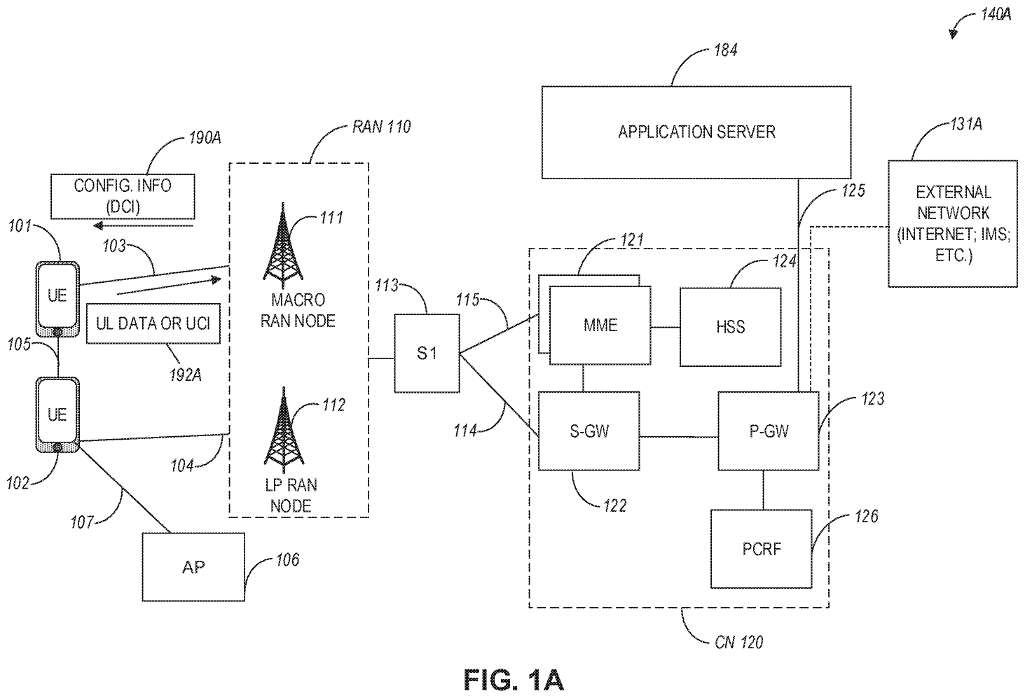

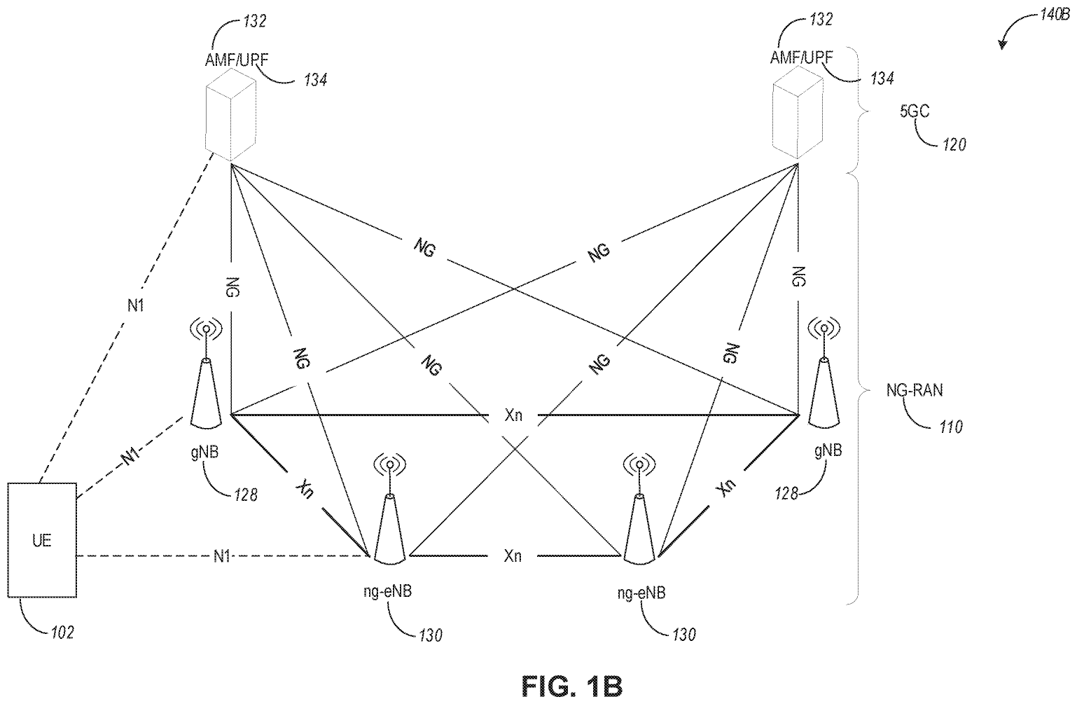

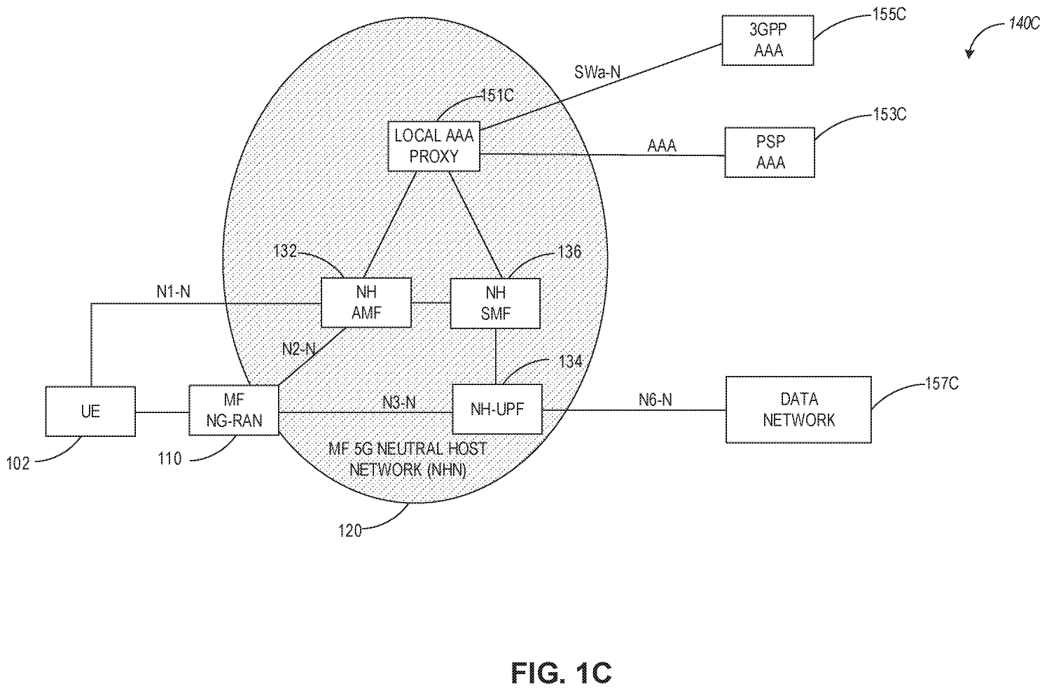

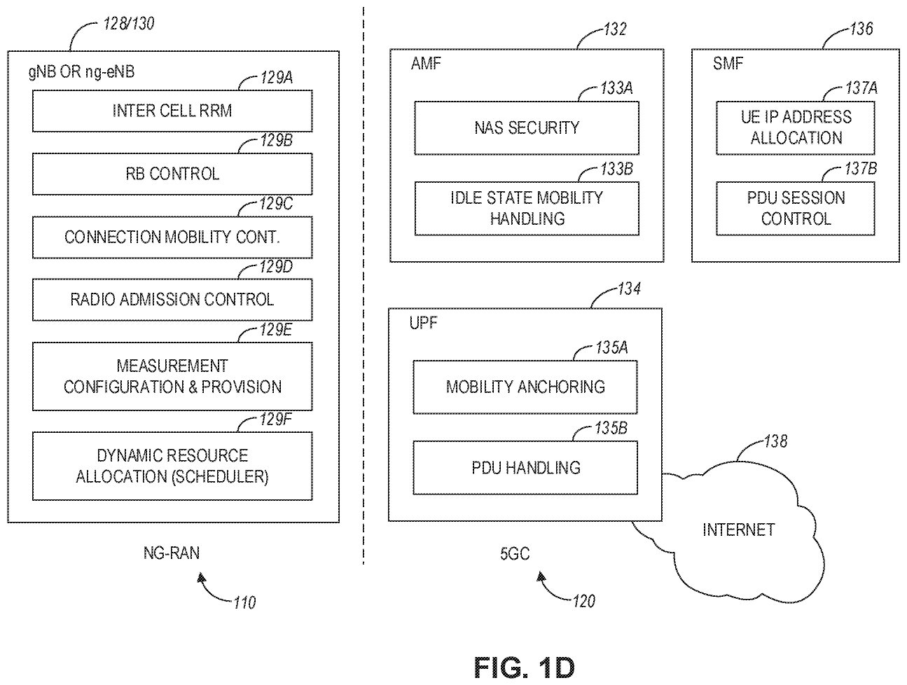

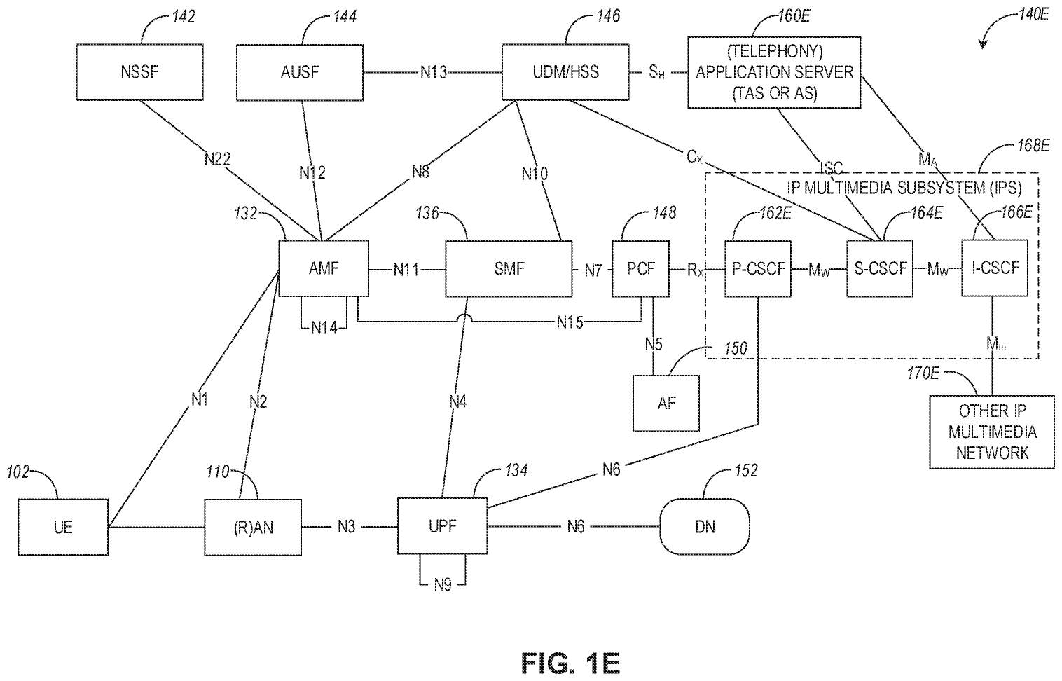

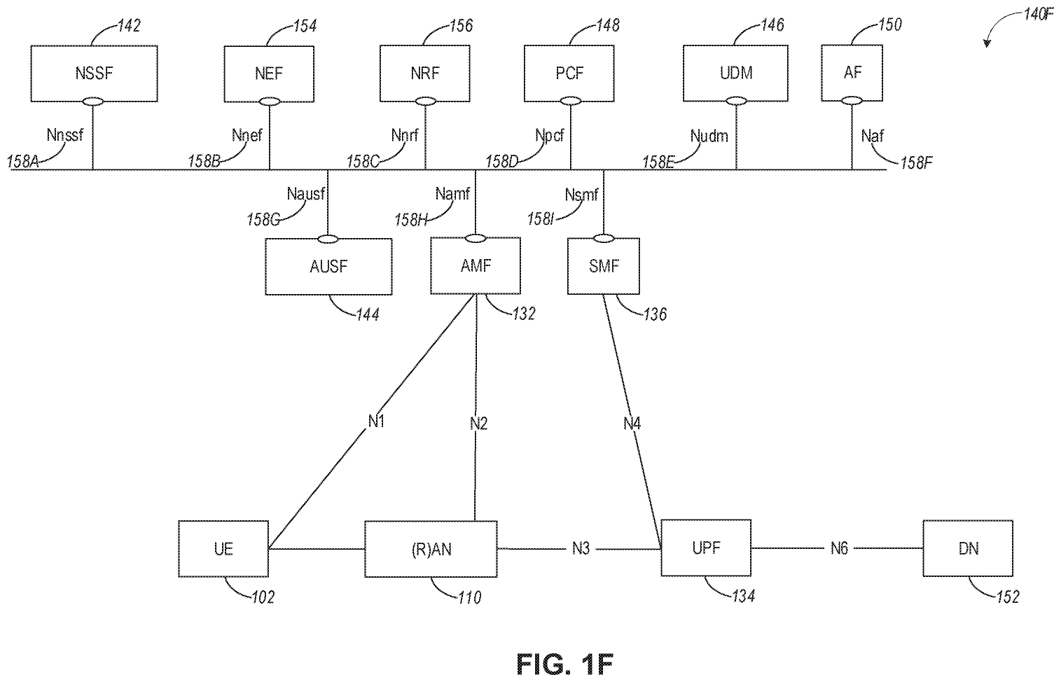

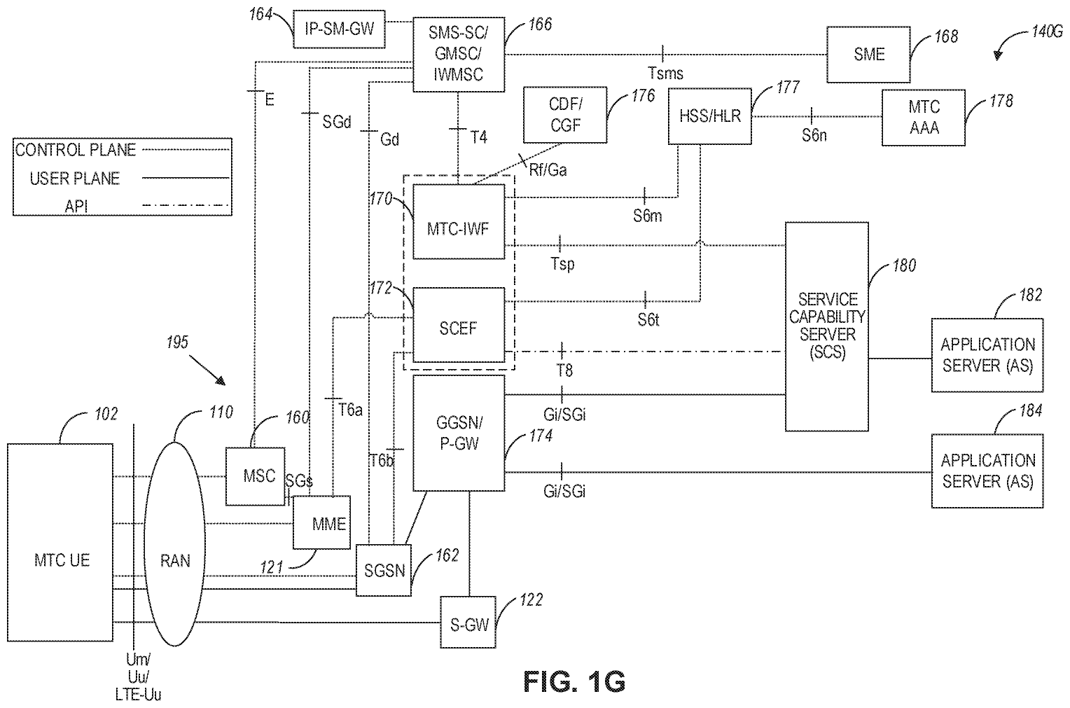

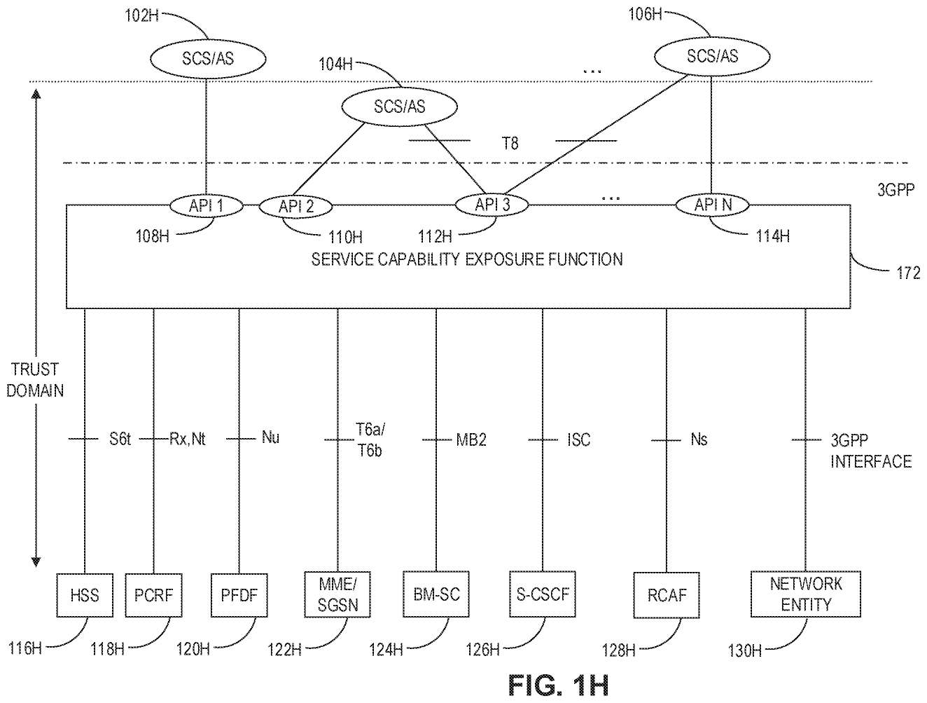

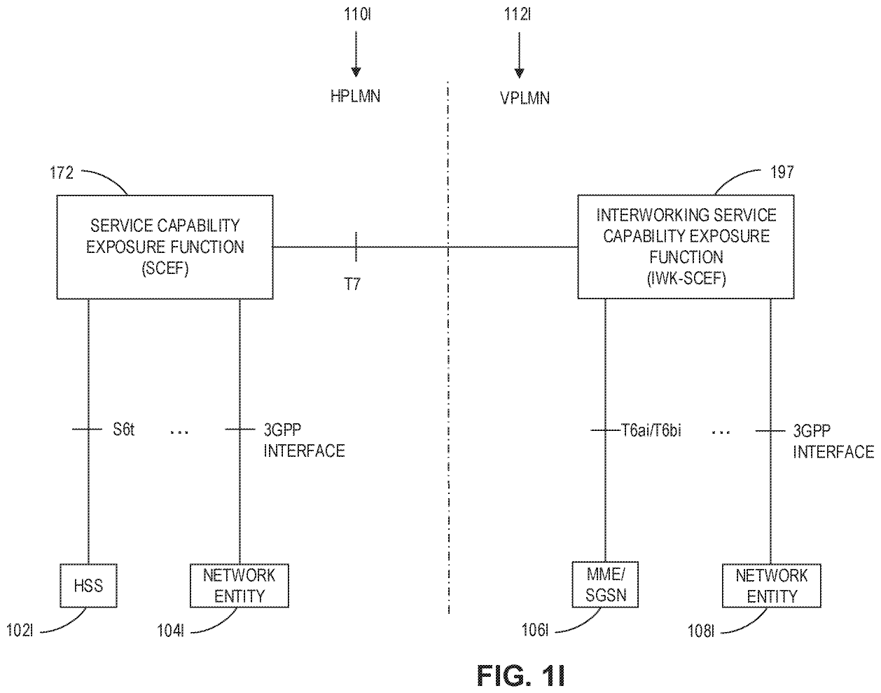

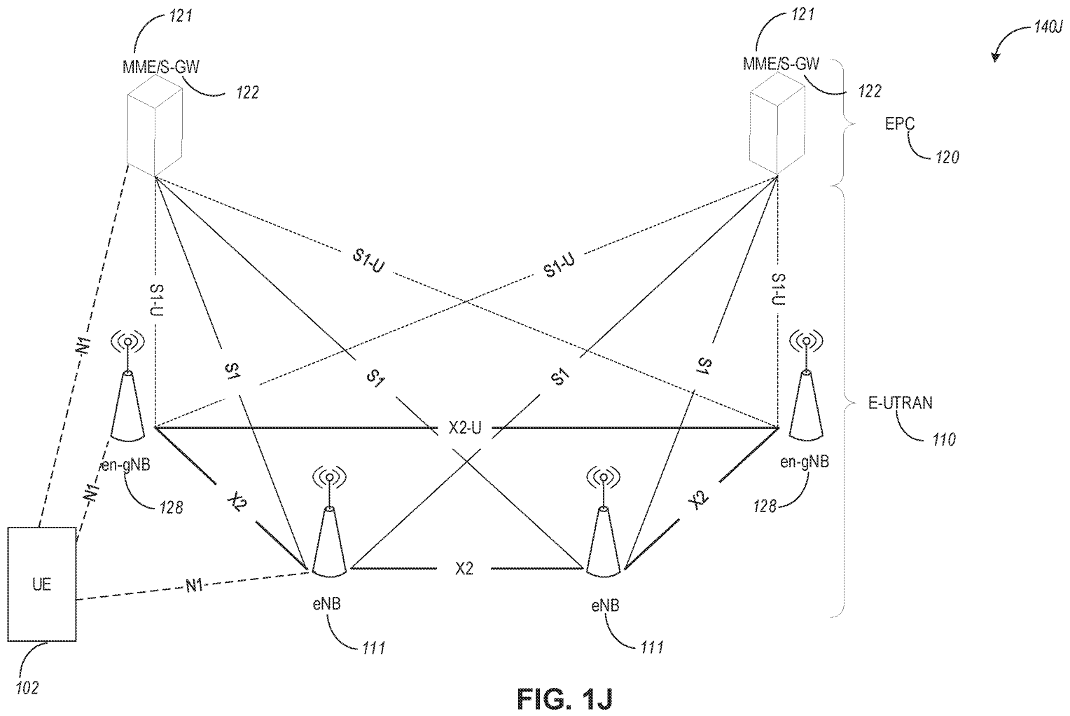

FIG. 1A illustrates an architecture of a network in accordance with some aspects. The network 140A is shown to include user equipment (UE) 101 and a UE 102. The UEs 101 and 102 are illustrated as smartphones (e.g., handheld touchscreen mobile computing devices connectable to one or more cellular networks), but may also comprise any mobile or non-mobile computing device, such as Personal Data Assistants (PDAs), pagers, laptop computers, desktop computers, wireless handsets, drones, or any other computing device including a wired and/or wireless communications interface.

Any of the radio links described herein (e.g., as used in the network 140A or any other illustrated network) may operate according to any one or more of the following exemplary radio communication technologies and/or standards including, but not limited to: a Global System for Mobile Communications (GSM) radio communication technology, a General Packet Radio Service (GPRS) radio communication technology, an Enhanced Data Rates for GSM Evolution (EDGE) radio communication technology, and/or a Third Generation Partnership Project (3GPP) radio communication technology, for example Universal Mobile Telecommunications System (UMTS), Freedom of Multimedia Access (FOMA), 3GPP Long Term Evolution (LTE), 3GPP Long Term Evolution Advanced (LTE Advanced), Code division multiple access 2000 (CDMA2000), Cellular Digital Packet Data (CDPD), Mobitex, Third Generation (3G), Circuit Switched Data (CSD), High-Speed Circuit-Switched Data (HSCSD), Universal Mobile Telecommunications System (Third Generation) (UMTS (3G)), Wideband Code Division Multiple Access (Universal Mobile Telecommunications System) (W-CDMA (UMTS)), High Speed Packet Access (HSPA), High-Speed Downlink Packet Access (HSDPA), High-Speed Uplink Packet Access (HSUPA), High Speed Packet Access Plus (HSPA+), Universal Mobile Telecommunications System-Time-Division Duplex (UMTS-TDD), Time Division-Code Division Multiple Access (TD-CDMA), Time Division-Synchronous Code Division Multiple Access (TD-CDMA), 3rd Generation Partnership Project Release 8 (Pre-4th Generation) (3GPP Rel. 8 (Pre-4G)), 3GPP Rel. 9 (3rd Generation Partnership Project Release 9), 3GPP Rel. 10 (3rd Generation Partnership Project Release 10), 3GPP Rel. 11 (3rd Generation Partnership Project Release 11), 3GPP Rel. 12 (3rd Generation Partnership Project Release 12), 3GPP Rel. 13 (3rd Generation Partnership Project Release 13), 3GPP Rel. 14 (3rd Generation Partnership Project Release 14), 3GPP Rel. 15 (3rd Generation Partnership Project Release 15), 3GPP Rel. 16 (3rd Generation Partnership Project Release 16), 3GPP Rel. 17 (3rd Generation Partnership Project Release 17), 3GPP Rel. 18 (3rd Generation Partnership Project Release 18), 3GPP 5G or 5G-NR, 3GPP LTE Extra, LTE-Advanced Pro, LTE Licensed-Assisted Access (LAA), MulteFire, UMTS Terrestrial Radio Access (UTRA), Evolved UMTS Terrestrial Radio Access (E-UTRA), Long Term Evolution Advanced (4th Generation) (LTE Advanced (4G)), cdmaOne (2G), Code division multiple access 2000 (Third generation) (CDMA2000 (3G)), Evolution-Data Optimized or Evolution-Data Only (EV-DO), Advanced Mobile Phone System (1st Generation) (AMPS (1G)), Total Access Communication System/Extended Total Access Communication System (TACS/ETACS), Digital AMPS (2nd Generation) (D-AMPS (2G)), Push-to-talk (PTT), Mobile Telephone System (MTS), Improved Mobile Telephone System (IMTS), Advanced Mobile Telephone System (AMTS), OLT (Norwegian for Offentlig Landmobil Telefoni, Public Land Mobile Telephony), MTD (Swedish abbreviation for Mobiltelefonisystem D, or Mobile telephony system D), Public Automated Land Mobile (Autotel/PALM), ARP (Finnish for Autoradiopuhelin, “car radio phone”), NMT (Nordic Mobile Telephony), High capacity version of NTT (Nippon Telegraph and Telephone) (Hicap), Cellular Digital Packet Data (CDPD), Mobitex, DataTAC, Integrated Digital Enhanced Network (iDEN), Personal Digital Cellular (PDC), Circuit Switched Data (CSD), Personal Handy-phone System (PHS), Wideband Integrated Digital Enhanced Network (WiDEN), iBurst, Unlicensed Mobile Access (UMA), also referred to as also referred to as 3GPP Generic Access Network, or GAN standard), Zigbee, Bluetooth(r), Wireless Gigabit Alliance (WiGig) standard, mmWave standards in general (wireless systems operating at 10-300 GHz and above such as WiGig, IEEE 802.1 lad, IEEE 802.1 lay, and the like), technologies operating above 300 GHz and THz bands, (3GPP/LTE based or IEEE 802.11p and other), Vehicle-to-Vehicle (V2V), Vehicle-to-X (V2X), Vehicle-to-Infrastructure (V2I), and Infrastructure-to-Vehicle (I2V) communication technologies, 3GPP cellular V2X, DSRC (Dedicated Short Range Communications) communication systems such as Intelligent-Transport-Systems and others.

LTE and LTE-Advanced are standards for wireless communications of high-speed data for user equipment (UE) such as mobile telephones. In LTE-Advanced and various wireless systems, carrier aggregation is a technology according to which multiple carrier signals operating on different frequencies may be used to carry communications for a single UE, thus increasing the bandwidth available to a single device. In some aspects, carrier aggregation may be used where one or more component carriers operate on unlicensed frequencies.

There are emerging interests in the operation of LTE systems in the unlicensed spectrum. As a result, an important enhancement for LTE in 3GPP Release 13 has been to enable its operation in the unlicensed spectrum via Licensed-Assisted Access (LAA), which expands the system bandwidth by utilizing the flexible carrier aggregation (CA) framework introduced by the LTE-Advanced system. Rel-13 LAA system focuses on the design of downlink operation on unlicensed spectrum via CA, while Rel-14 enhanced LAA (eLAA) system focuses on the design of uplink operation on unlicensed spectrum via CA.

Aspects described herein can be used in the context of any spectrum management scheme including, for example, dedicated licensed spectrum, unlicensed spectrum, (licensed) shared spectrum (such as Licensed Shared Access (LSA) in 2.3-2.4 GHz, 3.4-3.6 GHz, 3.6-3.8 GHz, and further frequencies and Spectrum Access System (SAS) in 3.55-3.7 GHz and further frequencies). Applicable exemplary spectrum bands include IMT (International Mobile Telecommunications) spectrum (including 450-470 MHz, 790-960 MHz, 1710-2025 MHz, 2110-2200 MHz, 2300-2400 MHz, 2500-2690 MHz, 698-790 MHz, 610-790 MHz, 3400-3600 MHz, to name a few), IMT-advanced spectrum, IMT-2020 spectrum (expected to include 3600-3800 MHz, 3.5 GHz bands, 700 MHz bands, bands within the 24.25-86 GHz range, for example), spectrum made available under the Federal Communications Commission's “Spectrum Frontier” 5G initiative (including 27.5-28.35 GHz, 29.1-29.25 GHz, 31-31.3 GHz, 37-38.6 GHz, 38.6-40 GHz, 42-42.5 GHz, 57-64 GHz, 71-76 GHz, 81-86 GHz and 92-94 GHz, etc), the ITS (Intelligent Transport Systems) band of 5.9 GHz (typically 5.85-5.925 GHz) and 63-64 GHz, bands currently allocated to WiGig such as WiGig Band 1 (57.24-59.40 GHz), WiGig Band 2 (59.40-61.56 GHz), WiGig Band 3 (61.56-63.72 GHz), and WiGig Band 4 (63.72-65.88 GHz); the 70.2 GHz-71 GHz band; any band between 65.88 GHz and 71 GHz; bands currently allocated to automotive radar applications such as 76-81 GHz; and future bands including 94-300 GHz and above. Furthermore, the scheme can be used on a secondary basis on bands such as the TV White Space bands (typically below 790 MHz) where, in particular, the 400 MHz and 700 MHz bands can be employed. Besides cellular applications, specific applications for vertical markets may be addressed, such as PMSE (Program Making and Special Events), medical, health, surgery, automotive, low-latency, drones, and the like.

Aspects described herein can also be applied to different Single Carrier or OFDM flavors (CP-OFDM, SC-FDMA, SC-OFDM, filter bank-based multicarrier (FBMC), OFDMA, etc.) and in particular 3GPP NR (New Radio) by allocating the OFDM carrier data bit vectors to the corresponding symbol resources.

In some aspects, any of the UEs 101 and 102 can comprise an Internet-of-Things (IoT) UE or a Cellular IoT (CIoT) UE, which can comprise a network access layer designed for low-power IoT applications utilizing short-lived UE connections. In some aspects, any of the UEs 101 and 102 can include a narrowband (NB) IoT UE (e.g., such as an enhanced NB-IoT (eNB-IoT) UE and Further Enhanced (FeNB-IoT) UE). An IoT UE can utilize technologies such as machine-to-machine (M2M) or machine-type communications (MTC) for exchanging data with an MTC server or device via a public land mobile network (PLMN), Proximity-Based Service (ProSe) or device-to-device (D2D) communication, sensor networks, or IoT networks. The M2M or MTC exchange of data may be a machine-initiated exchange of data. An IoT network includes interconnecting IoT UEs, which may include uniquely identifiable embedded computing devices (within the Internet infrastructure), with short-lived connections. The IoT UEs may execute background applications (e.g., keep-alive messages, status updates, etc.) to facilitate the connections of the IoT network.

In some aspects, NB-IoT devices can be configured to operate in a single physical resource block (PRB) and may be instructed to retune two different PRBs within the system bandwidth. In some aspects, an eNB-IoT UE can be configured to acquire system information in one PRB, and then it can retune to a different PRB to receive or transmit data.

In some aspects, any of the UEs 101 and 102 can include enhanced MTC (eMTC) UEs or further enhanced MTC (FeMTC) UEs.

The UEs 101 and 102 may be configured to connect, e.g., communicatively couple, with a radio access network (RAN) 110. The RAN 110 may be, for example, an Evolved Universal Mobile Telecommunications System (UMTS) Terrestrial Radio Access Network (E-UTRAN), a NextGen RAN (NG RAN), or some other type of RAN. The UEs 101 and 102 utilize connections 103 and 104, respectively, each of which comprises a physical communications interface or layer (discussed in further detail below); in this example, the connections 103 and 104 are illustrated as an air interface to enable communicative coupling, and can be consistent with cellular communications protocols, such as a Global System for Mobile Communications (GSM) protocol, a code-division multiple access (CDMA) network protocol, a Push-to-Talk (PTT) protocol, a PTT over Cellular (POC) protocol, a Universal Mobile Telecommunications System (UMTS) protocol, a 3GPP Long Term Evolution (LTE) protocol, a fifth generation (5G) protocol, a New Radio (NR) protocol, and the like.

In some aspects, the network 140A can include a core network (CN) 120. Various aspects of NG RAN and NG Core are discussed herein in reference to, e.g., FIG. 1B, FIG. 1C, FIG. 1D, FIG. 1E, FIG. 1F, and FIG. 1G.

In an aspect, the UEs 101 and 102 may further directly exchange communication data via a ProSe interface 105. The ProSe interface 105 may alternatively be referred to as a sidelink interface comprising one or more logical channels, including but not limited to a Physical Sidelink Control Channel (PSCCH), a Physical Sidelink Shared Channel (PSSCH), a Physical Sidelink Discovery Channel (PSDCH), and a Physical Sidelink Broadcast Channel (PSBCH).

The UE 102 is shown to be configured to access an access point (AP) 106 via connection 107. The connection 107 can comprise a local wireless connection, such as, for example, a connection consistent with any IEEE 802.11 protocol, according to which the AP 106 can comprise a wireless fidelity (WiFi®) router. In this example, the AP 106 is shown to be connected to the Internet without connecting to the core network of the wireless system (described in further detail below).

The RAN 110 can include one or more access nodes that enable the connections 103 and 104. These access nodes (ANs) can be referred to as base stations (BSs), NodeBs, evolved NodeBs (eNBs), Next Generation NodeBs (gNBs), RAN nodes, and the like, and can comprise ground stations (e.g., terrestrial access points) or satellite stations providing coverage within a geographic area (e.g., a cell). In some aspects, the communication nodes 111 and 112 can be transmission/reception points (TRPs). In instances when the communication nodes 111 and 112 are NodeBs (e.g., eNBs or gNBs), one or more TRPs can function within the communication cell of the NodeBs. The RAN 110 may include one or more RAN nodes for providing macrocells, e.g., macro RAN node 111, and one or more RAN nodes for providing femtocells or picocells (e.g., cells having smaller coverage areas, smaller user capacity, or higher bandwidth compared to macrocells), e.g., low power (LP) RAN node 112.

Any of the RAN nodes 111 and 112 can terminate the air interface protocol and can be the first point of contact for the UEs 101 and 102. In some aspects, any of the RAN nodes 111 and 112 can fulfill various logical functions for the RAN 110 including, but not limited to, radio network controller (RNC) functions such as radio bearer management, uplink and downlink dynamic radio resource management and data packet scheduling, and mobility management. In an example, any of the nodes 111 and/or 112 can be a new generation node-B (gNB), an evolved node-B (eNB), or another type of RAN node.

In accordance with some aspects, the UEs 101 and 102 can be configured to communicate using Orthogonal Frequency-Division Multiplexing (OFDM) communication signals with each other or with any of the RAN nodes 111 and 112 over a multicarrier communication channel in accordance various communication techniques, such as, but not limited to, an Orthogonal Frequency-Division Multiple Access (OFDMA) communication technique (e.g., for downlink communications) or a Single Carrier Frequency Division Multiple Access (SC-FDMA) communication technique (e.g., for uplink and ProSe for sidelink communications), although such aspects are not required. The OFDM signals can comprise a plurality of orthogonal subcarriers.

In some aspects, a downlink resource grid can be used for downlink transmissions from any of the RAN nodes 111 and 112 to the UEs 101 and 102, while uplink transmissions can utilize similar techniques. The grid can be a time-frequency grid, called a resource grid or time-frequency resource grid, which is the physical resource in the downlink in each slot. Such a time-frequency plane representation may be used for OFDM systems, which makes it applicable for radio resource allocation. Each column and each row of the resource grid may correspond to one OFDM symbol and one OFDM subcarrier, respectively. The duration of the resource grid in the time domain may correspond to one slot in a radio frame. The smallest time-frequency unit in a resource grid may be denoted as a resource element. Each resource grid may comprise a number of resource blocks, which describe the mapping of certain physical channels to resource elements. Each resource block may comprise a collection of resource elements; in the frequency domain, this may, in some aspects, represent the smallest quantity of resources that currently can be allocated. There may be several different physical downlink channels that are conveyed using such resource blocks.

The physical downlink shared channel (PDSCH) may carry user data and higher-layer signaling to the UEs 101 and 102. The physical downlink control channel (PDCCH) may carry information about the transport format and resource allocations related to the PDSCH channel, among other things. It may also inform the UEs 101 and 102 about the transport format, resource allocation, and H-ARQ (Hybrid Automatic Repeat Request) information related to the uplink shared channel. Typically, downlink scheduling (assigning control and shared channel resource blocks to the UE 102 within a cell) may be performed at any of the RAN nodes 111 and 112 based on channel quality information fed back from any of the UEs 101 and 102. The downlink resource assignment information may be sent on the PDCCH used for (e.g., assigned to) each of the UEs 101 and 102.

The PDCCH may use control channel elements (CCEs) to convey the control information. Before being mapped to resource elements, the PDCCH complex-valued symbols may first be organized into quadruplets, which may then be permuted using a sub-block interleaver for rate matching. Each PDCCH may be transmitted using one or more of these CCEs, where each CCE may correspond to nine sets of four physical resource elements known as resource element groups (REGs). Four Quadrature Phase Shift Keying (QPSK) symbols may be mapped to each REG. The PDCCH can be transmitted using one or more CCEs, depending on the size of the downlink control information (DCI) and the channel condition. There can be four or more different PDCCH formats defined in LTE with different numbers of CCEs (e.g., aggregation level, L=1, 2, 4, or 8).

Some aspects may use concepts for resource allocation for control channel information that are an extension of the above-described concepts. For example, some aspects may utilize an enhanced physical downlink control channel (EPDCCH) that uses PDSCH resources for control information transmission. The EPDCCH may be transmitted using one or more enhanced control channel elements (ECCEs). Similar to above, each ECCE may correspond to nine sets of four physical resource elements known as an enhanced resource element groups (EREGs). An ECCE may have other numbers of EREGs according to some arrangements.

The RAN 110 is shown to be communicatively coupled to a core network (CN) 120 via an S1 interface 113. In aspects, the CN 120 may be an evolved packet core (EPC) network, a NextGen Packet Core (NPC) network, or some other type of CN (e.g., as illustrated in reference to FIGS. 1B-1I). In this aspect, the S1 interface 113 is split into two parts: the S1-U interface 114, which carries traffic data between the RAN nodes 111 and 112 and the serving gateway (S-GW) 122, and the S1-mobility management entity (MME) interface 115, which is a signaling interface between the RAN nodes 111 and 112 and MMEs 121.

In this aspect, the CN 120 comprises the MMEs 121, the S-GW 122, the Packet Data Network (PDN) Gateway (P-GW) 123, and a home subscriber server (HSS) 124. The MMEs 121 may be similar in function to the control plane of legacy Serving General Packet Radio Service (GPRS) Support Nodes (SGSN). The MMEs 121 may manage mobility aspects in access such as gateway selection and tracking area list management. The HSS 124 may comprise a database for network users, including subscription-related information to support the network entities' handling of communication sessions. The CN 120 may comprise one or several HSSs 124, depending on the number of mobile subscribers, on the capacity of the equipment, on the organization of the network, etc. For example, the HSS 124 can provide support for routing/roaming, authentication, authorization, naming/addressing resolution, location dependencies, etc.

The S-GW 122 may terminate the S1 interface 113 towards the RAN 110, and routes data packets between the RAN 110 and the CN 120. In addition, the S-GW 122 may be a local mobility anchor point for inter-RAN node handovers and also may provide an anchor for inter-3GPP mobility. Other responsibilities of the S-GW 122 may include lawful intercept, charging, and some policy enforcement.

The P-GW 123 may terminate an SGi interface toward a PDN. The P-GW 123 may route data packets between the EPC network 120 and external networks such as a network including the application server 184 (alternatively referred to as application function (AF)) via an Internet Protocol (IP) interface 125. The P-GW 123 can also communicate data to other external networks 131A, which can include the Internet, IP multimedia subsystem (IPS) network, and other networks. Generally, the application server 184 may be an element offering applications that use IP bearer resources with the core network (e.g., UMTS Packet Services (PS) domain, LTE PS data services, etc.). In this aspect, the P-GW 123 is shown to be communicatively coupled to an application server 184 via an IP interface 125. The application server 184 can also be configured to support one or more communication services (e.g., Voice-over-Internet Protocol (VoIP) sessions, PTT sessions, group communication sessions, social networking services, etc.) for the UEs 101 and 102 via the CN 120.

The P-GW 123 may further be a node for policy enforcement and charging data collection. Policy and Charging Rules Function (PCRF) 126 is the policy and charging control element of the CN 120. In a non-roaming scenario, in some aspects, there may be a single PCRF in the Home Public Land Mobile Network (HPLMN) associated with a UE's Internet Protocol Connectivity Access Network (IP-CAN) session. In a roaming scenario with a local breakout of traffic, there may be two PCRFs associated with a UE's IP-CAN session: a Home PCRF (H-PCRF) within an HPLMN and a Visited PCRF (V-PCRF) within a Visited Public Land Mobile Network (VPLMN). The PCRF 126 may be communicatively coupled to the application server 184 via the P-GW 123. The application server 184 may signal the PCRF 126 to indicate a new service flow and select the appropriate Quality of Service (QoS) and charging parameters. The PCRF 126 may provision this rule into a Policy and Charging Enforcement Function (PCEF) (not shown) with the appropriate traffic flow template (TFT) and QoS class of identifier (QCI), which commences the QoS and charging as specified by the application server 184.

In an example, any of the nodes 111 or 112 can be configured to communicate to the UEs 101, 102 (e.g., dynamically) an antenna panel selection and a receive (Rx) beam selection that can be used by the UE for data reception on a physical downlink shared channel (PDSCH) as well as for channel state information reference signal (CSI-RS) measurements and channel state information (CSI) calculation.

In an example, any of the nodes 111 or 112 can be configured to communicate to the UEs 101, 102 (e.g., dynamically) an antenna panel selection and a transmit (Tx) beam selection that can be used by the UE for data transmission on a physical uplink shared channel (PUSCH) as well as for sounding reference signal (SRS) transmission.

In some aspects, the communication network 140A can be an IoT network. One of the current enablers of IoT is the narrowband-IoT (NB-IoT). NB-IoT has objectives such as coverage extension, UE complexity reduction, long battery lifetime, and backward compatibility with the LTE network. In addition, NB-IoT aims to offer deployment flexibility allowing an operator to introduce NB-IoT using a small portion of its existing available spectrum, and operate in one of the following three modalities: (a) standalone deployment (the network operates in re-farmed GSM spectrum); (b) in-band deployment (the network operates within the LTE channel); and (c) guard-band deployment (the network operates in the guard band of legacy LTE channels). In some aspects, such as with further enhanced NB-IoT (FeNB-IoT), support for NB-IoT in small cells can be provided (e.g., in microcell, picocell or femtocell deployments). One of the challenges NB-IoT systems face for small cell support is the UL/DL link imbalance, where for small cells the base stations have lower power available compared to macro-cells, and, consequently, the DL coverage can be affected and/or reduced. In addition, some NB-IoT UEs can be configured to transmit at maximum power if repetitions are used for UL transmission. This may result in large inter-cell interference in dense small cell deployments.

In some aspects, the UE 101 can receive configuration information 190A via, e.g., higher layer signaling or other types of signaling. The configuration information 190A can include downlink control information (DCI). The DCI can provide allocation of uplink frequency resources of a transmission bandwidth, wherein the allocation is a block interleaved frequency division multiple access (B-IFDMA) allocation including a plurality of interleaved physical resource blocks (PRBs) forming M number of interlaces within the transmission bandwidth, and N number of PRBs within each interlace of the M number of interlaces, with N and M being integers greater than or equal to 1. In response to the configuration information, the UE 101 can communicate uplink data (via PUSCH) or uplink control information (UCI) (via PUCCH), collectively indicated as 192A, back to the gNB 111, as described hereinbelow.

FIG. 1B is a simplified diagram of a next generation (NG) system architecture 140B in accordance with some aspects. Referring to FIG. 1B, the NG system architecture 140B includes RAN 110 and a 5G network core (5GC) 120. The NG-RAN 110 can include a plurality of nodes, such as gNBs 128 and NG-eNBs 130. The gNBs 128 and the NG-eNBs 130 can be communicatively coupled to the UE 102 via, e.g., an N1 interface.

The core network 120 (e.g., a 5G core network or 5GC) can include an access and mobility management function (AMF) 132 and/or a user plane function (UPF) 134. The AMF 132 and the UPF 134 can be communicatively coupled to the gNBs 128 and the NG-eNBs 130 via NG interfaces. More specifically, in some aspects, the gNBs 128 and the NG-eNBs 130 can be connected to the AMF 132 by NG-C interfaces, and to the UPF 134 by NG-U interfaces. The gNBs 128 and the NG-eNBs 130 can be coupled to each other via Xn interfaces.

In some aspects, a gNB 128 can include a node providing new radio (NR) user plane and control plane protocol termination towards the UE and is connected via the NG interface to the 5GC 120. In some aspects, an NG-eNB 130 can include a node providing evolved universal terrestrial radio access (E-UTRA) user plane and control plane protocol terminations towards the UE and is connected via the NG interface to the 5GC 120.

In some aspects, each of the gNBs 128 and the NG-eNBs 130 can be implemented as a base station, a mobile edge server, a small cell, a home eNB, and so forth.

FIG. 1C illustrates an example MulteFire Neutral Host Network (NHN) 5G architecture 140C in accordance with some aspects. Referring to FIG. 1C, the MulteFire 5G architecture 140C can include the UE 102, NG-RAN 110, and the core network 120. The NG-RAN 110 can be a MulteFire NG-RAN (MF NG-RAN), and the core network 120 can be a MulteFire 5G neutral host network (NHN).

In some aspects, the MF NHN 120 can include a neutral host AMF (NH AMF) 132, an NH SMF 136, an NH UPF 134, and a local AAA proxy 151C. The AAA proxy 151C can provide a connection to a 3GPP AAA server 155C and a participating service provider AAA (PSP AAA) server 153C. The NH-UPF 134 can provide a connection to a data network 157C.

The MF NG-RAN 120 can provide similar functionalities as an NG-RAN operating under a 3GPP specification. The NH-AMF 132 can be configured to provide similar functionality as an AMF in a 3GPP 5G core network (e.g., as described in reference to FIG. 1D). The NH-SMF 136 can be configured to provide similar functionality as an SMF in a 3GPP 5G core network (e.g., as described in reference to FIG. 1D). The NH-UPF 134 can be configured to provide similar functionality as a UPF in a 3GPP 5G core network (e.g., as described in reference to FIG. 1D).

FIG. 1D illustrates a functional split between NG-RAN and the 5G Core (5GC) in accordance with some aspects. Referring to FIG. 1D, there is illustrated a more detailed diagram of the functionalities that can be performed by the gNBs 128 and the NG-eNBs 130 within the NG-RAN 110, as well as the AMF 132, the UPF 134, and the SMF 136 within the 5GC 120. In some aspects, the 5GC 120 can provide access to the Internet 138 to one or more devices via the NG-RAN 110.

In some aspects, the gNBs 128 and the NG-eNBs 130 can be configured to host the following functions: functions for Radio Resource Management (e.g., inter-cell radio resource management 129A, radio bearer control 129B, connection mobility control 129C, radio admission control 129D, dynamic allocation of resources to UEs in both uplink and downlink (scheduling) 129F); IP header compression, encryption and integrity protection of data; selection of an AMF at UE attachment when no routing to an AMF can be determined from the information provided by the UE; routing of User Plane data towards UPF(s); routing of Control Plane information towards AMF; connection setup and release; scheduling and transmission of paging messages (originated from the AMF); scheduling and transmission of system broadcast information (originated from the AMF or Operation and Maintenance); measurement and measurement reporting configuration for mobility and scheduling 129E; transport level packet marking in the uplink; session management; support of network slicing; QoS flow management and mapping to data radio bearers; support of UEs in RRC_INACTIVE state; distribution function for non-access stratum (NAS) messages; radio access network sharing; dual connectivity; and tight interworking between NR and E-UTRA, to name a few.

In some aspects, the AMF 132 can be configured to host the following functions, for example: NAS signaling termination; NAS signaling security 133A; access stratum (AS) security control; inter-core network (CN) node signaling for mobility between 3GPP access networks; idle state/mode mobility handling 133B, including mobile device, such as a UE reachability (e.g., control and execution of paging retransmission); registration area management; support of intra-system and inter-system mobility; access authentication, access authorization including check of roaming rights, mobility management control (subscription and policies); support of network slicing; and/or SMF selection, among other functions.

The UPF 134 can be configured to host the following functions, for example: mobility anchoring 135A (e.g., anchor point for Intra-/Inter-RAT mobility); packet data unit (PDU) handling 135B (e.g., external PDU session point of interconnect to data network); packet routing and forwarding; packet inspection and user plane part of policy rule enforcement; traffic usage reporting; uplink classifier to support routing traffic flows to a data network; branching point to support multi-homed PDU session; QoS handling for user plane, e.g., packet filtering, gating, UL/DL rate enforcement; uplink traffic verification (SDF to QoS flow mapping); and/or downlink packet buffering and downlink data notification triggering, among other functions.

The Session Management function (SMF) 136 can be configured to host the following functions, for example: session management; UE IP address allocation and management 137A; selection and control of user plane function (UPF); PDU session control 137B, including configuring traffic steering at UPF 134 to route traffic to proper destination; control part of policy enforcement and QoS; and/or downlink data notification, among other functions.

FIG. 1E and FIG. 1F illustrate a non-roaming 5G system architecture in accordance with some aspects. Referring to FIG. 1E, there is illustrated a 5G system architecture 140E in a reference point representation. More specifically, UE 102 can be in communication with RAN 110 as well as one or more other 5G core (5GC) network entities. The 5G system architecture 140E includes a plurality of network functions (NFs), such as access and mobility management function (AMF) 132, session management function (SMF) 136, policy control function (PCF) 148, application function (AF) 150, user plane function (UPF) 134, network slice selection function (NSSF) 142, authentication server function (AUSF) 144, and unified data management (UDM)/home subscriber server (HSS) 146. The UPF 134 can provide a connection to a data network (DN) 152, which can include, for example, operator services, Internet access, or third-party services. The AMF can be used to manage access control and mobility, and can also include network slice selection functionality. The SMF can be configured to set up and manage various sessions according to network policy. The UPF can be deployed in one or more configurations according to the desired service type. The PCF can be configured to provide a policy framework using network slicing, mobility management, and roaming (similar to PCRF in a 4G communication system). The UDM can be configured to store subscriber profiles and data (similar to an HSS in a 4G communication system).

In some aspects, the 5G system architecture 140E includes an IP multimedia subsystem (IMS) 168E as well as a plurality of IP multimedia core network subsystem entities, such as call session control functions (CSCFs). More specifically, the IMS 168E includes a CSCF, which can act as a proxy CSCF (P-CSCF) 162E, a serving CSCF (S-CSCF) 164E, an emergency CSCF (E-CSCF) (not illustrated in FIG. 1E), and/or interrogating CSCF (I-CSCF) 166E. The P-CSCF 162E can be configured to be the first contact point for the UE 102 within the IM subsystem (IMS) 168E. The S-CSCF 164E can be configured to handle the session states in the network, and the E-CSCF can be configured to handle certain aspects of emergency sessions such as routing an emergency request to the correct emergency center or PSAP. The I-CSCF 166E can be configured to function as the contact point within an operator's network for all IMS connections destined to a subscriber of that network operator, or a roaming subscriber currently located within that network operator's service area. In some aspects, the I-CSCF 166E can be connected to another IP multimedia network 170E, e.g. an IMS operated by a different network operator.

In some aspects, the UDM/HSS 146 can be coupled to an application server 160E, which can include a telephony application server (TAS) or another application server (AS). The AS 160E can be coupled to the IMS 168E via the S-CSCF 164E and/or the I-CSCF 166E.

In some aspects, the 5G system architecture 140E can use unified access barring mechanism using one or more of the techniques described herein, which access barring mechanism can be applicable for all RRC states of the UE 102, such as RRC_IDLE, RRC_CONNECTED, and RRC_INACTIVE states.

In some aspects, the 5G system architecture 140E can be configured to use 5G access control mechanism techniques described herein, based on access categories that can be categorized by a minimum default set of access categories, which are common across all networks. This functionality can allow the public land mobile network PLMN, such as a visited PLMN (VPLMN) to protect the network against different types of registration attempts, enable acceptable service for the roaming subscriber and enable the VPLMN to control access attempts aiming at receiving certain basic services. It also provides more options and flexibility to individual operators by providing a set of access categories, which can be configured and used in operator-specific ways.

Referring to FIG. 1F, there is illustrated a 5G system architecture 140F and a service-based representation. System architecture 140F can be substantially similar to (or the same as) system architecture 140E. In addition to the network entities illustrated in FIG. 1E, system architecture 140F can also include a network exposure function (NEF) 154 and a network repository function (NRF) 156.

In some aspects, 5G system architectures can be service-based and interaction between network functions can be represented by corresponding point-to-point reference points N1 (as illustrated in FIG. 1E) or as service-based interfaces (as illustrated in FIG. 1F).

A reference point representation shows that interaction can exist between corresponding NF services. For example, FIG. 1E illustrates the following reference points: N1 (between the UE 102 and the AMF 132), N2 (between the RAN 110 and the AMF 132), N3 (between the RAN 110 and the UPF 134), N4 (between the SMF 136 and the UPF 134), N5 (between the PCF 148 and the AF 150), N6 (between the UPF 134 and the DN 152), N7 (between the SMF 136 and the PCF 148), N8 (between the UDM 146 and the AMF 132), N9 (between two UPFs 134), N10 (between the UDM 146 and the SMF 136), N11 (between the AMF 132 and the SMF 136), N12 (between the AUSF 144 and the AMF 132), N13 (between the AUSF 144 and the UDM 146), N14 (between two AMFs 132), NIS (between the PCF 148 and the AMF 132 in case of a non-roaming scenario, or between the PCF 148 and a visited network and AMF 132 in case of a roaming scenario), N16 (between two SMFs; not illustrated in FIG. 1E), and N22 (between AMF 132 and NSSF 142). Other reference point representations not shown in FIG. 1E can also be used.

In some aspects, as illustrated in FIG. 1F, service-based representations can be used to represent network functions within the control plane that enable other authorized network functions to access their services. In this regard, 5G system architecture 140F can include the following service-based interfaces: Namf 158H (a service-based interface exhibited by the AMF 132), Nsmf 1581 (a service-based interface exhibited by the SMF 136), Nnef 158B (a service-based interface exhibited by the NEF 154), Npcf 158D (a service-based interface exhibited by the PCF 148), a Nudm 158E (a service-based interface exhibited by the UDM 146), Naf 158F (a service-based interface exhibited by the AF 150), Nnrf 158C (a service-based interface exhibited by the NRF 156), Nnssf 158A (a service-based interface exhibited by the NSSF 142), Nausf 158G (a service-based interface exhibited by the AUSF 144). Other service-based interfaces (e.g., Nudr, N5g-eir, and Nudsf) not shown in FIG. 1F can also be used.

FIG. 1G illustrates an example of CIoT network architecture in accordance with some aspects. Referring to FIG. 1G, the CIoT architecture 140G can include the UE 102 and the RAN 110 coupled to a plurality of core network entities. In some aspects, the UE 102 can be machine-type communication (MTC) UE. The CIoT network architecture 140G can further include a mobile services switching center (MSC) 160, MME 121, a serving GPRS support node (SGSN) 162, a S-GW 122, an IP-Short-Message-Gateway (IP-SM-GW) 164, a Short Message Service Service Center (SMS-SC)/gateway mobile service center (GMSC)/Interworking MSC (IWMSC) 166, MTC interworking function (MTC-IWF) 170, a Service Capability Exposure Function (SCEF) 172, a gateway GPRS support node (GGSN)/Packet-GW (P-GW) 174, a charging data function (CDF)/charging gateway function (CGF) 176, a home subscriber server (HSS)/a home location register (HLR) 177, short message entities (SME) 168, MTC authorization, authentication, and accounting (MTC AAA) server 178, a service capability server (SCS) 180, and application servers (AS) 182 and 184.

In some aspects, the SCEF 172 can be configured to securely expose services and capabilities provided by various 3GPP network interfaces. The SCEF 172 can also provide means for the discovery of the exposed services and capabilities, as well as access to network capabilities through various network application programming interfaces (e.g., API interfaces to the SCS 180).

FIG. 1G further illustrates various reference points between different servers, functions, or communication nodes of the CIoT network architecture 140G. Some example reference points related to MTC-IWF 170 and SCEF 172 include the following: Tsms (a reference point used by an entity outside the 3GPP network to communicate with UEs used for MTC via SMS), Tsp (a reference point used by a SCS to communicate with the MTC-IWF related control plane signaling), T4 (a reference point used between MTC-IWF 170 and the SMS-SC 166 in the HPLMN), T6a (a reference point used between SCEF 172 and serving MME 121), T6b (a reference point used between SCEF 172 and serving SGSN 162), T8 (a reference point used between the SCEF 172 and the SCS/AS 180/182), S6m (a reference point used by MTC-IWF 170 to interrogate HSS/HLR 177), S6n (a reference point used by MTC-AAA server 178 to interrogate HSS/HLR 177), and S6t (a reference point used between SCEF 172 and HSS/HLR 177).

In some aspects, the CIoT UE 102 can be configured to communicate with one or more entities within the CIoT architecture 140G via the RAN 110 according to a Non-Access Stratum (NAS) protocol, and using one or more reference points, such as a narrowband air interface, for example, based on one or more communication technologies, such as Orthogonal Frequency-Division Multiplexing (OFDM) technology. As used herein, the term “CIoT UE” refers to a UE capable of CIoT optimizations, as part of a CIoT communications architecture.

In some aspects, the NAS protocol can support a set of NAS messages for communication between the CIoT UE 102 and an Evolved Packet System (EPS) Mobile Management Entity (MME) 121 and SGSN 162.

In some aspects, the CIoT network architecture 140F can include a packet data network, an operator network, or a cloud service network, having, for example, among other things, a Service Capability Server (SCS) 180, an Application Server (AS) 182, or one or more other external servers or network components.

The RAN 110 can be coupled to the HSS/HLR servers 177 and the AAA servers 178 using one or more reference points including, for example, an air interface based on an S6a reference point, and configured to authenticate/authorize CIoT UE 102 to access the CIoT network. The RAN 110 can be coupled to the CIoT network architecture 140G using one or more other reference points including, for example, an air interface corresponding to an SGi/Gi interface for 3GPP accesses. The RAN 110 can be coupled to the SCEF 172 using, for example, an air interface based on a T6a/T6b reference point, for service capability exposure. In some aspects, the SCEF 172 may act as an API GW towards a third-party application server such as AS 182. The SCEF 172 can be coupled to the HSS/HLR 177 and MTC AAA 178 servers using an S6t reference point, and can further expose an Application Programming Interface to network capabilities.

In certain examples, one or more of the CIoT devices disclosed herein, such as the CIoT UE 102, the CIoT RAN 110, etc., can include one or more other non-CIoT devices, or non-CIoT devices acting as CIoT devices, or having functions of a CIoT device. For example, the CIoT UE 102 can include a smartphone, a tablet computer, or one or more other electronic device acting as a CIoT device for a specific function, while having other additional functionality.

In some aspects, the RAN 110 can include a CIoT enhanced Node B (CIoT eNB) 111 communicatively coupled to the CIoT Access Network Gateway (CIoT GW) 195. In certain examples, the RAN 110 can include multiple base stations (e.g., CIoT eNBs) connected to the CIoT GW 195, which can include MSC 160, MME 121, SGSN 162, and/or S-GW 122. In certain examples, the internal architecture of RAN 110 and CIoT GW 195 may be left to the implementation and need not be standardized.

As used herein, the term “circuitry” may refer to, be part of, or include an Application Specific Integrated Circuit (ASIC) or other special purpose circuit, an electronic circuit, a processor (shared, dedicated, or group), or memory (shared, dedicated, or group) executing one or more software or firmware programs, a combinational logic circuit, or other suitable hardware components that provide the described functionality. In some aspects, the circuitry may be implemented in, or functions associated with the circuitry may be implemented by, one or more software or firmware modules. In some aspects, the circuitry may include logic, at least partially operable in hardware. In some aspects, circuitry, as well as modules disclosed herein, may be implemented in combinations of hardware, software and/or firmware. In some aspects, functionality associated with a circuitry can be distributed across more than one piece of hardware or software/firmware module. In some aspects, modules (as disclosed herein) may include logic, at least partially operable in hardware. Aspects described herein may be implemented into a system using any suitably configured hardware or software.

FIG. 1H illustrates an example of a Service Capability Exposure Function (SCEF) in accordance with some aspects. Referring to FIG. 1H, the SCEF 172 can be configured to expose services and capabilities provided by 3GPP network interfaces to external third-party service provider servers hosting various applications. In some aspects, a 3GPP network such as the CIoT architecture 140G, can expose the following services and capabilities: a home subscriber server (HSS) 116H, a policy and charging rules function (PCRF) 118H, a packet flow description function (PFDF) 120H, a MME/SGSN 122H, a broadcast multicast service center (BM-SC) 124H, a serving call server control function (S-CSCF) 126H, a RAN congestion awareness function (RCAF) 128H, and one or more other network entities 130H. The above-mentioned services and capabilities of a 3GPP network can communicate with the SCEF 172 via one or more interfaces as illustrated in FIG. 1H.

The SCEF 172 can be configured to expose the 3GPP network services and capabilities to one or more applications running on one or more service capability server (SCS)/application server (AS), such as SCS/AS 102H, 104H, . . . , 106H. Each of the SCS/AG 102H-106H can communicate with the SCEF 172 via application programming interfaces (APIs) 108H, 110H, 112H, . . . , 114H, as seen in FIG. 1H.

FIG. 1I illustrates an example of roaming architecture for SCEF in accordance with some aspects. Referring to FIG. 1I, the SCEF 172 can be located in HPLMN 110I and can be configured to expose 3GPP network services and capabilities, such as 102I, . . . , 104I. In some aspects, 3GPP network services and capabilities, such as 106I, . . . , 108I, can be located within VPLMN 112I. In this case, the 3GPP network services and capabilities within the VPLMN 112I can be exposed to the SCEF 172 via an interworking SCEF (IWK-SCEF) 197 within the VPLMN 112I.

FIG. 1J illustrates an example Evolved Universal Terrestrial Radio Access (E-UTRA) New Radio Dual Connectivity (EN-DC) architecture in accordance with some aspects. Referring to FIG. 1G, the EN-DC architecture 140J includes radio access network (or E-TRA network, or E-TRAN) 110 and EPC 120. The EPC 120 can include MMEs 121 and S-GWs 122. The E-UTRAN 110 can include nodes 111 (e.g., eNBs) as well as Evolved Universal Terrestrial Radio Access New Radio (EN) next generation evolved Node-Bs (en-gNBs) 128.

In some aspects, en-gNBs 128 can be configured to provide NR user plane and control plane protocol terminations towards the UE 102 and acting as Secondary Nodes (or SgNBs) in the EN-DC communication architecture 140J. The eNBs 111 can be configured as master nodes (or MeNBs) in the EN-DC communication architecture 140J. as illustrated in FIG. 1J, the eNBs 111 are connected to the EPC 120 via the S1 interface and to the EN-gNBs 128 via the X2 interface. The EN-gNBs 128 may be connected to the EPC 120 via the S1-U interface, and to other EN-gNBs via the X2-U interface.

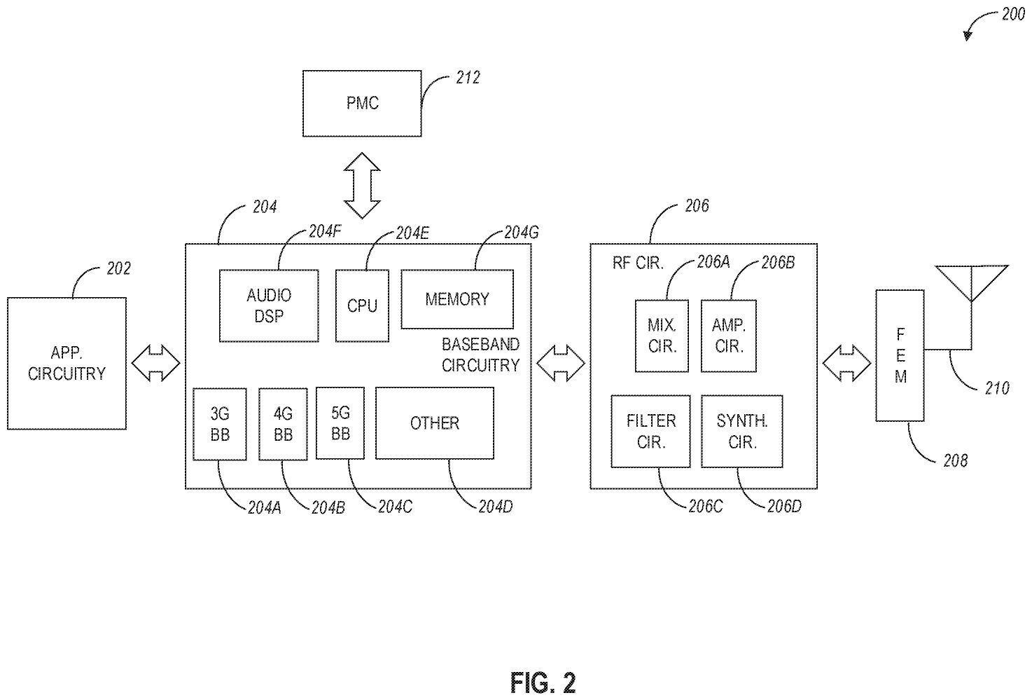

FIG. 2 illustrates example components of a device 200 in accordance with some aspects. In some aspects, the device 200 may include application circuitry 202, baseband circuitry 204, Radio Frequency (RF) circuitry 206, front-end module (FEM) circuitry 208, one or more antennas 210, and power management circuitry (PMC) 212 coupled together at least as shown. The components of the illustrated device 200 may be included in a UE or a RAN node. In some aspects, the device 200 may include fewer elements (e.g., a RAN node may not utilize application circuitry 202, and instead include a processor/controller to process IP data received from an EPC). In some aspects, the device 200 may include additional elements such as, for example, memory/storage, display, camera, sensor, and/or input/output (I/O) interface elements. In other aspects, the components described below may be included in more than one device (e.g., said circuitries may be separately included in more than one device for Cloud-RAN (C-RAN) implementations).

The application circuitry 202 may include one or more application processors. For example, the application circuitry 202 may include circuitry such as, but not limited to, one or more single-core or multi-core processors. The processor(s) may include any combination of general-purpose processors, special-purpose processors, and dedicated processors (e.g., graphics processors, application processors, etc.). The processors may be coupled with, and/or may include, memory/storage and may be configured to execute instructions stored in the memory/storage to enable various applications or operating systems to run on the device 200. In some aspects, processors of application circuitry 202 may process IP data packets received from an EPC.

The baseband circuitry 204 may include circuitry such as, but not limited to, one or more single-core or multi-core processors. The baseband circuitry 204 may include one or more baseband processors or control logic to process baseband signals received from a receive signal path of the RF circuitry 206 and to generate baseband signals for a transmit signal path of the RF circuitry 206. Baseband processing circuity 204 may interface with the application circuitry 202 for generation and processing of the baseband signals and for controlling operations of the RF circuitry 206. For example, in some aspects, the baseband circuitry 204 may include a third-generation (3G) baseband processor 204A, a fourth generation (4G) baseband processor 204B, a fifth generation (5G) baseband processor 204C, or other baseband processor(s) 204D for other existing generations, generations in development or to be developed in the future (e.g., second generation (2G), sixth-generation (6G), etc.). The baseband circuitry 204 (e.g., one or more of baseband processors 204A-D) may handle various radio control functions that enable communication with one or more radio networks via the RF circuitry 206. In other aspects, some or all of the functionality of baseband processors 204A-D may be included in modules stored in the memory 204G and executed via a Central Processing Unit (CPU) 204E. The radio control functions may include but are not limited to, signal modulation/demodulation, encoding/decoding, radio frequency shifting, etc. In some aspects, modulation/demodulation circuitry of the baseband circuitry 204 may include Fast-Fourier Transform (FFT), precoding, or constellation mapping/de-mapping functionality. In some aspects, encoding/decoding circuitry of the baseband circuitry 204 may include convolution, tail-biting convolution, turbo, Viterbi, or Low-Density Parity Check (LDPC) encoder/decoder functionality. Aspects of modulation/demodulation and encoder/decoder functionality are not limited to these examples and may include other suitable functionality in other aspects.

In some aspects, the baseband circuitry 204 may include one or more audio digital signal processor(s) (DSP) 204F. The audio DSP(s) 204F may include elements for compression/decompression and echo cancellation and may include other suitable processing elements in other aspects. Components of the baseband circuitry 204 may be suitably combined in a single chip, a single chipset, or disposed on the same circuit board in some aspects. In some aspects, some or all of the constituent components of the baseband circuitry 204 and the application circuitry 202 may be implemented together such as, for example, on a system on a chip (SOC).

In some aspects, the baseband circuitry 204 may provide for communication compatible with one or more radio technologies. For example, in some aspects, the baseband circuitry 204 may support communication with an evolved universal terrestrial radio access network (EUTRAN) or other wireless metropolitan area networks (WMAN), a wireless local area network (WLAN), and/or a wireless personal area network (WPAN). Baseband circuitry 204 configured to support radio communications of more than one wireless protocol may be referred to as multi-mode baseband circuitry, in some aspects.

RF circuitry 206 may enable communication with wireless networks using modulated electromagnetic radiation through a non-solid medium. In various aspects, the RF circuitry 206 may include switches, filters, amplifiers, etc. to facilitate communication with the wireless network. RF circuitry 206 may include a receive signal path which may include circuitry to down-convert RF signals received from the FEM circuitry 208 and provide baseband signals to the baseband circuitry 204. RF circuitry 206 may also include a transmit signal path which may include circuitry to up-convert baseband signals provided by the baseband circuitry 204 and provide RF output signals to the FEM circuitry 208 for transmission.

In some aspects, the receive signal path of the RF circuitry 206 may include a mixer 206A, an amplifier 206B, and a filter 206C. In some aspects, the transmit signal path of the RF circuitry 206 may include a filter 206C and a mixer 206A. RF circuitry 206 may also include a synthesizer 206D for synthesizing a frequency for use by the mixer 206A of the receive signal path and the transmit signal path. In some aspects, the mixer 206A of the receive signal path may be configured to down-convert RF signals received from the FEM circuitry 208 based on the synthesized frequency provided by synthesizer 206D. The amplifier 206B may be configured to amplify the down-converted signals and the filter 206C may be a low-pass filter (LPF) or band-pass filter (BPF) configured to remove unwanted signals from the down-converted signals to generate output baseband signals. Output baseband signals may be provided to the baseband circuitry 204 for further processing. In some aspects, the output baseband signals may optionally be zero-frequency baseband signals. In some aspects, mixer 206A of the receive signal path may comprise passive mixers.

In some aspects, the mixer 206A of the transmit signal path may be configured to up-convert input baseband signals based on the synthesized frequency provided by the synthesizer 206D to generate RF output signals for the FEM circuitry 208. The baseband signals may be provided by the baseband circuitry 204 and may be filtered by filter 206C.

In some aspects, the mixer 206A of the receive signal path and the mixer 206A of the transmit signal path may include two or more mixers and may be arranged for quadrature down conversion and upconversion, respectively. In some aspects, the mixer 206A of the receive signal path and the mixer 206A of the transmit signal path may include two or more mixers and may be arranged for image rejection (e.g., Hartley image rejection). In some aspects, the mixer 206A of the receive signal path and the mixer 206A may be arranged for direct down conversion and direct upconversion, respectively. In some aspects, the mixer 206A of the receive signal path and the mixer 206A of the transmit signal path may be configured for super-heterodyne operation.

In some aspects, the output baseband signals and the input baseband signals may optionally be analog baseband signals. According to some alternate aspects, the output baseband signals and the input baseband signals may be digital baseband signals. In these alternate aspects, the RF circuitry 206 may include an analog-to-digital converter (ADC) and digital-to-analog converter (DAC) circuitry and the baseband circuitry 204 may include a digital baseband interface to communicate with the RF circuitry 206.

In some dual-mode aspects, a separate radio IC circuitry may optionally be provided for processing signals for each spectrum.

In some aspects, the synthesizer 206D may optionally be a fractional-N synthesizer or a fractional N/N+1 synthesizer, although other types of frequency synthesizers may be suitable. For example, the synthesizer 206D may be a delta-sigma synthesizer, a frequency multiplier, or a synthesizer comprising a phase-locked loop with a frequency divider.

The synthesizer 206D may be configured to synthesize an output frequency for use by the mixer 206A of the RF circuitry 206 based on a frequency input and a divider control input. In some aspects, the synthesizer 206D may be a fractional N/N+1 synthesizer.

In some aspects, frequency input may be provided by a voltage controlled oscillator (VCO), although that is not a requirement. The divider control input may be provided, for example, by either the baseband circuitry 204 or the applications circuitry 202 depending on the desired output frequency. In some aspects, a divider control input (e.g., N) may be determined from a look-up table based on a channel indicated by the applications circuitry 202.

Synthesizer circuitry 206D of the RF circuitry 206 may include a divider, a delay-locked loop (DLL), a multiplexer and a phase accumulator. In some aspects, the divider may be a dual modulus divider (DMD) and the phase accumulator may be a digital phase accumulator (DPA). In some aspects, the DMD may be configured to divide the input signal by either N or N+1 (e.g., based on a carry out) to provide a fractional division ratio. In some example aspects, the DLL may include a set of cascaded, tunable, delay elements, a phase detector, a charge pump, and a D-type flip-flop. In these aspects, the delay elements may be configured to break a VCO period up into Nd equal packets of phase, where Nd is the number of delay elements in the delay line. In this way, the DLL provides negative feedback to assist in keeping the total delay through the delay line to one VCO cycle.

In some aspects, synthesizer circuitry 206D may be configured to generate a carrier frequency as the output frequency, while in other aspects, the output frequency may be a multiple of the carrier frequency (e.g., twice the carrier frequency, or four times the carrier frequency) and may be used in conjunction with quadrature generator and divider circuitry to generate multiple signals at the carrier frequency with multiple different phases with respect to each other. In some aspects, the output frequency may be a LO frequency (fLO). In some aspects, the RF circuitry 206 may include an IQ/polar converter.

FEM circuitry 208 may include a receive signal path which may include circuitry configured to operate on RF signals received from one or more antennas 210, and/or to amplify the received signals and provide the amplified versions of the received signals to the RF circuitry 206 for further processing. FEM circuitry 208 may also include a transmit signal path which may include circuitry configured to amplify signals for transmission provided by the RF circuitry 206 for transmission by one or more of the one or more antennas 210. In various aspects, the amplification through the transmit signal paths or the receive signal paths may be done in part or solely in the RF circuitry 206, in part or solely in the FEM circuitry 208, or in both the RF circuitry 206 and the FEM circuitry 208.

In some aspects, the FEM circuitry 208 may include a TX/RX switch to switch between transmit mode and receive mode operation. The FEM circuitry 208 may include a receive signal path and a transmit signal path. The receive signal path of the FEM circuitry 208 may include an LNA to amplify received RF signals and provide the amplified received RF signals as an output (e.g., to the RF circuitry 206). The transmit signal path of the FEM circuitry 208 may include a power amplifier (PA) to amplify input RF signals (e.g., provided by RF circuitry 206), and one or more filters to generate RF signals for subsequent transmission (e.g., by one or more of the one or more antennas 210).

In some aspects, the PMC 212 may manage power provided to the baseband circuitry 204. The PMC 212 may control power-source selection, voltage scaling, battery charging, and/or DC-to-DC conversion. The PMC 212 may, in some aspects, be included when the device 200 is capable of being powered by a battery, for example, when the device is included in a UE. The PMC 212 may increase the power conversion efficiency while providing beneficial implementation size and heat dissipation characteristics.

FIG. 2 shows the PMC 212 coupled with the baseband circuitry 204. In other aspects, the PMC 212 may be additionally or alternatively coupled with, and perform similar power management operations for, other components such as, but not limited to, application circuitry 202, RF circuitry 206, or FEM circuitry 208.

In some aspects, the PMC 212 may control, or otherwise be part of, various power saving mechanisms of the device 200. For example, if the device 200 is in an RRC_Connected state, in which it is still connected to the RAN node as it expects to receive traffic shortly, then it may enter a state known as Discontinuous Reception Mode (DRX) after a period of inactivity. During this state, the device 200 may power down for brief intervals of time and thus save power.

According to some aspects, if there is no data traffic activity for an extended period of time, then the device 200 may transition off to an RRC_Idle state, in which it disconnects from the network and does not perform operations such as channel quality feedback, handover, etc. The device 200 goes into a very low power state and it performs paging during which it periodically wakes up to listen to the network and then powers down again. The device 200 may transition back to RRC_Connected state to receive data.

An additional power saving mode may allow a device to be unavailable to the network for periods longer than a paging interval (ranging from seconds to a few hours). During this time, the device 200 in some aspects may be unreachable to the network and may power down. Any data sent during this time incurs a delay, which may be large, and it is assumed the delay is acceptable.

Processors of the application circuitry 202 and processors of the baseband circuitry 204 may be used to execute elements of one or more instances of a protocol stack. For example, processors of the baseband circuitry 204, alone or in combination, may be used execute Layer 3, Layer 2, or Layer 1 functionality, while processors of the application circuitry 202 may utilize data (e.g., packet data) received from these layers and further execute Layer 4 functionality (e.g., transmission communication protocol (TCP) and user datagram protocol (UDP) layers). As referred to herein, Layer 3 may comprise a radio resource control (RRC) layer, described in further detail below. As referred to herein, Layer 2 may comprise a medium access control (MAC) layer, a radio link control (RLC) layer, and a packet data convergence protocol (PDCP) layer, described in further detail below. As referred to herein, Layer 1 may comprise a physical (PHY) layer of a UE/RAN node, described in further detail below.

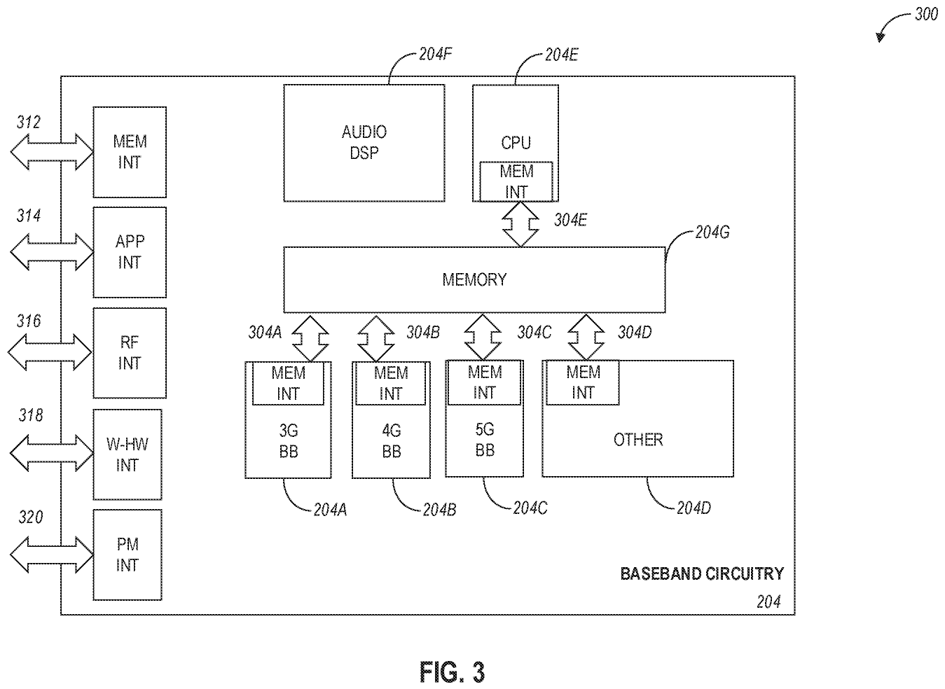

FIG. 3 illustrates example interfaces of baseband circuitry 204, in accordance with some aspects. As discussed above, the baseband circuitry 204 of FIG. 2 may comprise processors 204A-204E and a memory 204G utilized by said processors. Each of the processors 204A-204E may include a memory interface, 304A-304E, respectively, to send/receive data to/from the memory 204G.

The baseband circuitry 204 may further include one or more interfaces to communicatively couple to other circuitries/devices, such as a memory interface 312 (e.g., an interface to send/receive data to/from memory external to the baseband circuitry 204), an application circuitry interface 314 (e.g., an interface to send/receive data to/from the application circuitry 202 of FIG. 2), an RF circuitry interface 316 (e.g., an interface to send/receive data to/from RF circuitry 206 of FIG. 2), a wireless hardware connectivity interface 318 (e.g., an interface to send/receive data to/from Near Field Communication (NFC) components, Bluetooth® components (e.g., Bluetooth® Low Energy), Wi-Fi® components, and other communication components), and a power management interface 320 (e.g., an interface to send/receive power or control signals to/from the PMC 212).

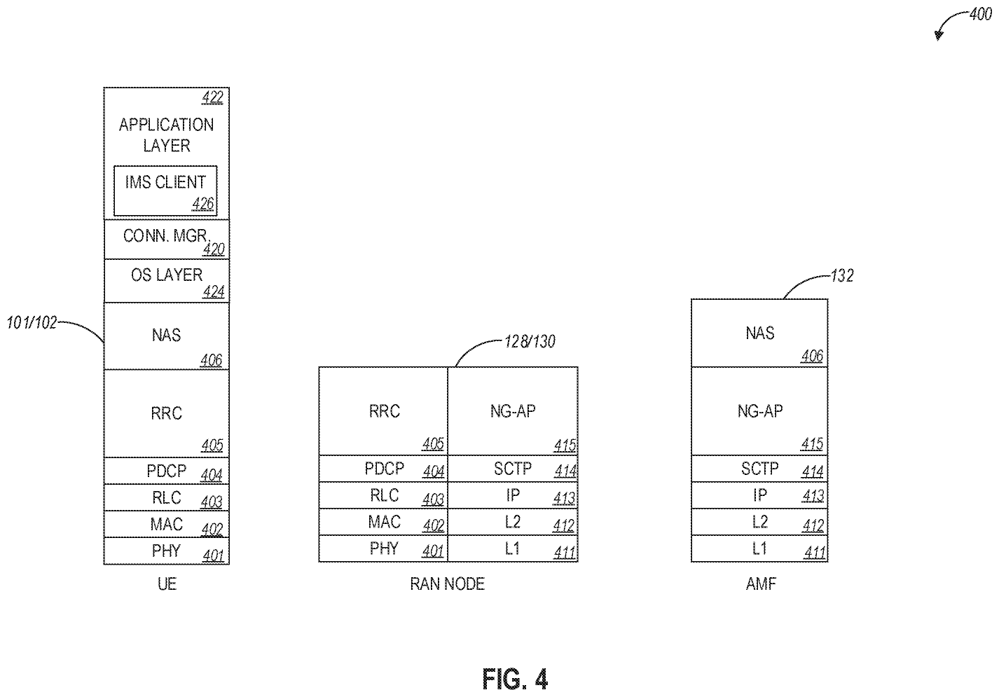

FIG. 4 is an illustration of a control plane protocol stack in accordance with some aspects. In one aspect, a control plane 400 is shown as a communications protocol stack between the UE 102, the RAN node 128 (or alternatively, the RAN node 130), and the AMF 132.

The PHY layer 401 may in some aspects transmit or receive information used by the MAC layer 402 over one or more air interfaces. The PHY layer 401 may further perform link adaptation or adaptive modulation and coding (AMC), power control, cell search (e.g., for initial synchronization and handover purposes), and other measurements used by higher layers, such as the RRC layer 405. The PHY layer 401 may in some aspects still further perform error detection on the transport channels, forward error correction (FEC) coding/decoding of the transport channels, modulation/demodulation of physical channels, interleaving, rate matching, mapping onto physical channels, and Multiple Input Multiple Output (MIMO) antenna processing.

The MAC layer 402 may in some aspects perform mapping between logical channels and transport channels, multiplexing of MAC service data units (SDUs) from one or more logical channels onto transport blocks (TB) to be delivered to PHY via transport channels, de-multiplexing MAC SDUs to one or more logical channels from transport blocks (TB) delivered from the PHY via transport channels, multiplexing MAC SDUs onto TBs, scheduling information reporting, error correction through hybrid automatic repeat request (HARQ), and logical channel prioritization.

The RLC layer 403 may in some aspects operate in a plurality of modes of operation, including Transparent Mode (TM), Unacknowledged Mode (UM), and Acknowledged Mode (AM). The RLC layer 403 may execute the transfer of upper layer protocol data units (PDUs), error correction through automatic repeat request (ARQ) for AM data transfers, and segmentation and reassembly of RLC SDUs for UM and AM data transfers. The RLC layer 403 may also maintain sequence numbers independent of the ones in PDCP for UM and AM data transfers. The RLC layer 403 may also in some aspects execute re-segmentation of RLC data PDUs for AM data transfers, detect duplicate data for AM data transfers, discard RLC SDUs for UM and AM data transfers, detect protocol errors for AM data transfers, and perform RLC re-establishment.

The PDCP layer 404 may in some aspects execute header compression and decompression of IP data, maintain PDCP Sequence Numbers (SNs), perform in-sequence delivery of upper layer PDUs at re-establishment of lower layers, perform reordering and eliminate duplicates of lower layer SDUs, execute PDCP PDU routing for the case of split bearers, execute retransmission of lower layer SDUs, cipher and decipher control plane and user plane data, perform integrity protection and integrity verification of control plane and user plane data, control timer-based discard of data, and perform security operations (e.g., ciphering, deciphering, integrity protection, integrity verification, etc.).

In some aspects, primary services and functions of the RRC layer 405 may include broadcast of system information (e.g., included in Master Information Blocks (MIBs) or System Information Blocks (SIBs) related to the non-access stratum (NAS)): broadcast of system information related to the access stratum (AS); paging initiated by 5GC 120 or NG-RAN 110, establishment, maintenance, and release of an RRC connection between the UE and NG-RAN (e.g., RRC connection paging, RRC connection establishment, RRC connection addition, RRC connection modification, and an RRC connection release, also for carrier aggregation and Dual Connectivity in NR or between E-UTRA and NR); establishment, configuration, maintenance, and release of Signalling Radio Bearers (SRBs) and Data Radio Bearers (DRBs); security functions including key management, mobility functions including handover and context transfer, UE cell selection and reselection and control of cell selection and reselection, and inter-radio access technology (RAT) mobility; and measurement configuration for UE measurement reporting. Said MIBs and SIBs may comprise one or more information elements (IEs), which may each comprise individual data fields or data structures. The RRC layer 405 may also, in some aspects, execute QoS management functions, detection of and recovery from radio link failure, and NAS message transfer between the NAS layer 406 in the UE and the NAS layer 406 in the AMF 132.

In some aspects, the following NAS messages can be communicated during the corresponding NAS procedure, as illustrated in Table 1 below:

TABLE 1

| 5G NAS | 5G NAS | 4G NAS | 4G NAS |
|---|---|---|---|
| Message | Procedure | Message name | Procedure |
| Registration | Initial | Attach Request | Attach |
| Request | registration | | procedure |
| | procedure | | |
| Registration | Mobility | Tracking Area | Tracking area |
| Request | registration | Update (TAU) | updating |
| | update | Request | procedure |
| | procedure | | |
| Registration | Periodic | TAU Request | Periodic |
| Request | registration | | tracking area |
| | update | | updating |
| | procedure | | procedure |
| Deregistration | Deregistration | Detach | Detach |
| Request | procedure | Request | procedure |
| Service | Service request | Service | Service request |
| Request | procedure | Request or | procedure |
| | | Extended | |
| | | Service | |
| | | Request | |
| PDU Session | PDU session | PDN | PDN |
| Establishment | establishment | Connectivity | connectivity |
| Request | procedure | Request | procedure |

In some aspects, when the same message is used for more than one procedure, then a parameter can be used (e.g., registration type or TAU type) which indicates the specific purpose of the procedure, e.g. registration type=“initial registration”, “mobility registration update” or “periodic registration update”.

The UE 101 and the RAN node 128/130 may utilize an NG radio interface (e.g., an LTE-Uu interface or an NR radio interface) to exchange control plane data via a protocol stack comprising the PHY layer 401, the MAC layer 402, the RLC layer 403, the PDCP layer 404, and the RRC layer 405.

The non-access stratum (NAS) protocol layers 406 forms the highest stratum of the control plane between the UE 101 and the AMF 132 as illustrated in FIG. 4. In aspects, the NAS protocol layers 406 support the mobility of the UE 101 and the session management procedures to establish and maintain IP connectivity between the UE 101 and the UPF 134. In some aspects, the UE protocol stack can include one or more upper layers, above the NAS layer 406. For example, the upper layers can include an operating system layer 424, a connection manager 420, and an application layer 422. In some aspects, the application layer 422 can include one or more clients which can be used to perform various application functionalities, including providing an interface for and communicating with one or more outside networks. In some aspects, the application layer 422 can include an IP multimedia subsystem (IMS) client 426.

The NG Application Protocol (NG-AP) layer 415 may support the functions of the N2 and N3 interface and comprise Elementary Procedures (EPs). An EP is a unit of interaction between the RAN node 128/130 and the 5GC 120. In certain aspects, the NG-AP layer 415 services may comprise two groups: UE-associated services and non-UE-associated services. These services perform functions including, but not limited to UE context management, PDU session management and management of corresponding NG-RAN resources (e.g. Data Radio Bearers [DRBs]), UE capability indication, mobility, NAS signaling transport, and configuration transfer (e.g. for the transfer of SON information).

The Stream Control Transmission Protocol (SCTP) layer (which may alternatively be referred to as the SCTP/IP layer) 414 may ensure reliable delivery of signaling messages between the RAN node 128/130 and the AMF 132 based, in part, on the IP protocol, supported by the IP layer 413. The L2 layer 412 and the L1 layer 411 may refer to communication links (e.g., wired or wireless) used by the RAN node 128/130 and the AMF 132 to exchange information.

The RAN node 128/130 and the AMF 132 may utilize an N2 interface to exchange control plane data via a protocol stack comprising the L1 layer 411, the L2 layer 412, the IP layer 413, the SCTP layer 414, and the S1-AP layer 415.

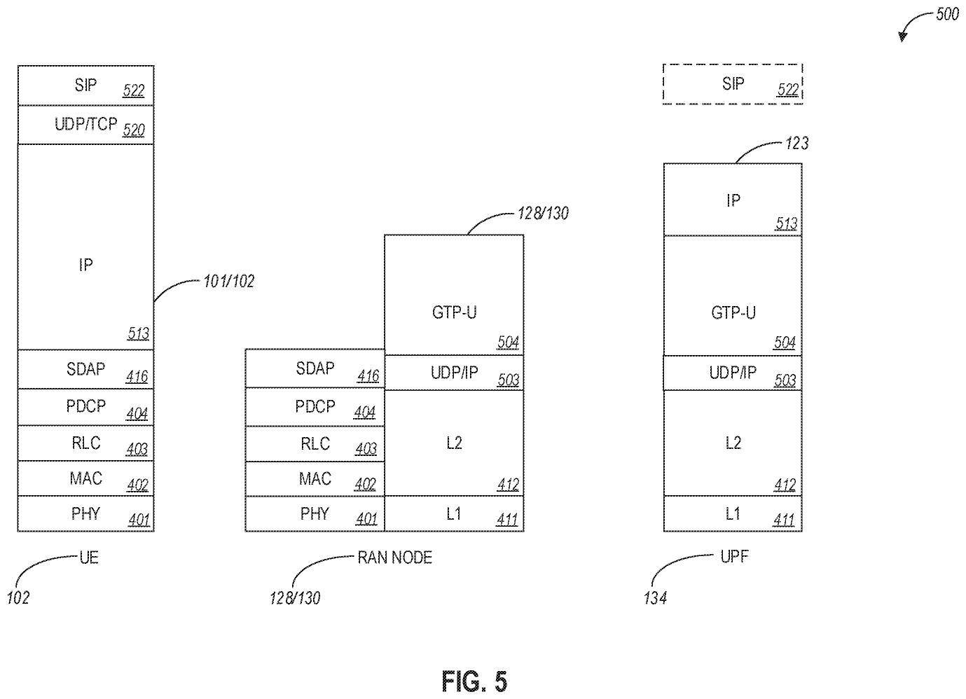

FIG. 5 is an illustration of a user plane protocol stack in accordance with some aspects. In this aspect, a user plane 500 is shown as a communications protocol stack between the UE 102, the RAN node 128 (or alternatively, the RAN node 130), and the UPF 134. The user plane 500 may utilize at least some of the same protocol layers as the control plane 400. For example, the UE 102 and the RAN node 128 may utilize an NR radio interface to exchange user plane data via a protocol stack comprising the PHY layer 401, the MAC layer 402, the RLC layer 403, the PDCP layer 404, and the Service Data Adaptation Protocol (SDAP) layer 416. The SDAP layer 416 may, in some aspects, execute a mapping between a Quality of Service (QoS) flow and a data radio bearer (DRB), and a marking of both DL and UL packets with a QoS flow ID (QFI). In some aspects, an IP protocol stack 513 can be located above the SDAP 416. A user datagram protocol (UDP)/transmission control protocol (TCP) stack 520 can be located above the IP stack 513. A session initiation protocol (SIP) stack 522 can be located above the UDP/TCP stack 520 and can be used by the UE 102 and the UPF 134.

The General Packet Radio Service (GPRS) Tunneling Protocol for the user plane (GTP-U) layer 504 may be used for carrying user data within the 5G core network 120 and between the radio access network 110 and the 5G core network 120. The user data transported can be packets in IPv4, IPv6, or PPP formats, for example. The UDP and IP security (UDP/IP) layer 503 may provide checksums for data integrity, port numbers for addressing different functions at the source and destination, and encryption and authentication on the selected data flows. The RAN node 128/130 and the UPF 134 may utilize an N3 interface to exchange user plane data via a protocol stack comprising the L1 layer 411, the L2 layer 412, the UDP/IP layer 503, and the GTP—U layer 504. As discussed above with respect to FIG. 4, NAS protocols support the mobility of the UE 101 and the session management procedures to establish and maintain IP connectivity between the UE 101 and the UPF 134.

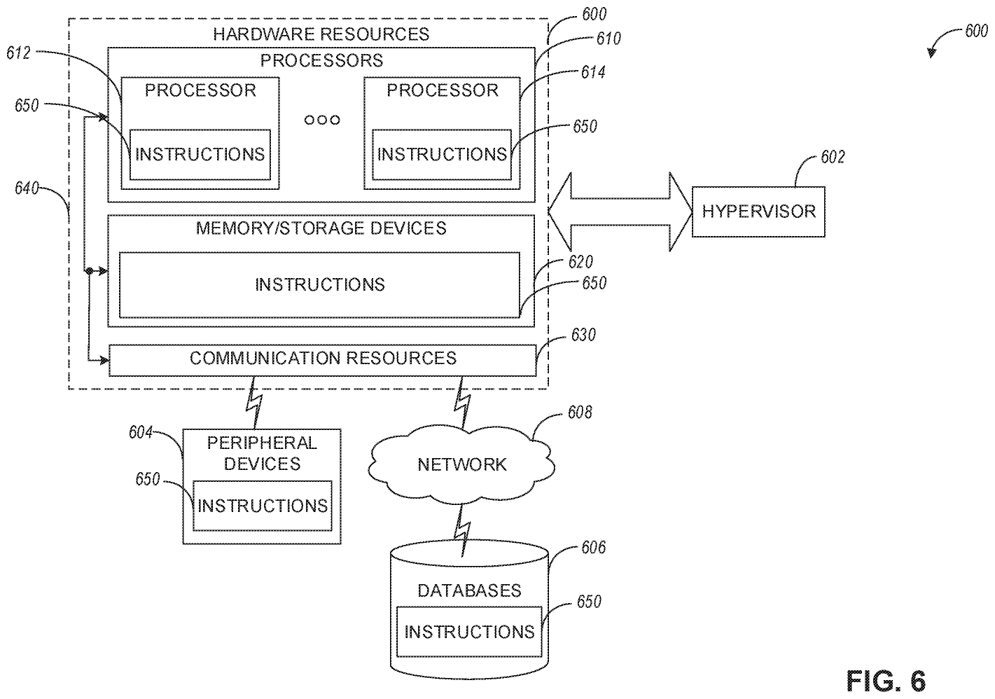

FIG. 6 is a block diagram illustrating components, according to some example aspects, able to read instructions from a machine-readable or computer-readable medium (e.g., a non-transitory machine-readable storage medium) and perform any one or more of the methodologies discussed herein. Specifically, FIG. 6 shows a diagrammatic representation of hardware resources 600 including one or more processors (or processor cores) 610, one or more memory/storage devices 620, and one or more communication resources 630, each of which may be communicatively coupled via a bus 640. For aspects in which node virtualization (e.g., NFV) is utilized, a hypervisor 602 may be executed to provide an execution environment for one or more network slices and/or sub-slices to utilize the hardware resources 600

The processors 610 (e.g., a central processing unit (CPU), a reduced instruction set computing (RISC) processor, a complex instruction set computing (CISC) processor, a graphics processing unit (GPU), a digital signal processor (DSP) such as a baseband processor, an application specific integrated circuit (ASIC), a radio-frequency integrated circuit (RFIC), another processor, or any suitable combination thereof) may include, for example, a processor 612 and a processor 614.

The memory/storage devices 620 may include a main memory, disk storage, or any suitable combination thereof. The memory/storage devices 620 may include, but are not limited to, any type of volatile or non-volatile memory such as dynamic random access memory (DRAM), static random-access memory (SRAM), erasable programmable read-only memory (EPROM), electrically erasable programmable read-only memory (EEPROM), Flash memory, solid-state storage, etc.

The communication resources 630 may include interconnection or network interface components or other suitable devices to communicate with one or more peripheral devices 604 or one or more databases 606 via a network 608. For example, the communication resources 630 may include wired communication components (e.g., for coupling via a Universal Serial Bus (USB)), cellular communication components, NFC components, Bluetooth® components (e.g., Bluetooth® Low Energy), Wi-Fi® components, and other communication components.

Instructions 650 may comprise software, a program, an application, an applet, an app, or other executable code for causing at least any of the processors 610 to perform any one or more of the methodologies discussed herein. The instructions 650 may reside, completely or partially, within at least one of the processors 610 (e.g., within the processor's cache memory), the memory/storage devices 620, or any suitable combination thereof. Furthermore, any portion of the instructions 650 may be transferred to the hardware resources 600 from any combination of the peripheral devices 604 or the databases 606. Accordingly, the memory of processors 610, the memory/storage devices 620, the peripheral devices 604, and the databases 606 are examples of computer-readable and machine-readable media.

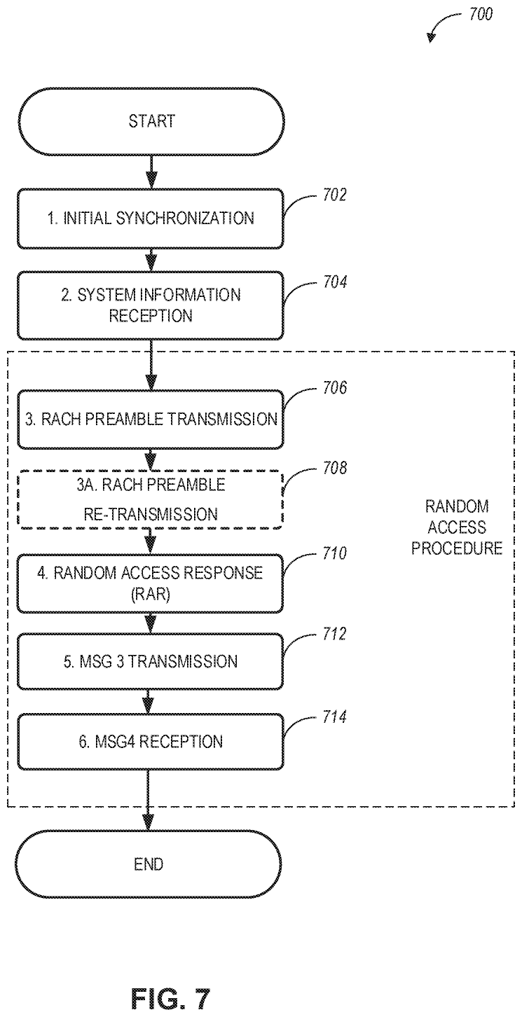

FIG. 7 is an illustration of an initial access procedure 700 including PRACH preamble retransmission in accordance with some aspects. Referring to FIG. 7, the initial access procedure 700 can start with operation 702, when initial synchronization can take place. For example, the UE 101 can receive a primary synchronization signal and a secondary synchronization signal to achieve the initial synchronization. In some aspects, the initial synchronization at operation 702 can be performed using one or more SS blocks received within an SS burst set. At operation 704, the UE 101 can receive system information, such as one or more system information blocks (SIBs) and/or master information blocks (MIBs).

At operation 706 through 714, a random access procedure can take place. More specifically, at operation 706, a PRACH preamble transmission can take place as message 1 (Msg1). At operation 710, UE 101 can receive a random access response (RAR) message, which can be random access procedure message 2 (Msg2). In Msg2, the node (e.g., gNB) 111 can respond with random access radio network temporary identifier (RA-RNTI), which can be calculated from the preamble resource (e.g., time and frequency allocation).

In some aspects, UE 101 can be configured to perform one or more retransmissions of the PRACH preamble at operation 708, when the RAR is not received or detected within a preconfigured or predefined time window. The PRACH preamble retransmission can take place with power ramping, as explained hereinbelow so that the transmission power is increased until the random-access response is received.

At operation 712, UE 101 can transmit a random access procedure message 3 (Msg3), which can include a radio resource control (RRC) connection request message. At operation 714, a random access procedure message 4 (Msg4) can be received by the UE 101, which can include an RRC connection setup message, carrying the cell radio network temporary identifier (CRNTI) used for subsequent communication between the UE 101 and the node 111.

In some aspects, techniques disclosed herein can be used for enhancing UE positioning in LTE and NR radio access technologies.

Techniques disclosed herein include techniques for enhanced positioning in cellular wireless communication networks of the next generation cellular systems, such as, for example, 3GPP LTE R16+ and 3GPP NR R16+. The proposed techniques are in general applicable to any type of wireless communication system and can be generalized. The proposed techniques aim to significantly improve the accuracy of UE location while minimizing receiver processing and measurements involved at the UE side to the minimum possible level. There are many technical problems of the existing location solutions used in cellular systems, including hearability problem (number of detected cells), non-line-of-sight (NLOS) channels, limited or narrow signal bandwidths, heavy signal processing at the UE side to measure signal location parameters. All of these problems are addressed by the techniques described herein.

Cellular wireless technologies rely on estimation of signal location parameters such as received reference signal time difference (RSTD), timing advance or round-trip time measurements, angle of arrival or departure to extract information propagation distance or relative difference of propagation distances between source(s) of the reference signal(s) and the mobile terminal. In particular, in LTE observed time difference of arrival (OTDOA) technology, base stations transmit positioning reference signals (PRS) or any other reference signals that can be used at the UE receiver side to measure the time difference of signal arrival (RSTD) for signals from different cells/base stations with respect to reference cell. The measured RSTD values with respect to the predefined reference cell are reported using higher layer positioning protocol to the location server in the network to determine the geographical coordinate of the target UE. In addition to RSTD reporting, the UE may report metric characterizing uncertainty/std deviation of the RSTD measurements or reference signal received power (RSRP) or quality (RSRQ).

The known previous solutions have multiple drawbacks, including (1) UE reports only a subset of signal location parameters such as RSTD, RTT, cell ID, RSRP, RSRQ and etc. that may not be sufficient or do not provide full information that may be relevant to UE location. (2) UEs need to perform sophisticated detection and estimation algorithms to measure signal location parameters from multiple cells that are typically of high computation complexity. In addition, many of algorithms such as for example super-resolution algorithms may not be affordable at the UE side due to extremely high computational complexity (e.g. MUSIC, etc.) and thus cannot be applied in practice. (3) The information reported by the UE to the network is partial and eventually a lot of information about various signal location parameters contained in received signals is not reported. For instance, the UE measures RSTD based on time of arrival estimation for the first arrival path from each station. It is clear that this information is incomplete and that other multi-path components can be also relevant to a location especially of location server has information about the environment. (4) UE implementations from different vendors use different algorithms for estimation of signal location parameters that may results in non-uniform performance across UEs even for the same propagation conditions.

Signal location parameters (SLP) are parameters of the signal that can be applied for the purpose of user positioning such as phase difference, time of arrival, time difference of arrival, propagation time/delays, angle of arrivals/departures, received reference signal powers and any other information that can be relevant to facilitate estimate of UE geographical coordinate.

Positioning reference signals (PRS) are the signals sent by cells/eNB/gNB/TRPs/Network Entities used to measure signal location parameters knowledge of which is beneficial for UE location. It could be specifically designed sequences and signals with good cross and autocorrelation properties or any data transmission depending on implementation and measurement and reporting type.

Reference Resource is the resource where PRS is transmitted and is characterized by stamp/ID, that can be configured by higher layer signaling and may be configured to UE for measurement and reporting. For instance the following ID may be used: 1) timestamp/ID (i.e. measured time location): time window to be reported (may be configured, but also possibly to report UE autonomous reporting by means of a new time index, SFN, slot number, and/or symbol index, etc.); 2) Frequency stamp/ID (i.e. measured frequency location not only for different carrier frequencies but also for different frequency within the given channel bandwidth); 3) TX/RX port stamp/ID (i.e. measured spatial domain information), and 4) code ID-sequence or signal ID describing or associated with the specific PRS.

Received signal waveform recorded/buffered at the UE side jointly with RSSI level contains full information about various signal location parameters. This data can be referred to as raw data containing full information about signal location parameters. Typically, at the UE side, the receiver aims to estimate a certain subset of signal location parameters such as signal time of arrival, received signal power and etc. The estimation of signal location parameters is done for each detected cell transmitting reference signals. Accurate estimation of many signal location parameters requires the development of sophisticated signal processing algorithms. In some aspects, the higher accuracy of signal location parameter estimation the higher complexity of the processing algorithm (e.g. super-resolution algorithms). Therefore, in practical UE implementations, the super-resolution algorithms are not considered and instead basic algorithms to estimate certain signal location parameters such as for example the timing of the first arrival path are used. Accurate estimation of the first arrival path may not be trivial especially in NLOS channels and complicated processing may be needed to achieve reliable and accurate estimation. In order to avoid these drawbacks, in some aspects, instead of reporting estimates of signal location parameters (i.e. measurement results), the received signal waveform or its pre-processed variant may be reported.

Type-1: Reporting of Recorded Received Signal Waveform (Raw Data).

In some aspects, the UE may report the received signal in time recorded at certain configured time windows. The format of received signal waveform recording can be preconfigured or signaled by UE. It is also possible that network instructs/configures UE on the format to use recording and reporting of the received waveform. For instance, the UE may capture a signal with different quantization levels (e.g. number of bits) and different backoff. The digital representation of the received signal waveform can be captured in any predefined format which is known at the UE and location server and/or base station. For instance, the received signal may be represented directly by quantized in-phase and quadrature components. In other aspects, the signal can be represented by quantized amplitude and phase. Other representation can be used without loss of generality. The raw data can be also compressed using known compression format so that the amount of payload for the report can be substantially reduced.

The captured received signal waveform in time domain or an FFT precoded received signal in frequency domain may be sent back to the eNB/gNB or network/location server in a predefined format known to the network as a payload of one of the report messages defined by MAC/RRC or upper layer signaling transported over PUSCH or any other physical channel. This mechanism of reporting is simple from the UE perspective and does not require the UE to know the transmitted signal waveform (reference signal) and which cells/eNB/gNB transmitted the signal and from which antenna ports. The only information the UE may need to know is when to capture received signal and where to adjust AGC given that the set of transmitting stations and antenna ports may be different, and UE may need to adjust AGC at the predefined time instances (at the beginning of recording window) to optimally quantize the signal and perform received power measurements for each recorded received signal waveform. On the other hand, the eNB/gNB/network/location server may need to have full information about transmission schedule and transmitted signal waveform including all physical layer structure details of the utilized reference signals (e.g. actual sequences, sequence mapping to spectrum resources, mapping to antenna ports and other details of transmission schedule by each cell) so that they know how to reproduce the transmitted signal and process reported by UE received signal waveform recorded at different transmission instances. The processing of the reported by UE received signal waveform can be done to extract and measure all possible signal location parameters by applying sophisticated processing algorithms including computationally intensive super-resolution algorithms. On top of the reporting received signal waveform corresponding to different time windows UE can be also expected to report the received signal strength for each recorded and reported waveform. The recorded received signal waveform can be reported per each time interval the recording was made and per each received antenna and/or per each received antenna port. This type of measurement reporting may be beneficial for users with reduced receiver complexity and can significantly improve location performance capabilities. In general, for reporting of the received waveform (type-1), it needs to be a time domain signal to consider the possibility of using different numerology or subcarrier spacings of the signals in a recording window.

Type-2: Reporting of Estimated Cir or Ctf (Pre-Processed Data).

In another aspect, the UE may preprocess the received signal waveform and estimate channel impulse response (CIR) in time or channel transfer function (CTF) in the frequency domain. The CIR and/or CTF that can be recorded in a predefined format and reported back to the eNB/gNB or network/location server in a predefined format known to the network as a payload of one of the MAC/RRC or upper layer messages transported over PUSCH or any other physical channel. In this case, it is assumed that UE is aware of demodulation reference signals and resources and transmitted schedule that was used for transmission of positioning reference signals used by different cells/eNBs/gNBs of the network. In this case, the amount of data reported back by UE to the network can be potentially reduced depending on the format. For instance, reporting of the estimated CIR may have much less overhead comparing to CTF or reporting received signal waveform, given that the number of taps in CIR is typically limited. On the other hand, the UE will need to report CTF/CIR for each transmitting cell that may increase overhead. If CIR is reported it may be possible to derive the angle of arrival (AoA) or multipath components to improve UE location.

Both CTF and CIR may be represented directly by quantized in-phase and quadrature components. In other aspects, CTF and CIR can be represented by quantized amplitude and phase. Other representations can be used without loss of generality. The estimated CIR and/or CTF can be reported per each time window the estimation was made and per each received antenna and/or per each received antenna port and/or for each transmit antenna port index or beam index. The CTF can be reported from the known subset of the resource elements in order to save payload overhead of the report. In addition, different compression approaches can be used to reduce report payload.

Type-3: Reporting of Signal Location Parameters (Processed Data).

In another aspect, the UE may process the received signal waveforms and estimate various signal location parameters such as phase difference, time of arrival, time difference of arrival, propagation time/delays, angle of arrivals/departures, received reference signal powers for each of the cell/eNB/gNB/TRPs. In this aspect, it is assumed that UE is configured and aware about demodulation reference signals, resources, and transmission schedule that were used for transmission of positioning reference signals used by different cells/eNBs/gNBs of the network. In this case, the amount of data reported by UE back to the network can be potentially reduced substantially. For instance, reporting the estimated SLP may have much less reporting overhead comparing to other reporting approaches however the accuracy of the radio-layer measurements and final location.

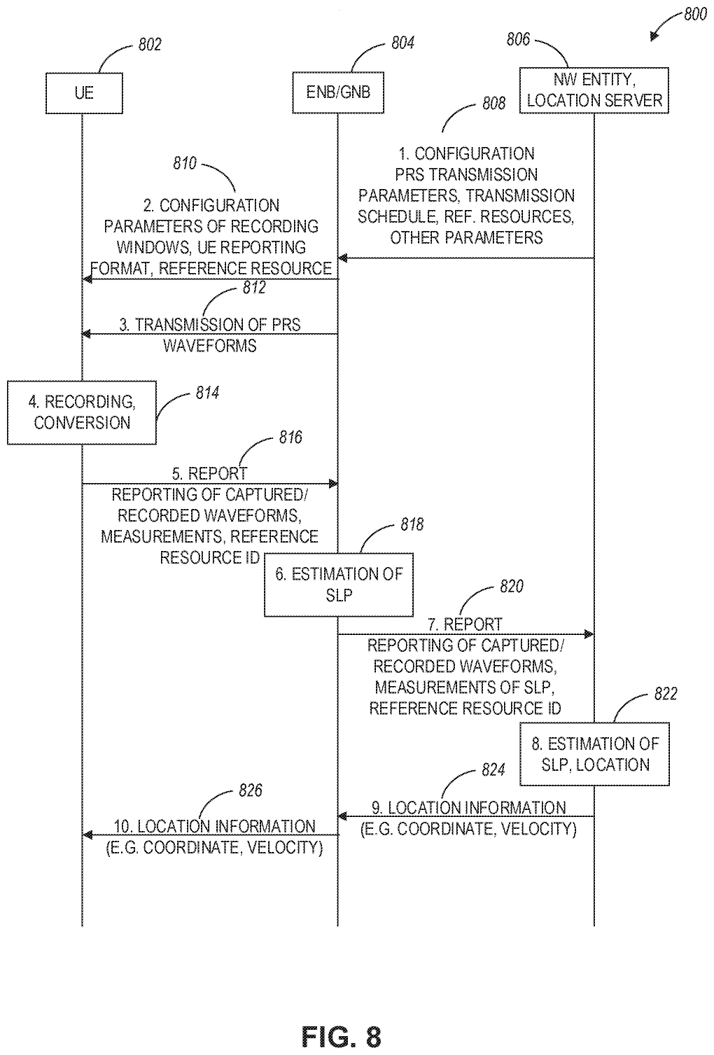

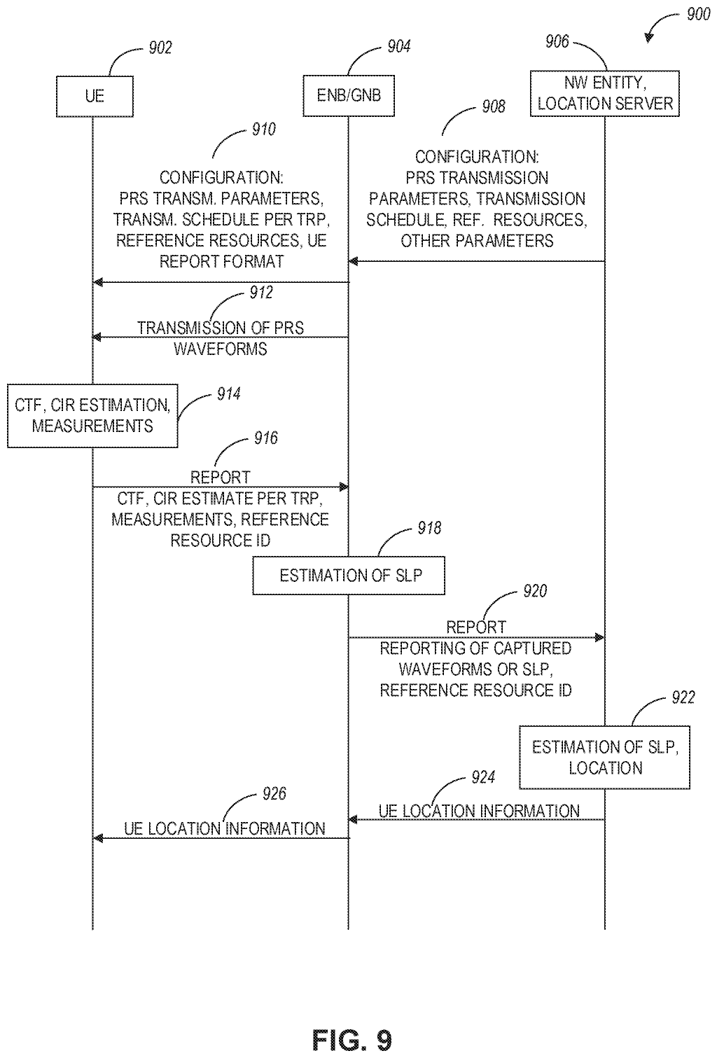

Depending on reporting information type, different system behavior can be expected as described below in connection with FIG. 8 and FIG. 9.

In case of Type-1 reporting (see FIG. 8), the only information that needs to be known to the UE is information about recording time instances (e.g. number, duration and periodicity of recording windows/occasions) and recording format (data representation format and signaling mechanism). In addition, the UE may be configured or scheduled with reporting time instances and reporting format. The information about waveforms, the physical structure of the transmission signals/sequences and transmission schedule details for transmission of reference signals across different cells, antenna ports, beam indexes.

FIG. 8 illustrates an example of communication exchange for the recording of received signal waveforms and reporting, in accordance with some aspects. Referring to FIG. 8, the communication exchange 800 can take place between the UE 802, eNB (or base station) 804, and a network entity such as a location server 806. At operation 808, the network entity 806 can communicate PRS transmission parameters, transmission schedule resources, other parameters or reference resources to the base station 804. At operation 810, the base station 804 can communicate parameters of recording windows, UE reporting format, and reference resources to the UE 802. At operation 812, PRS waveforms can be transmitted from the base station 804 to the UE 802. At operation 814, the UE can perform recording and conversion in connection with the received PRS waveforms. At operation 816, captured/recorded waveforms can be reported, together with measurements and reference resource ID. At operation 818, the base station 804 can perform estimation of SLP. At operation 820, the base station 804 can report the captured/recorded waveforms, measurements or SLP, and reference resource ID to the network entity 806. At operation 822, the network entity 806 estimates SLP and location of the UE. At operation 824, location information is communicated from the network entity 806 to the base station 804. At operation 826, the location information, such as coordinates, velocity or other information, is communicated from the base station 804 to the UE 802.

There are two alternative aspects of location reporting and location information signaling (operations 816, 820, 824, and 826).

In one aspect, (illustrated in FIG. 8), the information is exchanged between the UE and the location server via the eNB/gNB. In this aspect, in steps 816 and 818, RRC protocol can be used, and in steps 820 and 824 LPP (or its equivalent in NR) protocol can be used. In another aspect, messages can be communicated “directly” to the location server (i.e., the messages are sent via the eNB/gNB, but without interpreting these messages). In this case, the LPP protocol can be used (or its equivalent in NR).

In case of Type-2 reporting (see FIG. 9), the UE can be configured with all PRS transmission parameters required to estimate CTF and/or CIR from each cell/Transmission Reception Point(TRP)/eNB/gNB including parameters for generation of PRS waveform, Transmission Schedule and Resources used for PRS transmission including antenna ports and beam indexes as well as UE CTF, CIR reporting format. Once those are configured, cells/eNB/gNBs/TRPs can transmit waveforms following configured parameters and UE estimates CTF, CIR for all detected PRS transmissions. Finally, CTF and CIR information combined with other radio layer measurements such as RSRP, RSRQ, RSSI. RSTD, etc. can be reported back to eNB/gNB and/or network/location for further processing and estimation of UE location information (coordinates, velocity vector, etc).

FIG. 9 illustrates an example of communication exchange for estimation and reporting of channel impulse response (CIR) or channel transfer function (CTF), in accordance with some aspects. Referring to FIG. 9, the communication exchange 900 can take place between the UE 902, eNB (or base station) 904, and a network entity such as a location server 906. At operation 908, the network entity 906 can communicate PRS transmission parameters, transmission schedule, reference resources, and other parameters to the base station 904. At operation 910, the base station 904 can communicate PRS transmission parameters, transmission schedule per TRP, reference resources, and UE report format to the UE 902. At operation 912, PRS waveforms can be transmitted from the base station 904 to the UE 902. At operation 914, the UE can perform CTF, CIR estimation, and measurements. At operation 916, the UE 902 can report the CTF, the CIR estimate per TRP, the measurements, and the reference resource ID to the base station 904. At operation 918, the base station can perform estimation of SLP. At operation 920, the base station 904 can report the captured waveforms or SLP and reference resource ID to the network entity 906. At operation 922, the network entity 906 estimates SLP and location of the UE. At operation 924, location information is communicated from the network entity 906 to the base station 904. At operation 926, the location information, such as coordinates, velocity or other information, is communicated from the base station 904 to the UE 902.

Similarly to the type-1 reporting, there can be two signaling alternatives for type-2 reporting as well.

The diagram for Type-3 reporting is very similar to FIG. 9 for type-2 reporting, where instead of sharing information about estimates of CTF or CIR, the UE directly measures signal location parameters (SLP) and reports the parameters back to the network for estimation of the UE location.

In some aspects, a method of measuring signal location parameters based on positioning reference signals includes type−1 UE reporting of recorded received signal waveforms combined with other radio-layer measurements; type-2 UE reporting of estimated CIRs or CTFs combined with other radio-layer measurements; type-3 UE reporting of estimated SLPs combined with other radio-layer measurements; configuration of information for selected UE reporting type; configuration of UE reporting format; and configuration of reference resource.

The type−1 UE reporting of recorded received signal waveforms combined with other radio-layer measurements includes: capturing/recording of the received signal at the predetermined time windows at each receive antenna; conversion of capturing of the received signal at the predetermined time windows at each receive antenna to the predefined reporting format; and reporting of the recorded received signals to eNB/gNB/network in predefined format and using predefined signaling mechanism MAC/RRC/upper layer messages.

Radio-layer measurements include RSSI measurements conducted at each recording window for each received antenna.

Predetermined recording time windows include: configuration by eNB/gNB/network of reference symbols, slots, subframes or other time intervals and resource elements or reference spectrum resources to be used for recording of the received waveform signals by UE; configuration by eNB/gNB/network of the number, periodicity and duration of time windows used for capturing received signal waveform; and time instances for AGC settling within recording time windows.

The predefined reporting format includes: parameters of capturing signal waveform such as sampling rate and number of bits for quantization, etc.; signaling mechanism such MAC control element signaling, RRC control message or upper layer control message such as LPP message; and format of data representation such as quantized in-phase and quadrature components of received signal or quantized amplitude and phase or any other option w/o loss of generality.

The type-2 UE reporting of recorded received signal waveforms combined with other radio-layer measurements includes: capturing/recording of the received signal at the predetermined time windows at each receive antenna; estimation of channel transfer function or channel impulse response using received signal from the predetermined time windows for each receive antenna and transmit antenna port and utilizing information about PRS transmissions parameters from each cell; conversion of estimated channel transfer function or channel impulse response to the predefined format; and reporting of the recorded received signals to eNB/gNB/network in predefined format and using predefined signaling mechanism MAC/RRC/upper layer messages.

The radio-layer measurements include RSSL RSRP, RSRQ measurements conducted at each recording window for each received antenna of UE and transmit antenna ports of cells.

The predetermined time windows include: configuration by eNB/gNB/network of reference symbols, slots, subframes or other time intervals and resource elements or reference spectrum resources to be used for estimation of CTF and CIR by UE; and configuration by eNB/gNB/network of the number, periodicity and duration of reference resources carrying PRS used for estimation of CTF or CIR for each eNB/gNB/Cell.

The predefined reporting format includes: parameters of estimation and capturing of CTF or CIR for each eNB/gNB/Cell; and signaling mechanism such MAC control element signaling, RRC control message or upper layer control message such as LPP message.

The reference resource includes a resource where PRS is transmitted and characterized by stamp/ID that can be configured by higher layer signaling and may be configured to UE for measurements and reporting.

The reference resource includes: 1) timestamp/ID (i.e. measured time location): time window to be reported (may be configured, but also possibly to report UE autonomous reporting by means of a new time index, SFN, slot number, and/or symbol index, etc.); 2) Frequency stamp/ID (i.e. measured frequency location not only for different carrier frequencies but also for different frequency within the given channel bandwidth); 3) TX/RX port stamp/ID (i.e. measured spatial domain information); and 4) code ID-sequence or signal ID describing or associated with the specific PRS.

In some aspects, techniques disclosed herein can be used for a two-step PRACH design for NR.

Grant-free UL transmissions based on non-orthogonal multiple access (NOMA) is one of New Radio (NR) study items in 3GPP, targeting various use cases including massive connectivity for machine type communication (MTC), support of low overhead UL transmission schemes towards minimizing device power consumption for transmission of small data packets, low latency application such as ultra-reliable and low latency communication (URLLC).

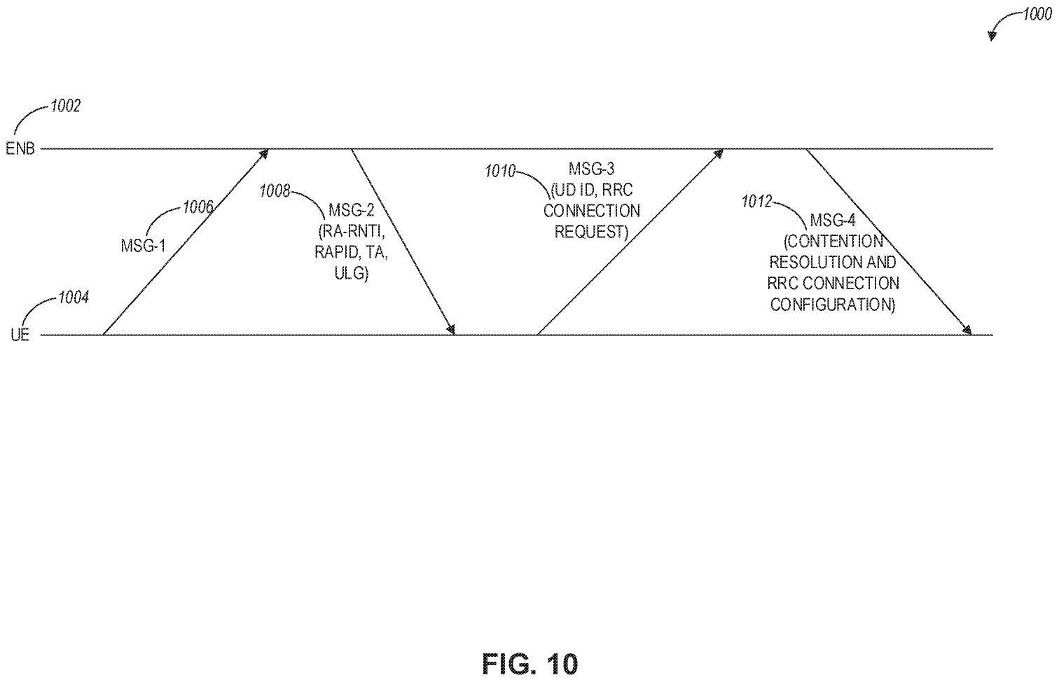

FIG. 10 illustrates a four-step PRACH procedure 1000, in accordance with some aspects. For the grant-free operation, especially for IDLE mode UEs, the UE may access the cell for the transmission of grant-free data. For accessing the cell, random access procedure (RACH or PRACH procedure) has to be applied. In some aspects, a 4-step RACH procedure can be used as indicated in FIG. 10. Referring to FIG. 10, the PRACH procedure is between a UE 1004 and base station 1002. The PRACH procedure can include the following four steps: Step 1: transmission of Msg-1 PRACH preamble 1006; Step 2: transmission of Msg-2 (RAR) 1008. PDCCH CRC is scrambled by RA-RNTI: indicating time-frequency resource of the PRACH. MAC CE: RAPID (PRACH preamble index), UL grant for Msg-3, Timing alignment (TA), TC-RNTI can all be communicated in Msg-2. Step 3: transmission of Msg-3 1010, including RRC connection request (if no C-RNTI is available in UE). UE Contention Resolution ID is included for user identification: S-TMSI or random ID. Step 4: transmission of Msg-4 1012, which is used for contention resolution by including UE ID received in Msg-3, and an additional RRC configuration Msg can also be included.

For the transmission of small data using grant-free transmission mode, the 4-step RACH may have significant overhead. If the low latency required service is considered, latency can be also increased by having all 4 steps. From the overhead and latency perspective, in some aspects, a 2-step RACH can be considered instead of the 4-step RACH.

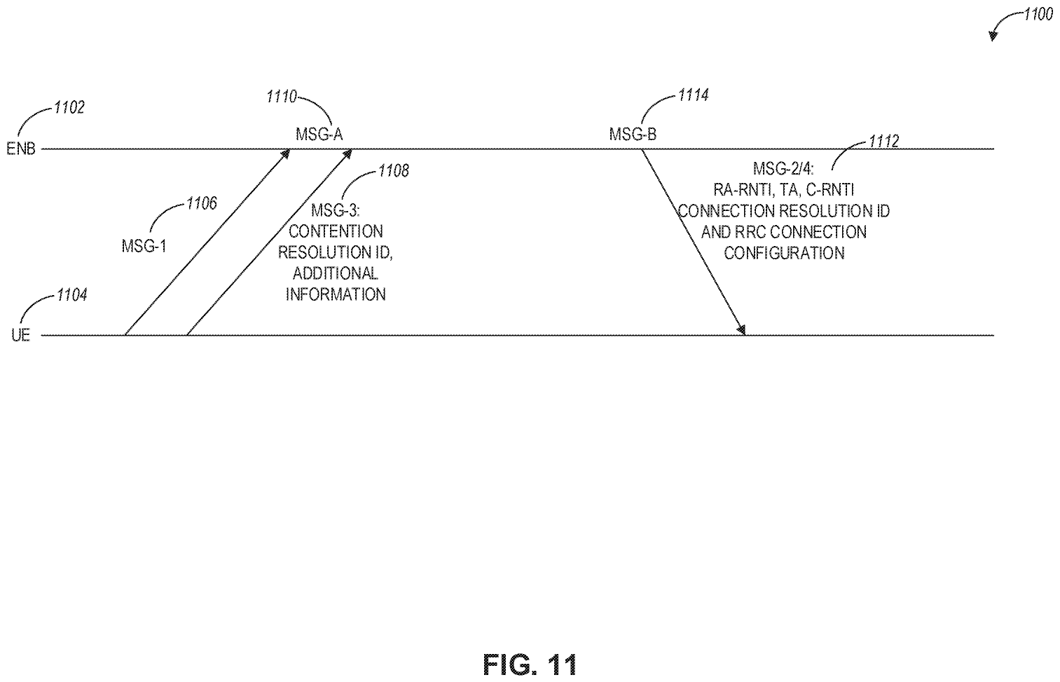

FIG. 11 illustrates a two-step PRACH procedure 1100, in accordance with some aspects. The 2-step RACH procedure between UE 1104 and base station 1102 includes 2 steps as shown in FIG. 11. Since the 2-step RACH can be considered as the minimized version of the 4-step RACH, similar functions as the 4-step RACH procedure can be used, including Msg-1/2/3/4 (e.g., 1106, 1108, 1112) has to be performed with 1 uplink message (Msg-A 1110) and 1 downlink message (Msg-B 1114).

Msg-A 1110 can include the PRACH preamble and the corresponding uplink data channel, e.g., PUSCH. Msg-B 1114 can include the responses on RACH and contention resolution information.

Configuration of 2-step RACH resource.

In some aspects, a 4-step RACH can be configured via remaining minimum system information (RMSI). RMSI can be also considered as a system information block 1 (SIB-1). Configuration includes which PRACH preamble is used, which resource is used for PRACH preamble, and etc. The configuration of the 2-step RACH especially for the PRACH preamble in Msg-A can also be used. Aspects of the configuration of the 2-step RACH are provided as follows, hereinbelow.

In one aspect, the resource can be configured for the PRACH preamble of Msg-1 for 2-step RACH procedure separately from the resource configured for PRACH preamble of 4-step RACH procedure. The NR cell may need to configure the 4-step RACH procedure for the legacy UEs. If the NR cell needs to configure a 2-step RACH procedure, the configuration can be separated from a 4-step RACH configuration.

For the separate configuration of PRACH preamble of a 2-step RACH procedure, system information can be used. Here, the system information can be a part of RMSI or other system information, e.g., SIB-X, where X is an integer number.

The UE which supports only 4-step RACH may neglect the system information for the configuration of 2-step RACH, but the UE which supports 2-step RACH has to read the configuration of the 2-step RACH.

In another aspect, the resource configured for the PRACH preamble of Msg-1 for 2-step RACH procedure is the same as or different from the resource configured for PRACH preamble of 4-step RACH procedure. The NR cell may need to configure the 4-step RACH procedure for the legacy UEs. If the NR cell needs to configure a 2-step RACH procedure, the same resource can be shared between PRACH preambles of 4-step RACH and 2-step RACH, or different resources can be used.

For the resource sharing, it can be guaranteed that the PRACH preamble resource of 2-step RACH does not give impacts for the configuration of 4-step RACH. This means that the legacy UEs that support 4-step RACH can perform 4-step RACH by receiving configuration of 4-step RACH without the information on configuration of 2-step RACH. The new UEs that support both 2-step RACH and 4-step RACH can perform either the 4-step RACH or the 2-step RACH by receiving configuration of both the 4-step RACH and the 2-step RACH.

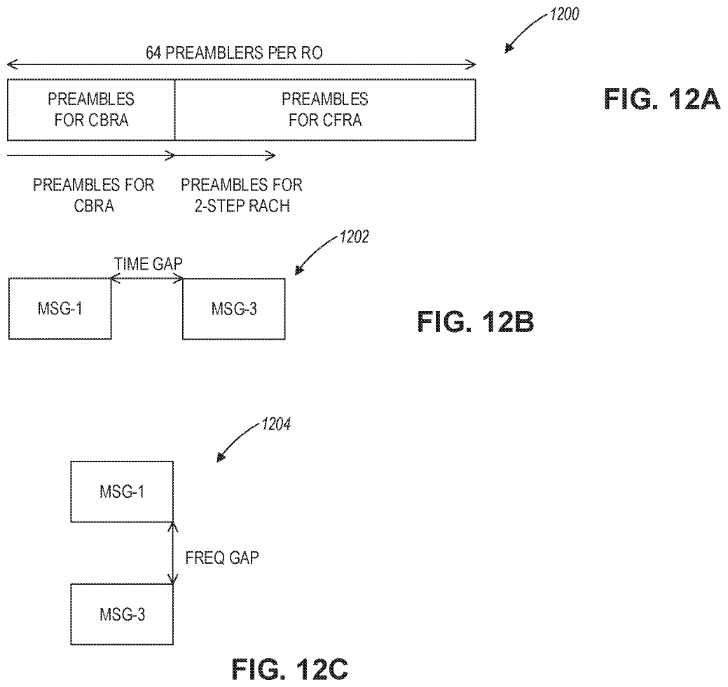

For the transparent configuration, a configuration of 4-step RACH has to be the baseline. In a 4-step RACH configuration, the number of preambles can be 64 inside one RACH occasion and the number of preambles for contention based random access (CBRA) is configured (e.g., as X). The remaining preambles (64-X) can be used for contention-free random access (CFRA) as can be seen in FIG. 12A.

FIG. 12A illustrates resource configuration 1200 for two-step PRACH procedure, in accordance with some aspects.

If multi-beam is used, then the number of total preambles for each corresponding SSB (synchronization signal block) is configured (which can be different from 64 and can be indicated as Y), and also the number of preambles for CBRA is configured (e.g., as Z). The remaining preambles (Y-Z) can be used for CFRA.

The preambles for CFRA can be controlled by the network, which means that the network can use the preambles for CFRA for the other purpose. Therefore, some preambles out of preambles reserved for CFRA can be configured for preambles for 2-step RACH. As can be seen in FIG. 12A, the first a number of preambles out of all preambles are configured for CBRA preamble. If a 2-step RACH is configured, the preambles for 2-step RACH can be a part of the remaining preambles. Preambles for the 2-step RACH can be starting from the lowest number (as shown in FIG. 12A) or the highest number or any preambles with a certain pre-determined rule. Preambles not used for 4-step CBRA and 2-step RACH can be further used for the CFRA by network determination.

Note that PRACH resource partition between the 4-step CBRA, the 2-step RACH, and CFRA can be realized in time, frequency or code domain, or a combination thereof.

In some aspects, the configuration signaling can indicate the number of preambles for 2-step RACH only, or it can also indicate the exact preambles, e.g., starting position and number of preambles.

Resource multiplexing of uplink channels for 2-step RACH resource.

As mentioned above, the first step is the transmission of Msg-A and it can include the PRACH preamble (Msg-1) and corresponding uplink data channel (Msg-3), e.g., PUSCH. The aspects of multiplexing between PRACH preambles and corresponding PUSCH are provided hereinbelow.

In one aspect, the Msg-1 (PRACH preamble) and Msg-3 (corresponding uplink data channel) are multiplexed in TDM (time domain multiplexing) manner, as illustrated in FIG. 12B. FIG. 12B illustrates TDM multiplexing 1202 between Msg-1 and Msg-3 (inside Msg-A), in accordance with some aspects. Msg-1 and Msg-3 are not transmitted at the same time but at different times. In addition, frequency position for Msg-1 and Msg-3 can be either same or different. Further, the same or different numerologies can be employed for the transmission of Msg-1 and Msg-3.

For the transmission of Msg-1 and Msg-3, the exact resource for both channels has to be indicated to the UE. The indication can be done by system information, e.g., RMSI, SIB-1, or SIB-X, where X is an integer number. Inside the indication, all of some of the frequency position of each channel, slot information or OFDM symbol information for each channel, the time gap between Msg-1 and Msg-3 can be included. Note that it may be possible that the time gap is not included between Msg-1 and Msg-3 transmission. This may be applied for the case when the same numerology is employed for the transmission of Msg-1 and Msg-3.

In some aspects, if a UE performs the 2-step RACH operation, the UE transmits Msg-1 in the resource configured for 2-step RACH and then also transmit Msg-3 in the configured resource.

In another aspect, the Msg-1 (PRACH preamble) and Msg-3 (corresponding uplink data channel) are multiplexed in FDM (frequency domain multiplexing) manner, as illustrated in FIG. 12C. FIG. 12C illustrates FDM multiplexing 1204 between Msg-1 and Msg-3 (inside Msg-A), in accordance with some aspects. Msg-1 and Msg-3 are transmitted at the same time but at different frequency parts. Furthermore, the same or different numerologies can be employed for the transmission of Msg-1 and Msg-3.

For the transmission of Msg-1 and Msg-3, the exact resource for both channels may be indicated to the UE. The indication can be done by system information, e.g., RMSI, SIB-1, or SIB-X, where X is an integer number. Inside the indication, all or some of the frequency position of each channel, slot information or OFDM symbol information for each channel, frequency gap between Msg-1 and Msg-3 can be included. In some aspects, the frequency gap is not included between Msg-1 and Msg-3 transmission. This may be applied for the case when the same numerology is employed for the transmission of Msg-1 and Msg-3.

If a UE performs the 2-step RACH operation, the UE transmits Msg-1 in the resource configured for the 2-step RACH and then also transmit Msg-3 in the configured resource.

In another aspect, the transmission of MSg-3 can use NOMA aspects. For the transmission of NOMA, one MA (Multiple Access) signature may be used by the UE. The MA signature and/or MA resource can have an association with PRACH preamble. If a UE chooses a PRACH preamble out of the configured preamble set, the MA signature and/or the MA resource are determined based on the selected PRACH preamble. The network may first detect the UE by the reception of PRACH preamble and performs the reception of Msg-3 using NOMA receiver in accordance with the determined MA signature. The NOMA approach can include some or all of spreading, scrambling, interleaving, sparse mapping, and etc.

In some aspects, the TBS or MCS for Msg-3 can be configured by the system information along with the configuration of the PRACH preamble resources, or by TBS and MCS can be dependent on which preamble is chosen, which resource is chosen, etc.

Information for Msg-A and Msg-B.

The detailed information for Msg-A and Msg-B may be determined as described hereinbelow.

In one aspect, the information for Msg-A can be all or part of the information of Msg-1 and Msg-3. The information for Msg-B can be all or part of the information of Msg-2 and Msg-4. One example of Msg-A and Msg-B can be seen in Table 2. As shown in Table 2, there can be two scenarios for 2-step RACH: (1) for short-latency RRC connection: UE goes into the connected mode with reduced latency, and (2) for short message transmission: UE just transmits small size of data without transition from idle mode to connected mode

Depending on the scenarios, the information for Msg-A and Msg-B can be different. The network may configure one scenario out of the two or configure both scenarios. If both scenarios are configured, then the network may have a different resource for different scenarios or one resource for both scenarios. If the resource is shared between two scenarios, a UE may transmit the selection information between two scenarios by indicating the selection information inside Msg-A.

TABLE 2
Information for Msg-A and Msg-B for 2-step RACH

| | | 2-step RACH | | |
|---|---|---|---|---|
| | | | | For short |
| | | | For RRC | message w/o |
| 4-step RACH | | | connection | RRC connection |
| Msg- | Preamble index, | Msg- | Preamble index, | Preamble index, |
| 1 | SSB mapping, | A | UE contention | Contention |
| | Group A/B | | resolution ID, | resolution ID, |
| Msg- | Contention | | RRC connection | Message itself |
| 3 | resolution ID, | | request | with cause value |
| | RRC connection | | | |
| | request | | | |
| Msg- | RA-RNTI in | Msg- | RA-RNTI, TA, C- | RA-RNTI, |
| 2 | PDCCH, RAPID, | B | RNTI contention | contention |
| | TA, TC-RNTI, | | resolution ID, | resolution ID |
| | UL, grant | | RRC connection | (No RAPID, No |
| Msg- | Contention | | configuration. | TA, No C-RNTI, |
| 4 | resolution ID, | | (No RAPID, No | No UL Grant) |
| | RRC connection | | UL Grant) | |
| | configuration | | | |

In some aspects, techniques for handling parallel downlink transmissions by a UE can be used as disclosed hereinbelow.

A UE can receive one or multiple downlink (DL) transmissions in parallel and one or more of those parallel transmissions may have overlap in time and/or frequency. Parallel transmissions may correspond to the same or different service types. One service, such as ultra-reliable low latency communication (URLLC), may have more priority or stringent latency constraint than another service such as mobile broadband or other non-critical machine type communications. An urgent transmission may require pre-emption of resources of any ongoing non-urgent transmission. The network may signal which resources are preempted so that impacted transmission may be decoded ignoring polluted bits. It may be possible that one or more of the parallel transmissions to the UE can be exempted from pre-emption, such as if the transmission comprises a URLLC packet. The UE may identify which transmission is non-preemptible. Moreover, if network later sends a signaling (preemption indication, or PI) identifying which resources are preempted, how UE processes this signaling if the indicated preempted resource overlaps with the resource of a non-preemptible transmission.

Handling of parallel downlink (DL) transmissions, with potential overlap, has not been discussed in the standards yet. Standards have only agreed on semi-static switching on/off PI monitoring. However, semi-static PI monitoring switching cannot resolve the case when a UE receives parallel transmissions, with potential overlap, and the UE may need to identify whether one or both of the transmissions can be preempted.

In some aspects, a UE may identify a certain transmission is non-preemptible by some rules, semi-static configurations, L1 signaling, or a combination thereof. Alternatively, transmission identified as non-preemptible may also be regarded as a transmission that is prioritized and may not be dropped if its resource overlaps with other transmission(s). Techniques disclosed herein can include detailing UE behavior for handling PI in case it indicates an overlap of preempted resources and resources of non-preemptible transmission. Disclosed techniques further help the UE identify which transmission is non-preemptible and how to handle decoding of such transmission if UE receives a PI signaling later that indicates preempted resources overlap with the resources of a non-preemptible transmission.

The disclosed techniques include two sections. The first section discusses mechanisms of identifications by a UE whether transmission can be preempted or not. The second section provides UE behavior of handling such identification for processing a DL transmission or PDSCH with or without PI signaling.

In some aspects, a UE may be configured, e.g., semi-statically, or it may be defined in the specifications as an optional UE capability, to receive up to N unicast PDSCH transmissions within a given interval X, such that out of N possible unicast PDSCHs, up to M<=N PDSCHs may overlap in time, e.g., may overlap by at least one OFDM symbol. The unicast PDSCHs that overlap in time are assumed to not overlap in frequency. As a variant, the UE may indicate that it is capable of receiving up to N unicast PDSCH transmissions within a given interval X, such that out of N possible unicast PDSCHs, up to M<=N unicast PDSCHs may be simultaneously received at any given time within the time interval X.

In some aspects, the duration of interval X can be a group of symbols, or a slot or a group of slots. The interval can be semi-statically configured as well. A slot may comprise 7 or 14 symbols. The value of N can be 2, 4, 7, or any other integer. The values of N, M, and duration of X may or may not be numerology-dependent.

Below, for convenience, we consider examples of M=2, i.e., at a given time, two PDSCHs of a UE may overlap in time. However, this can be generalized for other values of M. Additionally, examples for N=2 and 3 are also illustrated.

In the following description, intra-UE multiplexing refers to the case when at least two PDSCHs scheduled to a UE overlap in terms of assigned resources, in time or time-and-frequency.

Signaling and configuration for identification of a non-preemptible (or prioritized) transmission.

In some aspects, a UE may receive one or more configuration signaling from the network, either semi-statically or dynamically, during or before receiving a DL data transmission to identify whether the DL data transmission can be exempted from preemption. In other words, signaling may indicate whether the DL transmission can be dropped or not or whether the transmission is prioritized over other transmission(s). Instead of or along with such configuration, the UE may also assume some defined rules to identify such transmission. It may be useful when UE can receive transmission of mixed services. Transmission of one service type may be preempted, whereas another transmission to the UE of different service type maybe urgent and not subject to preemption. It should be understood that in the context of the present disclosure, a transmission identified as non-preemptible may also be categorized as a transmission that is prioritized or may not be dropped in case of overlap with other transmission(s).

Technique 1: The UE receives configuration (e.g., semi-static or dynamic) of one or more values of duration T so that if a UE is signaled transmission comprising one of those durations, that transmission is assumed non-preemptible. The duration T can be one symbol, or group of contiguous or noncontiguous symbols such as 2, 4, 7 symbols, one slot or group of contiguous or non-contiguous slots.

Semi-static configuration can be provided for e.g., by UE specific RRC signaling. In one example, this configuration can be part of UE-specific Bandwidth part (BWP) RRC configurations of a UE, e.g., 15 KHz BWP may have values of T less than 7 symbols, whereas a 60 KHz BWP may have values of T up to 1 or 2 slots.

In another aspect, this configuration can be group-common. The group-common signaling can be conveyed in a group-common DCI or semi-statically in system information or another form of RRC signaling.

Technique 2: The UE may be configured with certain DCI format and/or control resource set (CORESET)/search space properties that can be associated with a non-preemptible transmission. For example, if a given DCI format is received/detected with aggregation level equal or larger than a threshold, e.g., 8 or 16, the UE may assume the scheduled transmission is protected from preemption. Furthermore, if PDCCH repetition or scheduling DCI repetition is configured and/or signaled for a given PDSCH, the UE may assume that PDSCH is exempted from preemption. For example, if PDCCH repetition number is larger than one is signaled for a HARQ process, the UE may assume the scheduled transmission of that HARQ process and/or subsequent transmissions of that HARQ process before ACK is detected are exempted from preemption

Technique 3: Identification of a non-preemptible transmission can be associated with a certain BWP. For example, if a UE supports multiple BWP configurations, transmission in one or more of the configured BWPs can be assumed non-preemptible. For example, a UE may support 15 KHz and 60 KHz BWPs. Transmissions in 60 KHz BWP maybe assumed non-preemptible. i.e., no intra-UE multiplexing may be allowed in some given BWPs. A UE supporting both enhanced mobile broadband (eMBB) and ultra-reliable low-latency communications (URLLC), may assume URLLC traffic would be provided in 60K Hz BWP. UEs supporting either eMBB or URLLC only may have transmissions in either BWPs.

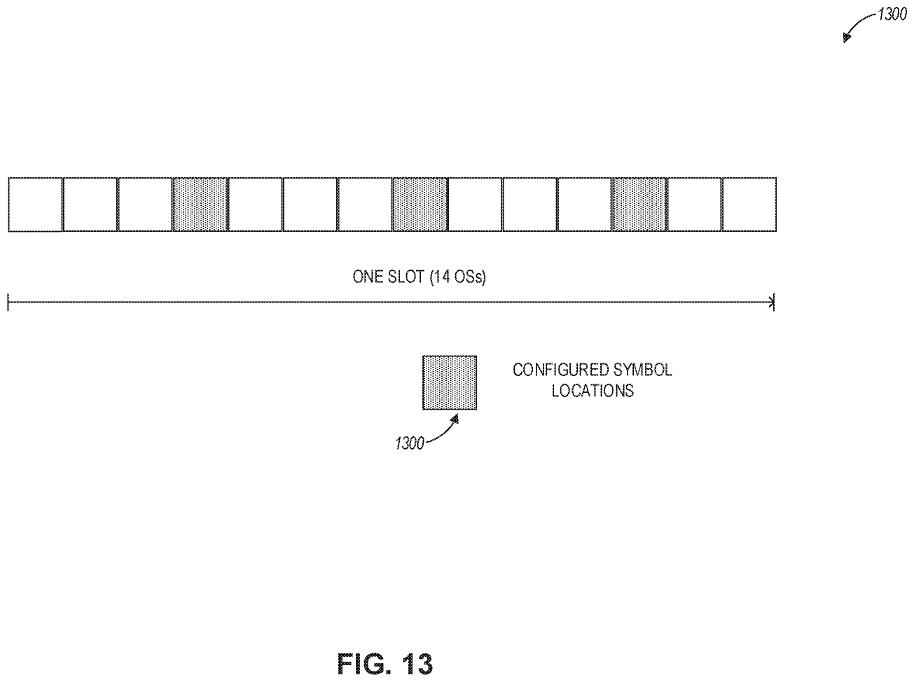

Technique 4: Some symbol locations within a slot can be configured for receiving non-preemptible transmissions. The supported symbol locations may have one or more configured offsets from slot boundary. When a PDSCH assigned to the UE starts from one of those locations or PDCCH received in one of those locations, the UE may assume the scheduled transmission is non-preemptible. Offset(s) for symbol locations within a slot can be any value from 2 to 13. In FIG. 13, there is illustrated an aspect where the offset is 3, 7, and 11. FIG. 13 illustrates configuring symbols within a slot 1300 for receiving a non-preemptible low latency transmission, in accordance with some aspects. As illustrated in FIG. 13, the offset is calculated from the start of slot or first symbol of a slot.

Technique 5: A UE may be configured with an RRC configuration to monitor PI, i.e., RRC signaling may turn on or off PI monitoring. However, it may confuse the UE if the UE receives one or more transmissions which may not be preempted, i.e., for which transmission(s), the UE takes PI into account, for which it does not. One approach can be scheduling DCI or PDCCH of the non-preemptible PDSCH includes a flag which indicates the UE to ignore PI indication for this transmission. In one example, RRC PI monitoring switch can be off, DCI flag can be true, then UE monitors PI only following that transmission in the next K=>1 monitoring occasions, and may take PI into account only for that transmission. K can be a configured value. The UE may stop monitoring PI until triggered by RRC or DCI. In another example, RRC PI monitoring switch can be on, DCI flag can be false, then the UE may ignore PI only for that transmission although it may be monitoring PI for other transmissions.

UE Behaviors for Handling Parallel DL Transmissions

As mentioned above, a UE may receive one or more parallel DL transmission. One or more of those transmissions may have higher priority than other parallel transmissions. In some aspects, parallel transmissions can be made in orthogonal resources, in some cases, the network may schedule parallel transmissions with overlapping resource assignment. In case of overlap in frequency and time, the UE would prioritize the imminent transmission and assume the ongoing transmission is not made in the overlapping resources.

Furthermore, a given UE may support both eMBB and URLLC services. The eMBB packets may be subject to preemption however URLLC packets may not be. Hence, if a UE receives PI, the UE may have different behaviors in terms of the application of the preemption information for different parallel DL transmission. For example, if the indicated preempted resource includes assigned resource of a non-preemptible transmission, the UE would ignore the PI for that transmission, however, the PI information may still be relevant if the UE has other ongoing transmissions that can be preempted.

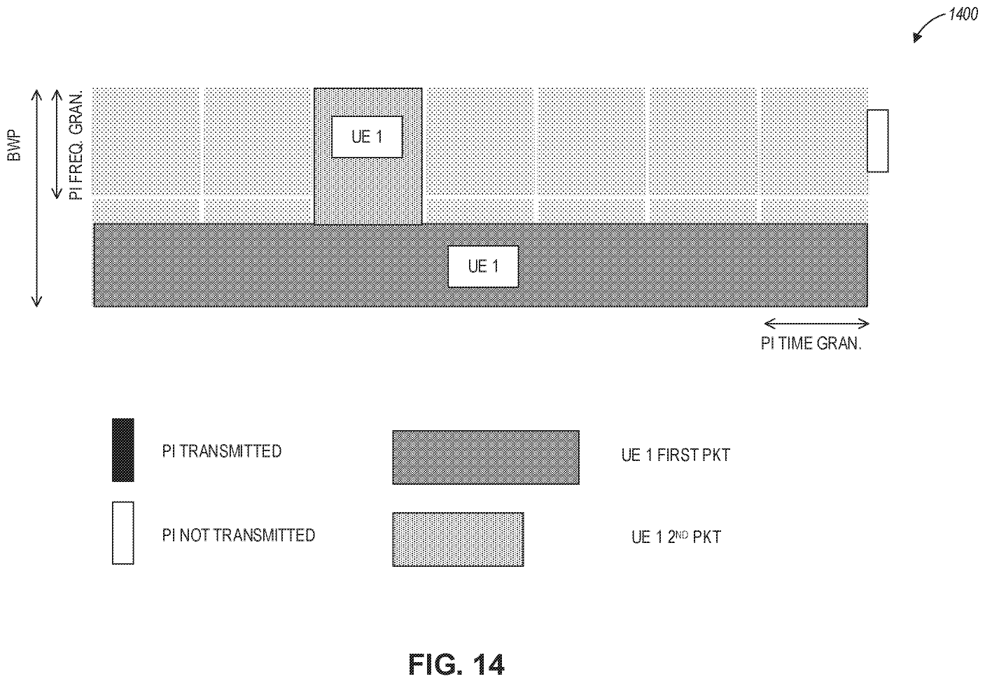

Below, we identify some cases to explain UE behaviors. Each of the parallel transmission may comprise a duration of 2 or 4 or 7 symbols or a slot or group of slots. Some of FIG. 14-FIG. 19 illustrate a duration of seven-time partitions, each time partition can be 2 or 4 or 7 or 14 symbols. Low latency/non-preemptible transmission is assumed to occupy one-time partition, whereas latency tolerant or preemptable transmission is seven partitions long. PI monitoring periodicity is also assumed to be seven-time partitions. However, this is only an example. Even though FIGS. 14-19 illustrate transmissions to UE 1, there can be transmissions made to other UEs as well.

FIG. 14 illustrates UE behavior 1400 for handling parallel downlink transmissions when assigned resources to two PDSCH are orthogonal, in accordance with some aspects. Case 1-a is illustrated in FIG. 14, where N=2 and assigned resources to two PDSCH are orthogonal. No PI is received. The UE receives and decodes two transmissions in parallel. The UE may or may not have received prior configuration information related to a second packet. PI time and frequency granularities are indicated in FIG. 14 as “PI time gran.” and “PI freq. gran.”, respectively.

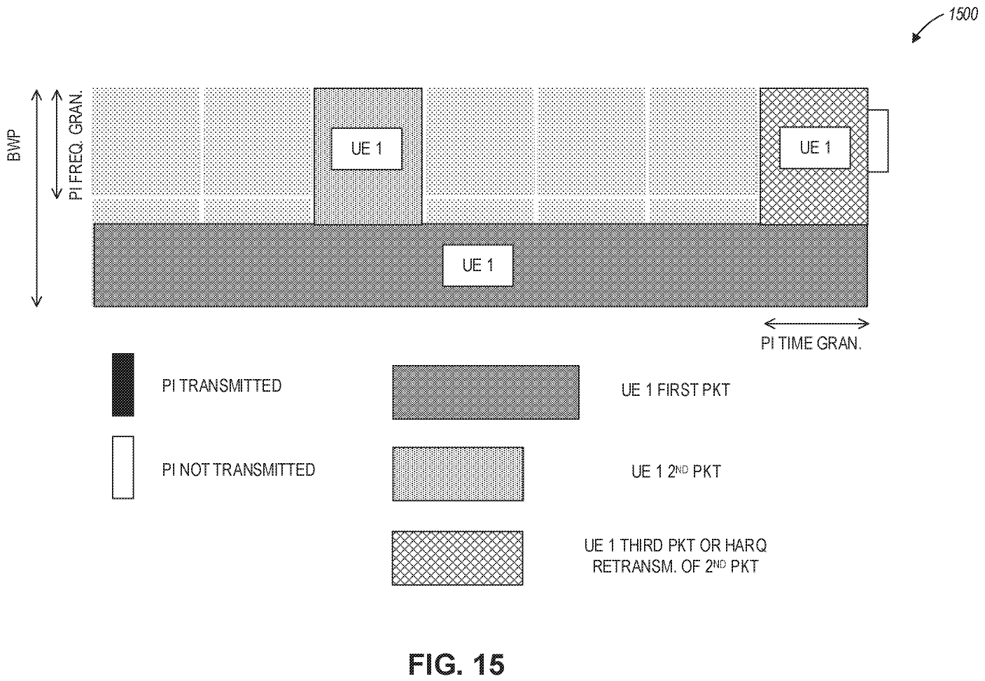

FIG. 15 illustrates UE behavior 1500 for handling parallel downlink transmissions when assigned resources to three PDSCH are orthogonal, in accordance with some aspects. Case 1-b is illustrated in FIG. 15, where N=3 and assigned resources to three PDSCHs are orthogonal. No PI is received. The UE receives and decodes transmissions in parallel. The UE may or may not have received prior configuration information related to the second packet or the third packet. The third packet may be HARQ retransmission of the second packet. In one aspect, separate configuration or indication may not be needed for HARQ retransmission of a packet, i.e., if UE identifies a HARQ process is non-preemptible during initial transmission, it may assume its subsequent retransmissions are also non-preemptible.

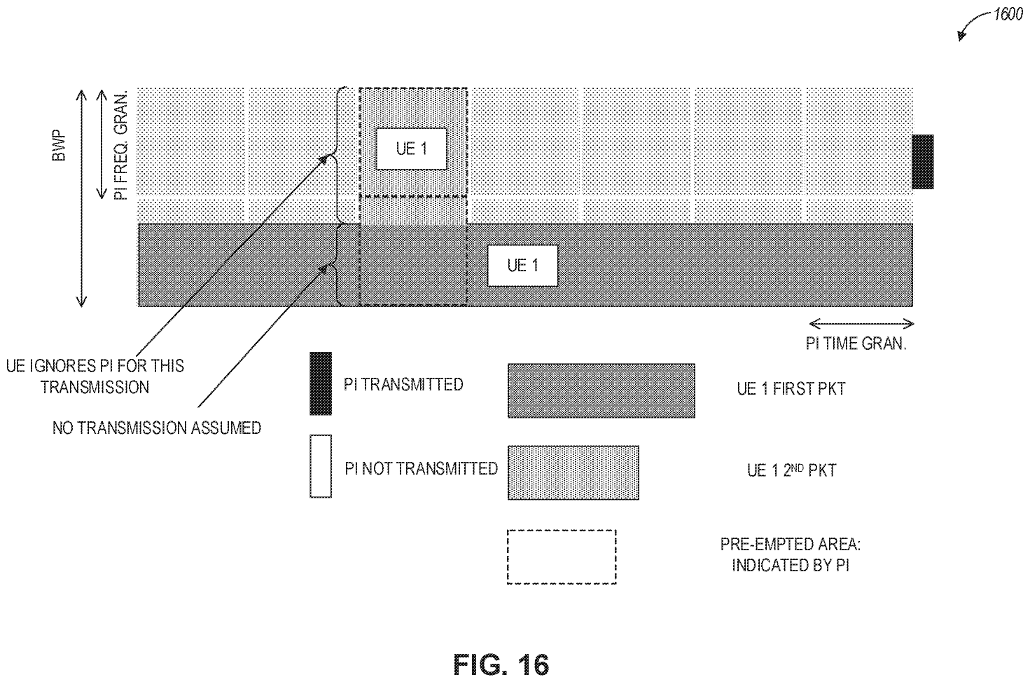

FIG. 16 illustrates UE behavior 1600 for handling parallel downlink transmissions in connection with orthogonal resources assignment for parallel transmissions, in accordance with some aspects. Case 2 is illustrated in FIG. 16, where orthogonal resources are assigned for parallel transmissions. The UE receives the PI. The UE takes PI into account for the first packet and assumes no transmission was made in the indicated preempted area. The UE ignores PI for the second packet, i.e., assumes transmission of the second packet is made even if it falls within the indicated preempted area.

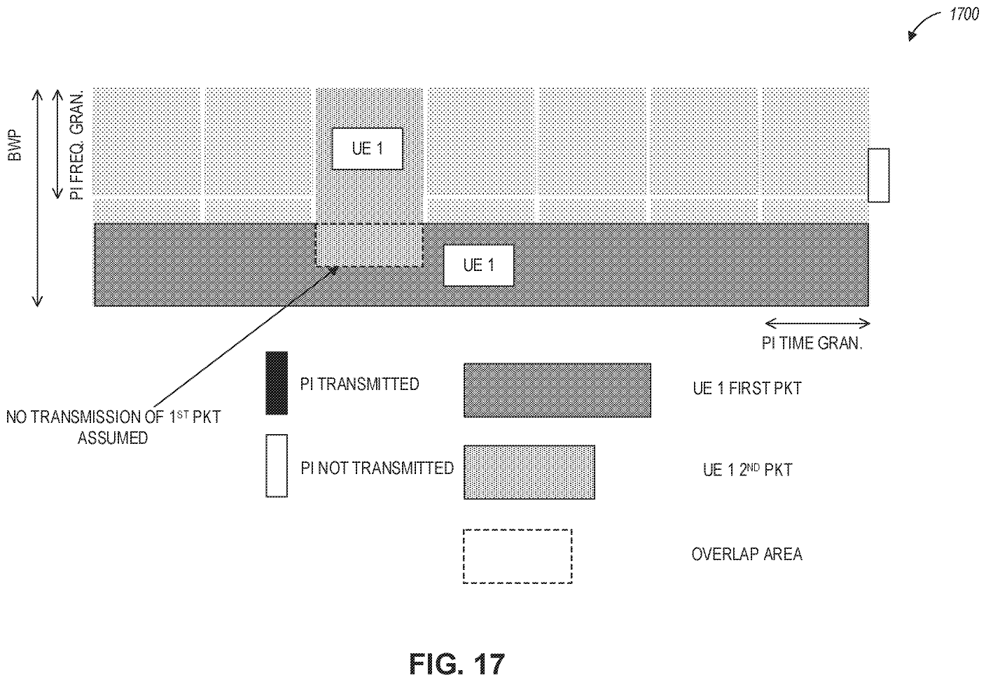

FIG. 17 illustrates UE behavior 1700 for handling parallel downlink transmissions in connection with overlapping resources assignment for parallel transmissions, in accordance with some aspects. Case 3 is illustrated in FIG. 17, where overlapping resources are assigned for parallel transmissions. The UE does not receive a PI. The transmission of the second packet takes priority over the first packet. The UE assumes no transmission of the first packet was made within the area of overlap with resources of the second packet. This approach has no impact on the transmission of the first packet outside the area of overlap.

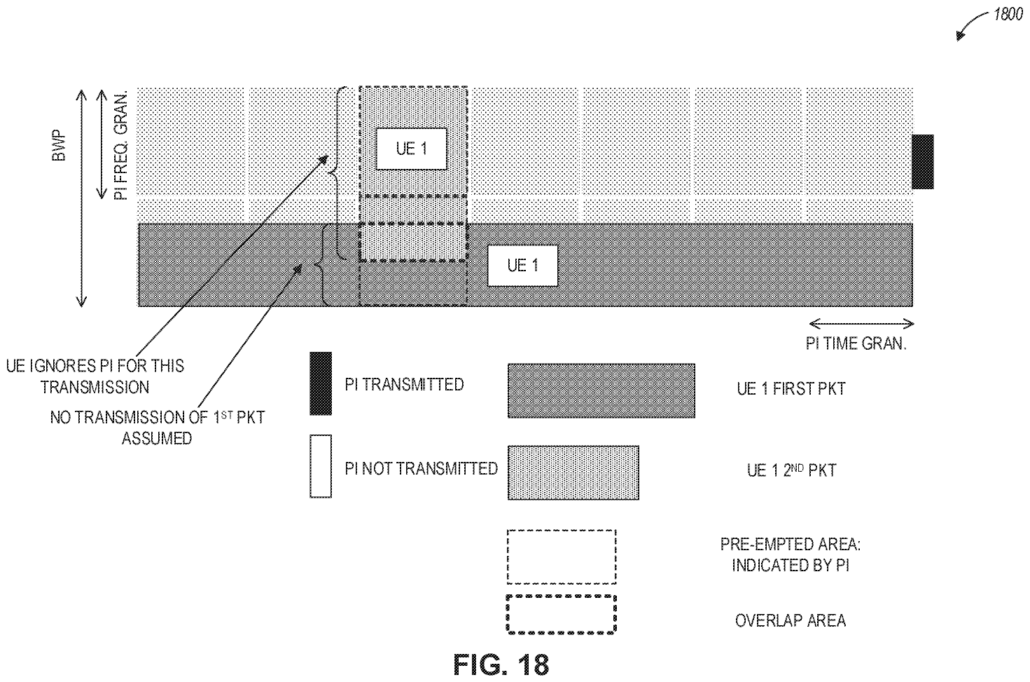

FIG. 18 illustrates UE behavior 1800 for handling parallel downlink transmissions in connection with overlapping resources assignment for parallel transmissions, in accordance with some aspects. Case 4 is illustrated in FIG. 18, where overlapping resources are assigned for parallel transmissions. The UE receives the PI. The Network may transmit PI if there is overlap in resource assignments of different UEs (other UEs not shown in FIG. 18). In this case, the transmission of the second packet takes priority over the first packet. The UE assumes no transmission of the first packet was made within the area of overlap with resources of the second packet (the indicated overlap area in FIG. 18). This approach has no impact to transmission and processing of the first packet outside the area of the overlap until the PI is received. When the PI is received, the UE revises assumption of ‘no transmission’ if the pre-empted area overlaps with resources of 1st packet transmission. This is because there can be transmissions to other UEs within the pre-empted region, hence UE takes PI into account for the first packet to avoid any chance of decoding of other UE's data. Further, the UE ignores PI for part of the pre-empted area if it overlaps with resources of the second packet (the second packet is assumed non-preemptible). The UE may assume first that no transmission of the first packet was made in the overlap area when the second packet is being received. Later, upon receiving the PI, the UE revises the assumption of ‘no transmission’ of the first packet and assumes that no transmission of the first packet is made within part of the pre-empted region that overlaps with the resources of the first packet.

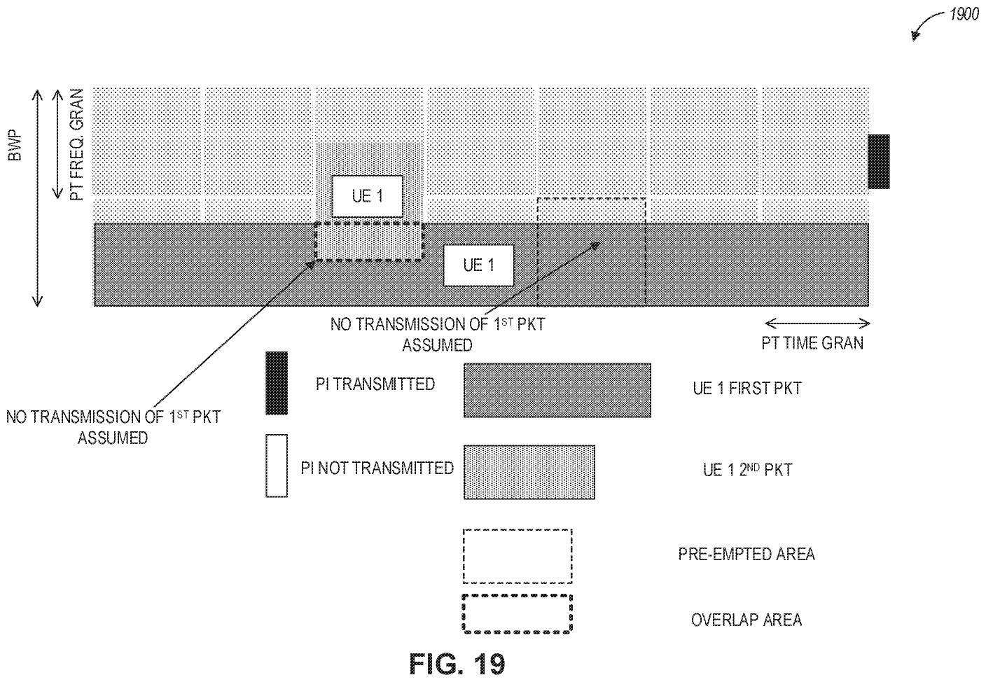

FIG. 19 illustrates UE behavior 1900 for handling parallel downlink transmissions in connection with overlapping resources assignment for parallel transmissions, in accordance with some aspects. Case 5 is illustrated in FIG. 19, where overlapping resources are assigned for parallel transmissions. The UE receives the PI. The PI may be received if there is overlap in resource assignments of different UEs (other UEs not shown in FIG. 19). In this scenario, the transmission of the second packet takes priority over the first packet. The UE assumes no transmission of the first packet was made within the area of overlap with resources of the second packet. This approach has no impact to transmission and processing of the first packet outside the area of overlap until the PI is received. When the PI is received, the UE assumes ‘no transmission’ is made within part of the pre-empted area that overlaps with resources of first packet transmission. There can be transmissions to other UEs during the pre-empted region, hence UE 1 takes PI into account for identifying the actual resources where the first packet transmission was made. The difference between Case 5 and Case 4 is that the PI does not indicate the region where the second packet is scheduled as pre-empted. This may be because the resource assignment of the second packet did not overlap with other UE's transmission.

In some aspects, a method of new radio (NR) communications includes indication from a UE, indicating capability to receive up to N unicast PDSCHs within a time interval X, such that up to M<=N unicast PDSCHs may overlap in time by at least one OFDM symbol. The limit of M unicast PDSCHs that the UE is capable of receiving simultaneously applies within the interval X. The limit of M unicast PDSCHs that the UE is capable of receiving simultaneously applies to any point in time within the interval X, i.e., the total number of unicast PDSCHs with time-domain overlaps with up to M−1 other unicast PDSCHs may be greater than M over the entire interval X. In any of the disclosed aspects, M=2, N=7, and X=slot duration for a given numerology (subcarrier spacing and cyclic prefix combination). In any of the disclosed aspects. M=2, N=2, and X=slot duration for a given numerology (subcarrier spacing and cyclic prefix combination)

A method for new radio (NR) communications includes receiving by a UE, a first configuration message, the configuration message identifies certain conditions of when transmission can be assumed non-preemptible. The method includes receiving by the UE, a first DL transmission, the first DL transmission identified to be non-preemptible. The method includes receiving by the UE, a first control signaling, the control signaling identifying pre-empted resources. The method includes processing the first DL transmission by the UE ignoring the indication of pre-empted resources if the preempted resources overlap with the resources of first DL transmission. The first configuration message is conveyed by RRC signaling. The configuration can be part of UE specific Bandwidth part (BWP) RRC configurations of a UE. The first configuration message is group-common. The group-common signaling can be conveyed in a group-common DCI or semi-statically in system information or another form of RRC signaling. The UE may be configured with certain DCI format and/or control resource set (CORESET)/search space properties that can be associated with a non-preemptible transmission. If PDCCH repetition or scheduling DCI repetition is configured and/or signaled for a given PDSCH, the UE assumes that PDSCH is exempted from preemption. If PDCCH repetition number larger than one is signaled for a HARQ process, the UE assumes the scheduled transmission of that HARQ process and/or subsequent transmissions of that HARQ process before ACK is detected are exempted from preemption.

Identification of a non-preemptible transmission can be associated with a certain BWP. Accordingly, if a UE supports multiple BWP configurations, transmission in one or more of the configured BWPs can be assumed non-preemptible. UEs supporting either eMBB or URLLC only may have transmissions in either BWPs. Some symbol locations within a slot can be configured for receiving non-preemptible transmissions. The supported symbol locations may have one or more configured offsets from slot boundary. When a PDSCH assigned to the UE starts from one of those locations or PDCCH received in one of those locations, UE may assume the scheduled transmission is non-preemptible. Offset(s) for symbol locations within a slot can be any value from 2 to 13, or 3, 7, 11. The UE may be configured with an RRC configuration to monitor PI, i.e., RRC signaling may turn on or off PI monitoring. Scheduling DCI or PDCCH of the non-preemptible PDSCH includes a flag which indicates the UE to ignore PI indication for this transmission. RRC PI monitoring switch can be off, DCI flag can be true, then UE monitors PI only following that transmission in the next K=>1 monitoring occasions, and may take PI into account only for that transmission. K can be a configured value. Then UE stops monitoring PI until triggered by RRC or DCI. RRC PI monitoring switch can be on, DCI flag can be false, then UE ignores PI only for that transmission although it may be monitoring PI for other transmissions.

In some aspects, NR RRM enhancements for unlicensed band operation can be configured using one or more techniques disclosed herein.

Rel-15 NR systems can be designed to operate on licensed spectrum. The NR-unlicensed, a short-hand notation of the NR-based access to unlicensed spectrum, is a technology that enables the operation of the NR system on the unlicensed spectrum. In the unlicensed operation, there is a need for the introduction of new measurement/reports in addition to the conventional measurements/reports defined for licensed operation, e.g., RSRP, RSRQ, etc.

New measurement reports can be beneficial for unlicensed band channel selection to choose a channel that is currently less congested. The channel selection can be made more elaborated by taking into account the presence of other technologies sharing the same spectrum.

Rel-15 NR systems support wider maximum channel bandwidth (CBW) than LTE's 20 MHz. Wideband communication is also supported in LTE via CA of up to 20 MHz component carriers (CCs). By defining wider CBW in NR, it is possible to dynamically allocate frequency resources via scheduling, which can be more efficient and flexible than the CA operation. In addition, having a single wideband carrier has merit in terms of low control overhead as it needs only single control signaling, whereas CA requires separate control signaling per each aggregated carrier. Moreover, the spectrum utilization can be improved by eliminating the need for guardband between CCs.

For a given wide CBW, it may be beneficial to perform measurement/report not only for the wideband but also in the unit of sub-bands in the consideration of Wi-Fi 20 MHz channelization. Techniques disclosed herein can be used for various enhancements to NR RRM and to improve the unlicensed band operation.

In some aspects, the following measurements/reports can be supported for NR: RSSI measurement/report; channel occupancy measurement/report; measurement/report on the presence of other technologies (e.g., Wi-Fi systems including but not limited to IEEE 802.11a/b/g/n/ac/ax/ad/ay, and/or LTE unlicensed including but not limited to LAA/eLAA/FeLAA, MuLTEfire, etc.); measurement/report on the presence of same NR-unlicensed technology; and measurement/report on the RSSI/channel occupancy from signals of the same operator networks is supported for NR.

For the above-listed measurements/reports, the following reporting options can be supported: instantaneous and/or average measurement reports; quantized measurement reports; and wide-band and sub-band measurement reports. In some aspects, the measurements/reports can be utilized by the network for unlicensed channel selection.

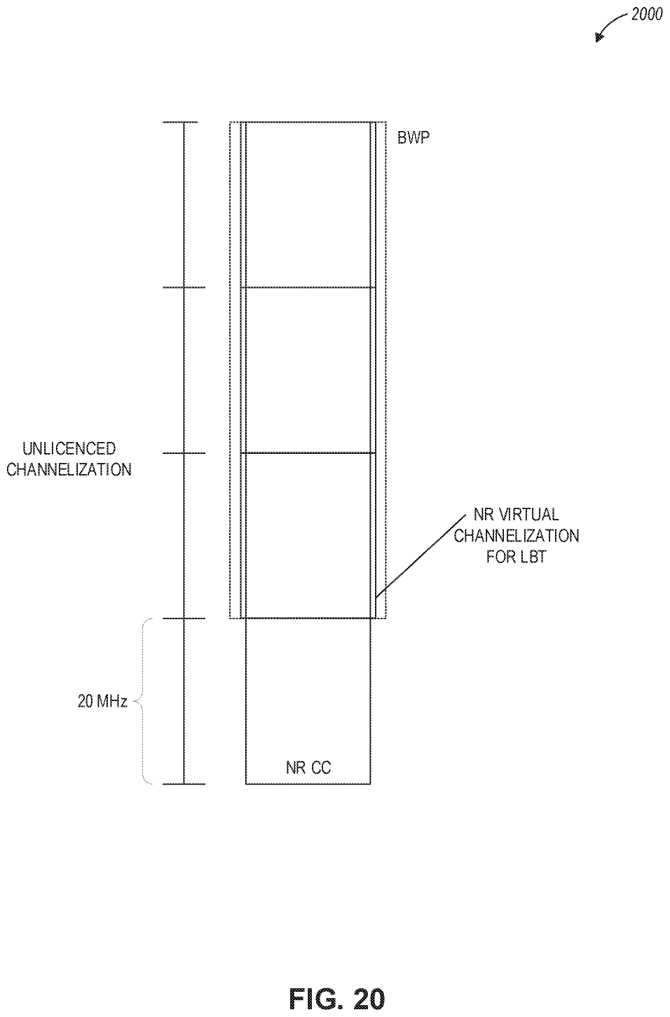

FIG. 20 illustrates NR wide channel bandwidth 2000, in accordance with some aspects.

Techniques disclosed herein can be used to enhance NR RRM measurement that can be potentially used by the network for unlicensed channel selection, etc. In some aspects, the RSSI measurement/report is supported. RSSI measurement timing configuration (RMTC) is introduced. RMTC has configurable periodicity and may take values from {40, 80, 160, 320, 640} ms. In the absence of RMTC configuration, a UE may autonomously select the timing for inter-frequency measurements.

In some aspects, channel occupancy measurement/report is supported. The measurement report is in the form of a percentage that the channel is being occupied. The channel is measured as being occupied if the detected energy level is above a certain threshold. The threshold is signaled to the UE. The threshold is a fixed constant value, e.g., −72 dBm. The threshold is the ED threshold value of the UE based on the transmission power. A system-specific measurement can be also used such as Wi-Fi preamble detection, LTE CRS detection, and NR RS detection including signals that may be introduced later, e.g., NR preamble, etc.

In some aspects, measurement/report on the presence of other technologies (e.g., Wi-Fi systems including but not limited to IEEE 802.11a/b/g/n/ac/ax/ad/ay, and/or LTE unlicensed including but not limited to LAA/eLAA/FeLAA, MuLTEfire, etc.) is supported. For the measurement of the presence of Wi-Fi technologies, Wi-Fi preamble detection is used. For the measurement of the presence of LTE unlicensed technologies, CRS detection is used.

In some aspects, measurement/report on the presence of the same NR-unlicensed technology is supported. The NR RS detection including signals that may be introduced later, e.g., NR preamble, etc.

In some aspects, measurement/report on the RSSI/channel occupancy from signals of the same operator networks are supported for NR.

In some aspects, for the above-listed measurements/reports, the following reporting options are supported: instantaneous and/or average measurement reports are supported. The L1 measurement can be performed over X number of symbols, e.g., 1. The L1 measurement can be aggregated over a certain duration, e.g., N number of L1 measurements or T ms, to produce average measurement.

In some aspects, a quantized measurement report is supported. For instance, the measured values are quantized over M ranges of values and the index of the corresponding range is reported.

In some aspect, a wide-band and sub-band measurement report is supported (since NR supports wideband operation and the measurement can be quite different in the different parts of the spectrum within the wideband carrier).

For instance, and in reference to FIG. 20, if the measurement is performed for a wide channel BW, e.g., 80 MHz, both wide-band measurement for 80 MHz and sub-band measurement for each four 20 MHz BW parts is supported. In some aspects, the BW that the sub-band measurement is performed can be aligned with the LBT BW grid.

In some aspects, the following measurements/reports are supported for NR:

RSSI measurement/report. RSSI measurement timing configuration (RMTC) is introduced; RMTC has configurable periodicity and may take values from (40, 80, 160, 320, 640) ms; in the absence of RMTC configuration, a UE may autonomously select the timing for inter-frequency measurements.

Channel occupancy measurement/report. The measurement report is in the form of a percentage that the channel is being occupied. Channel is measured as being occupied if the detected energy level is above a certain threshold. The threshold is signaled to UE. The threshold is a fixed constant value, e.g., −72 dBm. The threshold is the ED threshold value of the UE based on the transmission power. A system-specific measurement can be also used such as Wi-Fi preamble detection, LTE CRS detection, and NR RS detection including signals that may be introduced later, e.g., NR preamble, etc.

Measurement/report on the presence of other technologies (e.g., Wi-Fi systems including but not limited to IEEE 802.11a/b/g/n/ac/ax/ad/ay, and/or LTE unlicensed including but not limited to LAA/eLAA/FeLAA, MuLTEfire, etc.). For the measurement of the presence of Wi-Fi technologies, Wi-Fi preamble detection is used. For the measurement of the presence of LTE unlicensed technologies, CRS detection is used.

Measurement/report on the presence of same NR-unlicensed technology. NR RS detection including signals that may be introduced later, e.g., NR preamble, etc.

Measurement/report on the RSSI/channel occupancy from signals of the same operator networks is supported for NR.

For the above-listed measurements/reports, the following reporting options are supported:

Instantaneous and/or average measurement reports. L1 measurement is performed over X number of symbols, e.g., 1. L1 measurement is aggregated over a certain duration, e.g., N number of L1 measurements or T ms, to produce average measurement.

Quantized measurement report. Wide-band and sub-band measurement report. For instance, if the measurement is performed for a wide channel BW, e.g., 100 MHz, both wide-band measurement for 100 MHz and sub-band measurement for each five 20 MHz BW is supported. The BW that the sub-band measurement is performed can be aligned with the LBT BW grid.

In some aspects, techniques disclosed herein can be used for the uniform and non-uniform interlace based uplink physical channel design for NR unlicensed (NR-U).

In legacy LTE, uplink (UL) transmission scheme was based on Single Carrier Frequency Division Multiple Access (SC-FDMA) approach, where the sub-carrier mapping could be either localized (contiguous in frequency) or distributed (non-contiguous in frequency) across the bandwidth of the physical channel. In contiguous mapping mode, the Discrete Fourier Transform (DFT) pre-coded input data for UL transmission occupy consecutive frequency sub-carriers within UL transmission bandwidth. On the other hand, for non-contiguous mapping scheme, DFT output of the input data are allocated across the entire bandwidth, with zeros occupying unused sub-carriers inserted in between sub-carriers used for transmission. The distributed mapping scheme, when designed so as to maintain the equidistant gap in between used sub-carriers is called Interleaved FDMA (IFDMA). A special case of SC-FDMA, IFDMA is particularly efficient a multiple access scheme with low complexity transmitter side implementation (time domain signal modulation without the use of DFT and IDFT), low computation complexity for channel equalization and user separation, low envelope fluctuation of transmitted signal, high frequency diversity gain, and high spectral efficiency even without the knowledge of channel state information (CSI) at the transmitter. However, IFDMA is prone to channel frequency offset (CFO) error and inter-carrier interference (ICI).

In the unlicensed spectrum, contiguous mapping of transmit data in UL across consecutive frequency sub-carriers is not efficient, since the occupied channel bandwidth (OCB) regulation has to be met. In addition, regulation constraining peak power spectral density (PSD) may forbid UE to fully utilize the maximum allowed total transmit power if contiguous mapping is used. IFDMA provides a plausible solution to get around the regulatory constraints, but the associated impairments like CFO error and ICI may curb the benefits IFDMA can possibly confer.

One way to mitigate the impact of CFO error and ICI is to use a special structure of IFDMA, called Block-IFDMA (B-IFDMA). In B-IFDMA, UEs are allocated equally spaced resource blocks (RBs) (e.g., physical resource blocks, PRBs) containing adjacent frequency sub-carriers (known as interlace), the blocks being spread across the entire transmission bandwidth. B-IFDMA may be less susceptible to phase noise than IFDMA and also has lower sensitivity to CFO while offering comparable frequency diversity gain as IFDMA. B-IFDMA has marginally higher peak-to-average power ratio (PAPR) compared to IFDMA. Depending on the time-frequency variability within an RB of interlace, channel estimation performance of B-IFDMA can be slightly better/worse than IFDMA with the same pilot overhead.

Techniques disclosed herein can be used for B-IFDMA based interlace design for NR-unlicensed uplink physical channel, where the interlace RB can be in the unit of a physical resource block (PRB) or, in the unit of a fraction of PRB, referred to as a sub-PRB, or a combination thereof in the frequency domain and can span any number of symbols within a subframe in time domain. Additionally, the proposed interlace design is flexible to be uniform or non-uniform, depending on whether each interlace interleaved across the bandwidth has the same number of resource blocks per interlace or not. Finally, the proposed interlace design is numerology scalable, i.e., the interlace designed for a physical channel with a specific numerology (i.e. a set of sub-carrier spacing and bandwidth configuration) can be scaled to deduce the interlace design of another physical channel with a different numerology (i.e. with a different set of sub-carrier spacing and/or bandwidth configuration). The baseline interlace design can be based on the B-IFDMA structure used in LTE unlicensed spectrum (for enhanced Licensed Assisted Access or eLAA UL waveform) for the design of physical uplink shared channel (PUSCH).

Legacy LTE-unlicensed interlace design is not suitable for NR-unlicensed spectrum, since NR spectrum utilization encompasses numerous numerology sets (i.e., configurations of sub-carrier spacing and bandwidth combinations), unlike the limited numerology specification (10 and 20 MHz bandwidths and 15 KHz sub-carrier spacing) for LTE-unlicensed. For LTE-unlicensed, uniform interlace design with 10 PRBs/interlace was sufficient to meet OCB and PSD related regulations, which may not be possible for NR-unlicensed. In fact, no simple uniform interlace design may be possible for some sub-carrier spacing bandwidth combinations where the number of PRBs available is multiples of prime numbers, for example, 51 PRBs for 20 MHz bandwidth and 30 KHz sub-carrier spacing.

Since NR-unlicensed is targeted for a much diverse numerology configuration, PRB-based uniform interlace design of LTE-unlicensed may not be the appropriate design choice especially for larger bandwidth, where each PRB spans over wide frequency range over which the channels may not remain frequency non-selective. Hence, the basic unit of interlace RB may be needed to be of finer granularity than 1 PRB (e.g., a fraction of a PRB may be used), unlike legacy LTE-unlicensed design.

LTE-unlicensed interlace design is numerology specific. Since NR-unlicensed is diverse in potential sub-carrier spacing-bandwidth combination sets to be supported, a numerology scalable interlace design would be relevant for NR-unlicensed physical channel design, contrary to the legacy LTE-unlicensed approach.

Techniques disclosed herein can be used for NR-unlicensed physical channel design for UL and B-IFDMA based interlace design for NR-unlicensed wideband operation to meet regulations. Such techniques are beneficial for enabling NR UL transmission over unlicensed spectrum, and enabling efficient resource utilization across various numerology sets while abiding by the regulatory constraints for NR UL transmission in the unlicensed spectrum.

B-IFDMA based interlace design for NR-unlicensed uplink.

In some aspects, a B-IFDMA based uniform interlace design may consist of one interlace as the basic unit of resource allocation and there may be a number of interleaved interlaces (indexed 0, 1, . . . , i−1; where i is an integer) that can be designed for a given physical channel, where each interlace may be composed of n resource blocks equally spaced in frequency domain, each consisting of x frequency sub-carriers, where n is an integer; and the separation between two consecutive resource blocks in the frequency domain may be of m blocks, with each block consisting of x frequency sub-carriers, where m is an integer.

In one option, x may be in units of physical resource blocks (PRBs), i.e. x=12 sub-carriers or 1 PRB, such that each interlace may consist of N (N=n*x) PRBs, with a separation of M (M=m*x) PRBs in between two consecutive resource blocks of the interlace, where N and M are integers.

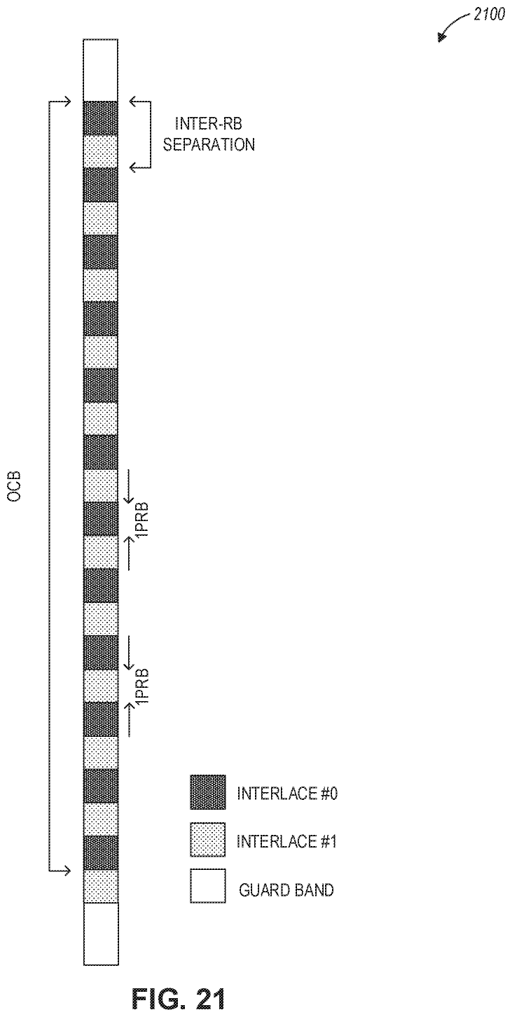

FIG. 21 illustrates an example 2100 of a PRB based uniform interlace including two interlaces with 12 PRBs per interlace, in accordance with some aspects. More specifically, FIG. 21 illustrates an example of PRB level B-IFDMA based interlace design for a physical channel with 20 MHz bandwidth and 60 kHz sub-carrier spacing, which has 24 PRBs. Two interleaved interlaces (interlace #0, interlace #1) with 12 PRBs per interlace may be designed for this channel. In the example in FIG. 21, {x=1 PRB, n=12, m=2}, and hence each interlace consists of N=12 PRBs with the separation between two consecutive PRBs within one interlace being M=2 PRBs. Occupied channel bandwidth is 16.56 MHz which is 82.8% (>80%) of the nominal channel bandwidth of 20 MHz, and inter-RB separation (i.e. separation between first sub-carriers of two consecutive resource blocks in an interlace) is 1.44 MHz (>1 MHz).

In another aspect, x may be in units of sub-PRB (i.e., fraction of a PRB), i.e. x=1 sub-PRB, where 1 sub-PRB=q PRB, 0<q<1. In this case, each interlace may consist of N (N=n*x) sub-PRBs, with a separation of M (M=m*x) sub-PRBs in between two consecutive resource blocks of each interlace.

In some aspects, the values of m (and hence M) would be incremented by 1 based on the definition of inter-RB distance.

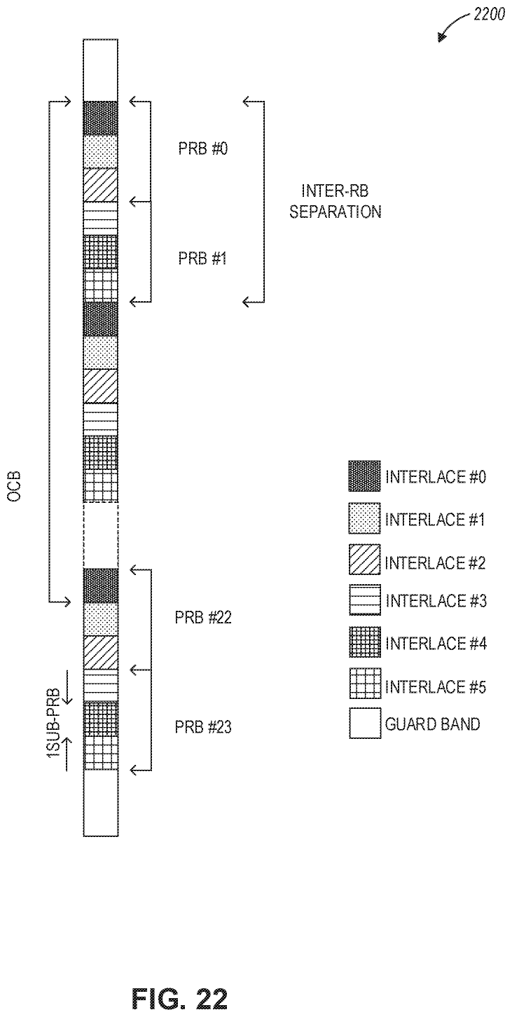

FIG. 22 illustrates an example 2200 of sub-PRB based uniform interlace including six interlaces with 12 sub-PRBs per interlace, in accordance with some aspects. More specifically, FIG. 22 illustrates an example of sub-PRB level B-IFDMA based interlace design for a physical channel with 20 MHz bandwidth and 60 kHz sub-carrier spacing, which has 24 PRBs. Six interleaved interlaces (interlace #0, . . . , interlace #5) with 12 sub-PRBs per interlace may be designed for this channel, where 3 consecutive sub-PRBs constitute 1 PRB, i.e. 1 sub-PRB=1/3 PRB=4 sub-carriers. In the example in FIG. 22, {q=1/3 PRB, n=12, m=6}, and hence each interlace consists of N=12 sub-PRBs with the separation between two consecutive sub-PRBs within an interlace being M=6 sub-PRBs. The occupied channel bandwidth is 16.08 MHz which is 80.4% (>80%) of the nominal channel bandwidth of 20 MHz, and the inter-RB separation (i.e. separation between first sub-carriers of two consecutive resource blocks (here, sub-PRBS) of an interlace) is 1.44 MHz (>IMHz).

In some aspects, a B-IFDMA based non-uniform interlace design may consist of one interlace as the basic unit of resource allocation, and there may be a number of interleaved interlaces (indexed 0,1, . . . , i−1) that can be designed for a given physical channel, where: (1) the j-th interlace (j=0, 1, . . . , i−1) may be composed of nⱼ resource blocks equally spaced in frequency domain, each consisting of x frequency sub-carriers, where nⱼ and x are integers; and (2) the separation between two consecutive resource blocks within the j-th interlace in the frequency domain may be of m blocks, with each block consisting of x frequency sub-carriers, where m is an integer.

In some aspects, x may be in units of physical resource blocks (PRBs), i.e. x=12 sub-carriers or 1 PRB, such that the j-th interlace may consist of Nⱼ (Nⱼ=nⱼ*x) PRBs, with a separation of M (M=m*x) PRBs in between two consecutive resource blocks of the j-th interlace, where Nⱼ and M are integers.

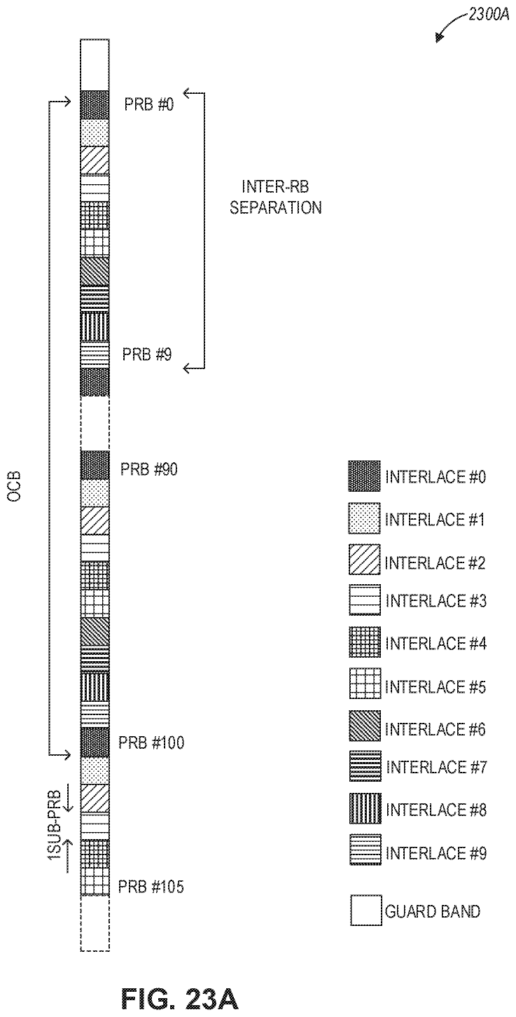

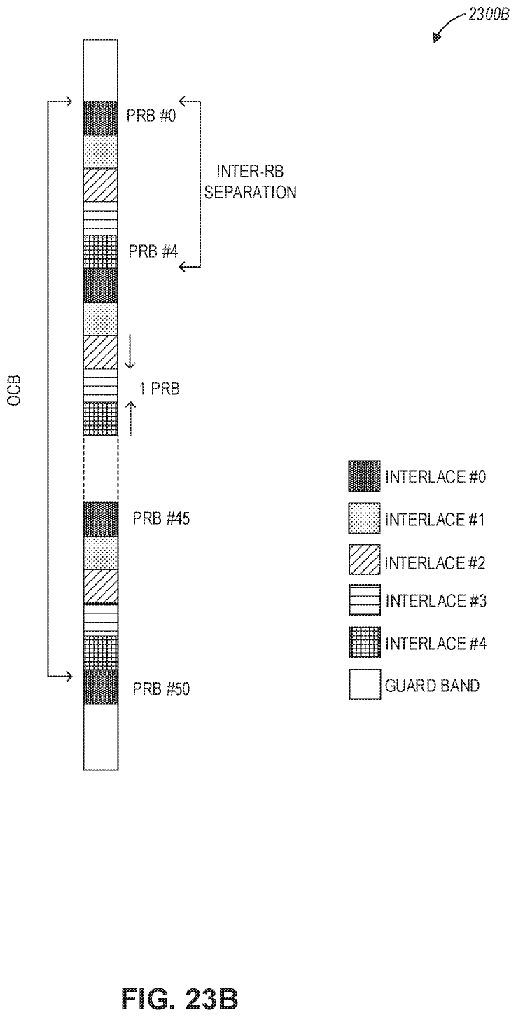

FIG. 23A illustrates an example 2300 A of PRB based non-uniform interlace including six interlaces with 11 PRBs per interlace and four interlaces with 10 PRBs per interlace, in accordance with some aspects. More specifically, FIG. 23A illustrates an example of PRB level B-IFDMA based non-uniform interlace design for a physical channel with 20 MHz bandwidth and 15 kHz sub-carrier spacing, which has 106 PRBs. Ten interleaved interlaces (interlace #0, . . . , interlace #9) may be designed for this channel, with 11 PRBs/interlace for {interlace #0, . . . , interlace #5} and 10 PRBs/interlace for {interlace #6, . . . , interlace #9). In the example of FIG. 23A, {x=1 PRB, nⱼ=11 for j=(0, . . . , 5) and nⱼ=10 for j=(6, . . . , 9), m=9}, and hence 6 interlaces indexed {interlace #0, . . . , interlace #5} each consists of N=11 PRBs with the separation between two consecutive PRBs within one interlace being M=10 PRBs, whereas 4 interlaces indexed {interlace #6, . . . , interlace #9} each consists of N=10 PRBs with the separation between two consecutive PRBs within one interlace being M=10 PRBs as well. The occupied channel bandwidth is 16.56 MHz which is 90.9% (>80%) of the nominal channel bandwidth of 20 MHz, and inter-RB separation (i.e. separation between first sub-carriers of two consecutive resource blocks in an interlace) is 1.8 MHz (>1 MHz).

In some aspects, the parameter M as used herein indicates a number of interlaces within a transmission bandwidth, and the parameter N indicates a number of PRBs within each interlace of the M number of interlaces.

FIG. 23B illustrates an example 2300B of PRB based non-uniform interlace for communications using 30 kHz subcarrier spacing (SCS) over 20 MHz nominal channel bandwidth, in accordance with some aspects.

In some aspects, x may be in units of sub-PRB (i.e., a fraction of a PRB), i.e., x=1 sub-PRB, where 1 sub-PRB=q PRB, 0<q<1. In this case, the j-th interlace may consist of Nj (Nj=nj*x) sub-PRBs, with a separation of M (M=m*x) sub-PRBs in between two consecutive resource blocks of the j-th interlace, and similar principle of sub-PRB based interlace design mentioned before for uniform interlace may be applied for non-uniform interlace design as well.

In some aspects, PRB-level interlace design (uniform/non-uniform) may be numerology scalable, i.e. a PRB level interlace based physical channel design for a set of numerology (sub-carrier spacing and bandwidth configuration) may be extended or scaled to another physical channel design with a different numerology (different sub-carrier spacing and/or different bandwidth configuration).

In one aspect, if the bandwidth remains the same and the sub-carrier spacing is scaled up/down in between two physical channels, the interlace design for one physical channel can be scaled accordingly to derive the interlace structure of the other physical channel.

In another aspect, if the sub-carrier spacing remains the same and the bandwidth is scaled up/down in between two physical channels, the interlace design for one physical channel can be scaled accordingly to derive the interlace structure of the other physical channel.

In another aspect, if both the bandwidth and the sub-carrier spacing in between two physical channels are scaled up/down (where both the parameters may be scaled up or down, or one can be scaled up while the other may be scaled down), the interlace design for one physical channel can be scaled accordingly to derive the interlace structure of the other physical channel.

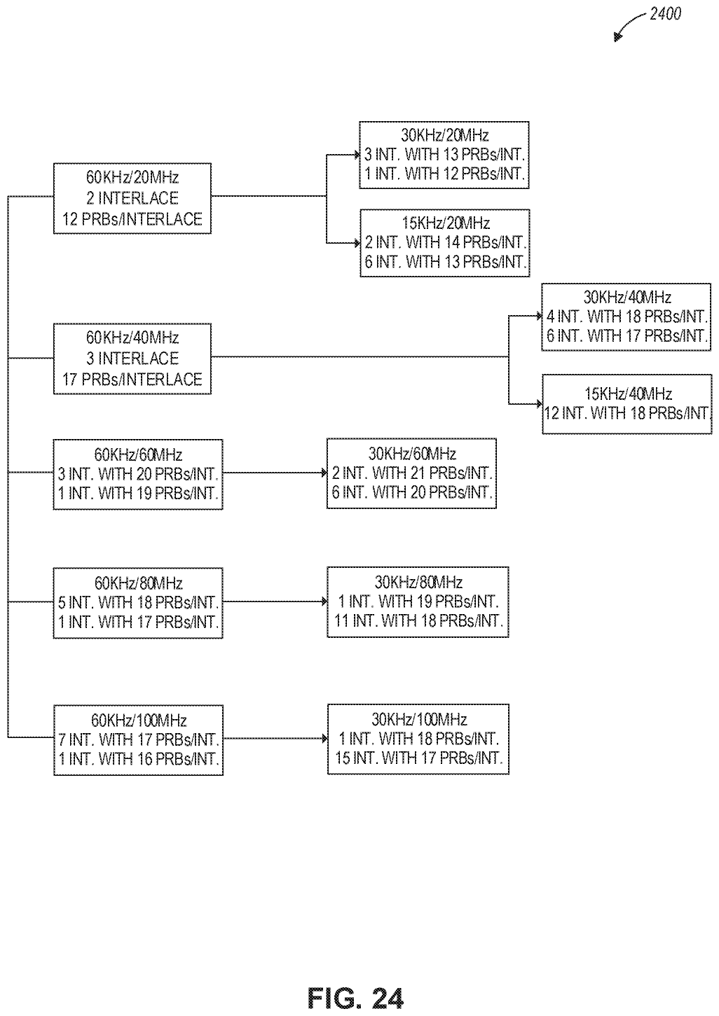

FIG. 24 illustrates an example 2400 of numerology scalable, PRB based uniform and non-uniform interlace design, in accordance with some aspects. More specifically, FIG. 24 illustrates an example of numerology scalable interlace design, where the baseline interlace design for the physical channel with sub-carrier spacing of 60 kHz and bandwidth of 20 MHz can be scaled for a different physical channel with different sub-carrier spacing (for e.g., a physical channel with the same bandwidth of 20 MHz but reduced sub-carrier spacing of 15 kHz), or different bandwidth (for e.g., a physical channel with an increased bandwidth of 40 MHz but the same sub-carrier spacing of 60 kHz), or both (for e.g. a physical channel with an increased bandwidth of 40 MHz and a reduced sub-carrier spacing of 15 kHz).

In another aspect, sub-PRB level interlace design (uniform/non-uniform) may be numerology scalable, i.e. a sub-PRB interlace based physical channel designed for a set of numerology (sub-carrier spacing and bandwidth configuration) may be extended or scaled to another physical channel design with a different numerology (different sub-carrier spacing and/or different bandwidth configuration).

In another aspect, a PRB or sub-PRB level interlace design (uniform/non-uniform) may be numerology scalable.

In some aspects, PRB-level interlace based physical channel designed for a set of numerology (sub-carrier spacing and bandwidth configuration) may be extended or scaled to another physical channel design with different numerology (different sub-carrier spacing and/or different bandwidth configuration), which may be either PRB-based or sub-PRB-based interlace design.

In some aspects, a sub-PRB level interlace based physical channel designed for a set of numerology (sub-carrier spacing and bandwidth configuration) may be extended or scaled to another physical channel design with a different numerology (different sub-carrier spacing and/or different bandwidth configuration), which may be either PRB based or sub-PRB based interlace design.

In some aspects, a system and method of wireless communication for a fifth generation (5G) or new radio (NR) system operating in unlicensed spectrum (NR-unlicensed) includes determined, by UE, a rule of resource allocation for physical uplink channels based on an interleaved frequency division multiplexing approach, hereafter referred to as interlace (the basic unit of resource allocation). Transmitted, by UE, one or more uplink signals using one or more basic units of resource allocation, in accordance with the interlace design.

In some aspects, a Block-Interleaved Frequency Division Multiple Access (B-IFDMA) based uniform interlace design consists of one interlace as the basic unit of resource allocation and a number of interleaved interlaces (indexed 0, 1, . . . , i−1) are designed for a given physical channel, where each interlace is composed of n resource blocks equally spaced in frequency domain, each consisting of x sub-carriers in the frequency domain, and the separation between two consecutive resource blocks in the frequency domain is m blocks, with each block consisting of x frequency sub-carriers, where n, m, x are integers. UE uses one or more than one of these basic units of resource allocation (or uniform interlaces) to transmit one or more than one uplink signals.

In some aspects, the parameter x is in units of physical resource block (PRB), i.e. x=12 sub-carriers or 1 PRB, such that each interlace consists of N (N=n*x) PRBs, with a separation of M (M=m*x) PRBs in between two consecutive resource blocks in an interlace, where N and M are integers. The UE uses one or more than one of these basic units of resource allocation (or PRB based uniform interlaces) to transmit one or more than one uplink signals.

In some aspects, the parameter x is in units of sub-PRB (fraction of a PRB), i.e. x=1 sub-PRB, where 1 sub-PRB=q PRB, 0<q<1. In this case, each interlace consists of N (N=n*x) sub-PRBs, with a separation of M (M=m*x) sub-PRBs in between two consecutive resource blocks of the interlace. The UE uses one or more than one of these basic units of resource allocation (or sub-PRB based uniform interlaces) to transmit one or more than one uplink signals.

In some aspects, a B-IFDMA based non-uniform interlace design consists of one interlace as the basic unit of resource allocation and a number of interleaved interlaces (indexed 0, 1, . . . , i−1) are designed for a given physical channel, where the j-th interlace (j=0, 1, . . . , i−1) is composed of nⱼ resource blocks equally spaced in frequency domain, each consisting of x sub-carriers in the frequency domain, and the separation between two consecutive resource blocks within the j-th interlace in the frequency domain is of m blocks, with each block consisting of x frequency sub-carriers. In this case, n₀, n₁, . . . , nᵢ₋₁ are not all the same, i.e. few or all of them have different values. The UE uses one or more than one of these basic units of resource allocation (or non-uniform interlaces) to transmit one or more than one uplink signals.

In some aspects, x is in units of physical resource block (PRB), i.e. x=12 sub-carriers or 1 PRB, such that j-th interlace consists of Nⱼ (Nⱼ=nⱼ*x) PRBs, with a separation of M (M=m*x) PRBs in between two consecutive resource blocks of the j-th interlace, where N_{N} and M are integers. UE uses one or more than one of these basic units of resource allocation (or PRB based non-uniform interlaces) to transmit one or more than one uplink signals.

In some aspects, x is in units of sub-PRB (fraction of a PRB). i.e. x=1 sub-PRB, where 1 sub-PRB=q PRB, 0<q<1. In this case, j-th interlace consists of Nⱼ (Nⱼ=nⱼ*x) sub-PRBs, with a separation of M (M=m*x) sub-PRBs in between two consecutive resource blocks of the j-th interlace. The UE uses one or more than one of these basic units of resource allocation (or sub-PRB based non-uniform interlaces) to transmit one or more than one uplink signals.

In some aspects, a B-IFDMA based interlace design is numerology scalable, i.e. an interlace based physical channel design for a set of numerology (sub-carrier spacing and bandwidth configuration) is extended or scaled to another physical channel design with a different numerology (different sub-carrier spacing and/or different bandwidth configuration) that the UE uses for its uplink signal transmission.

In some aspects, a PRB-level interlace design (uniform/non-uniform) is numerology scalable, i.e. a PRB-level interlace based physical channel design for a set of numerology (sub-carrier spacing and bandwidth configuration) is extended or scaled to another physical channel design with a different numerology (different sub-carrier spacing and/or different bandwidth configuration) that the UE uses for its uplink signal transmission.

In some aspects, the bandwidth remains the same and the sub-carrier spacing is scaled up/down in between the baseline numerology set and another numerology set that the UE uses for its uplink signal transmission. The interlace design for the physical channel the UE uses for its uplink signal transmission is scaled accordingly to derive the interlace structure from the interlace design of the physical channel with baseline numerology configuration.

In some aspects, the sub-carrier spacing remains the same and the bandwidth is scaled up/down in between the baseline numerology set and another numerology set that the UE uses for its uplink signal transmission. The interlace design for the physical channel the UE uses for its uplink signal transmission is scaled accordingly to derive the interlace structure from the interlace design of the physical channel with baseline numerology configuration.

In some aspects, both the bandwidth and the sub-carrier spacing are scaled up/down (where both the parameters can be scaled up or down, or one can be scaled up while the other can be scaled down) in between the baseline numerology set and another numerology set that the UE uses for its uplink signal transmission. The interlace design for the physical channel the UE uses for its uplink signal transmission is scaled accordingly to derive the interlace structure from the interlace design of the physical channel with baseline numerology configuration.

In some aspects, a sub-PRB level interlace design (uniform/non-uniform) is numerology scalable, i.e. a sub-PRB level interlace based physical channel design for a set of numerology (sub-carrier spacing and bandwidth configuration) is extended or scaled to another physical channel design with a different numerology (different sub-carrier spacing and/or different bandwidth configuration) that the UE uses for its uplink signal transmission.

In some aspects, the bandwidth remains the same and the sub-carrier spacing is scaled up/down in between the baseline numerology set and another numerology set that the UE uses for its uplink signal transmission. The interlace design for the physical channel the UE uses for its uplink signal transmission is scaled accordingly to derive the interlace structure from the interlace design of the physical channel with baseline numerology configuration.

In some aspects, the sub-carrier spacing remains the same and the bandwidth is scaled up/down in between the baseline numerology set and another numerology set that the UE uses for its uplink signal transmission. The interlace design for the physical channel the UE uses for its uplink signal transmission is scaled accordingly to derive the interlace structure from the interlace design of the physical channel with baseline numerology configuration.

In some aspects, both the bandwidth and the sub-carrier spacing are scaled up/down (where both the parameters can be scaled up or down, or one can be scaled up while the other can be scaled down) in between the baseline numerology set and another numerology set that the UE uses for its uplink signal transmission. The interlace design for the physical channel the UE uses for its uplink signal transmission is scaled accordingly to derive the interlace structure from the interlace design of the physical channel with baseline numerology configuration.

In some aspects, a PRB or sub-PRB level interlace design (uniform/non-uniform) is numerology scalable, i.e. a PRB or sub-PRB level interlace based physical channel design for a set of numerology (sub-carrier spacing and bandwidth configuration) is extended or scaled to another physical channel design with a different numerology (different sub-carrier spacing and/or different bandwidth configuration) that the UE uses for its uplink signal transmission.

In some aspects, a PRB-level interlace based physical channel designed for a set of numerology (sub-carrier spacing and bandwidth configuration) is extended or scaled to another physical channel design with a different numerology (different sub-carrier spacing and/or different bandwidth configuration), which is either PRB based or sub-PRB based interlace design.

In some aspects, the bandwidth remains the same and the sub-carrier spacing is scaled up/down in between the baseline numerology set and another numerology set that the UE uses for its uplink signal transmission. The interlace design for the physical channel the UE uses for its uplink signal transmission is scaled accordingly to derive the interlace structure from the interlace design of the physical channel with baseline numerology configuration.

In some aspects, the sub-carrier spacing remains the same and the bandwidth is scaled up/down in between the baseline numerology set and another numerology set that the UE uses for its uplink signal transmission. The interlace design for the physical channel the UE uses for its uplink signal transmission is scaled accordingly to derive the interlace structure from the interlace design of the physical channel with baseline numerology configuration.

In some aspects, both the bandwidth and the sub-carrier spacing are scaled up/down (where both the parameters can be scaled up or down, or one can be scaled up while the other can be scaled down) in between the baseline numerology set and another numerology set that the UE uses for its uplink signal transmission. The interlace design for the physical channel the UE uses for its uplink signal transmission is scaled accordingly to derive the interlace structure from the interlace design of the physical channel with baseline numerology configuration.

In some aspects, sub-PRB level interlace based physical channel designed for a set of numerology (sub-carrier spacing and bandwidth configuration) is extended or scaled to another physical channel design with different numerology (different sub-carrier spacing and/or different bandwidth configuration), which is either PRB based or sub-PRB based interlace design.

In some aspects, the bandwidth remains the same and the sub-carrier spacing is scaled up/down in between the baseline numerology set and another numerology set that the UE uses for its uplink signal transmission. The interlace design for the physical channel the UE uses for its uplink signal transmission is scaled accordingly to derive the interlace structure from the interlace design of the physical channel with baseline numerology configuration.

In some aspects, the sub-carrier spacing remains the same and the bandwidth is scaled up/down in between the baseline numerology set and another numerology set that the UE uses for its uplink signal transmission. The interlace design for the physical channel the UE uses for its uplink signal transmission is scaled accordingly to derive the interlace structure from the interlace design of the physical channel with baseline numerology configuration.

In some aspects, both the bandwidth and the sub-carrier spacing are scaled up/down (where both the parameters can be scaled up or down, or one can be scaled up while the other can be scaled down) in between the baseline numerology set and another numerology set that the UE uses for its uplink signal transmission. The interlace design for the physical channel the UE uses for its uplink signal transmission is scaled accordingly to derive the interlace structure from the interlace design of the physical channel with baseline numerology configuration.

In some aspects, a B-IFDMA based interlace design consists of one interlace as the basic unit of resource allocation and a number of interleaved interlaces (indexed 0, 1, . . . , i−1) are designed for a given physical channel, where each interlace can span 1 sub-frame in time-domain, i.e. the interlace can span 1, 2, . . . , X symbols across time domain (when a subframe corresponding to a given numerology (a set of sub-carrier spacing and bandwidth configuration) contains X symbols) and any of the methods of claim 2 to claim 25 apply to design one or more than one interleaved interlace(s) that UE uses for transmission of one or more uplink signals over a physical channel.

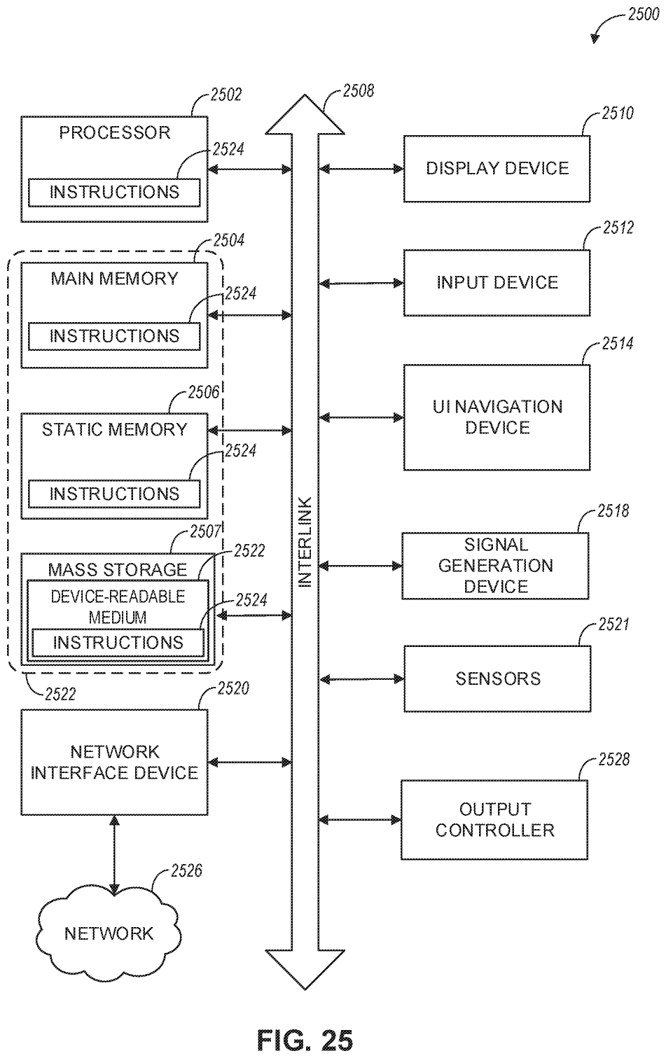

FIG. 25 illustrates a block diagram of a communication device such as an evolved Node-B (eNB), a next generation Node-B (gNB), an access point (AP), a wireless station (STA), a mobile station (MS), or a user equipment (UE), in accordance with some aspects. In alternative aspects, the communication device 2500 may operate as a standalone device or may be connected (e.g., networked) to other communication devices.

Circuitry (e.g., processing circuitry) is a collection of circuits implemented in tangible entities of the device 2500 that include hardware (e.g., simple circuits, gates, logic, etc.). Circuitry membership may be flexible over time. Circuitries include members that may, alone or in combination, perform specified operations when operating. In an example, the hardware of the circuitry may be immutably designed to carry out a specific operation (e.g., hardwired). In an example, the hardware of the circuitry may include variably connected physical components (e.g., execution units, transistors, simple circuits, etc.) including a machine-readable medium physically modified (e.g., magnetically, electrically, moveable placement of invariant massed particles, etc.) to encode instructions of the specific operation.

In connecting the physical components, the underlying electrical properties of a hardware constituent are changed, for example, from an insulator to a conductor or vice versa. The instructions enable embedded hardware (e.g., the execution units or a loading mechanism) to create members of the circuitry in hardware via the variable connections to carry out portions of the specific operation when in operation. Accordingly, in an example, the machine-readable medium elements are part of the circuitry or are communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry at a different time. Additional examples of these components with respect to the device 2500 follow.

In some aspects, the device 2500 may operate as a standalone device or may be connected (e.g., networked) to other devices. In a networked deployment, the communication device 2500 may operate in the capacity of a server communication device, a client communication device, or both in server-client network environments. In an example, the communication device 2500 may act as a peer communication device in peer-to-peer (P2P) (or other distributed) network environment. The communication device 2500 may be a UE, eNB, PC, a tablet PC, a STB, a PDA, a mobile telephone, a smartphone, a web appliance, a network router, switch or bridge, or any communication device capable of executing instructions (sequential or otherwise) that specify actions to be taken by that communication device. Further, while only a single communication device is illustrated, the term “communication device” shall also be taken to include any collection of communication devices that individually or jointly execute a set (or multiple sets) of instructions to perform any one or more of the methodologies discussed herein, such as cloud computing, software as a service (SaaS), and other computer cluster configurations.

Examples, as described herein, may include, or may operate on, logic or a number of components, modules, or mechanisms. Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a communication device-readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

Communication device (e.g., UE) 2500 may include a hardware processor 2502 (e.g., a central processing unit (CPU), a graphics processing unit (GPU), a hardware processor core, or any combination thereof), a main memory 2504, a static memory 2506, and mass storage 2507 (e.g., hard drive, tape drive, flash storage, or other block or storage devices), some or all of which may communicate with each other via an interlink (e.g., bus) 2508.

The communication device 2500 may further include a display device 2510, an alphanumeric input device 2512 (e.g., a keyboard), and a user interface (UI) navigation device 2514 (e.g., a mouse). In an example, the display device 2510, input device 2512 and UI navigation device 2514 may be a touch screen display. The communication device 2500 may additionally include a signal generation device 2518 (e.g., a speaker), a network interface device 2520, and one or more sensors 2521, such as a global positioning system (GPS) sensor, compass, accelerometer, or other sensors. The communication device 2500 may include an output controller 2528, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 2507 may include a communication device-readable medium 2522, on which is stored one or more sets of data structures or instructions 2524 (e.g., software) embodying or utilized by any one or more of the techniques or functions described herein. In some aspects, registers of the processor 2502, the main memory 2504, the static memory 2506, and/or the mass storage 2507 may be, or include (completely or at least partially), the device-readable medium 2522, on which is stored the one or more sets of data structures or instructions 2524, embodying or utilized by any one or more of the techniques or functions described herein. In an example, one or any combination of the hardware processor 2502, the main memory 2504, the static memory 2506, or the mass storage 2516 may constitute the device-readable medium 2522.

As used herein, the term “device-readable medium” is interchangeable with “computer-readable medium” or “machine-readable medium”. While the communication device-readable medium 2522 is illustrated as a single medium, the term “communication device-readable medium” may include a single medium or multiple media (e.g., a centralized or distributed database, and/or associated caches and servers) configured to store the one or more instructions 2524.

The term “communication device-readable medium” may include any medium that is capable of storing, encoding, or carrying instructions (e.g., instructions 2524) for execution by the communication device 2500 and that causes the communication device 2500 to perform any one or more of the techniques of the present disclosure, or that is capable of storing, encoding or carrying data structures used by or associated with such instructions. Non-limiting communication device-readable medium examples may include solid-state memories and optical and magnetic media. Specific examples of communication device-readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks. In some examples, communication device-readable media may include non-transitory communication device-readable media. In some examples, communication device-readable media may include communication device-readable media that is not a transitory propagating signal.

The instructions 2524 may further be transmitted or received over a communications network 2526 using a transmission medium via the network interface device 2520 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, among others. In an example, the network interface device 2520 may include one or more physical jacks (e.g., Ethernet, coaxial, or phone jacks) or one or more antennas to connect to the communications network 2526. In an example, the network interface device 2520 may include a plurality of antennas to wirelessly communicate using at least one of single-input multiple-output (SIMO), MIO, or multiple-input single-output (MISO) techniques. In some examples, the network interface device 2520 may wirelessly communicate using Multiple User MIMO techniques.

The term “transmission medium” shall be taken to include any intangible medium that is capable of storing, encoding or carrying instructions for execution by the communication device 2500, and includes digital or analog communications signals or another intangible medium to facilitate communication of such software. In this regard, a transmission medium in the context of this disclosure is a device-readable medium.

### ADDITIONAL NOTES AND EXAMPLES

Example 1 is an apparatus of a user equipment (UE), the apparatus comprising: processing circuitry, wherein to configure the UE for New Radio (NR) unlicensed band (NR-U) communications, the processing circuitry is to: decode downlink control information (DCI) received via a physical downlink control channel (PDCCH), the DCI providing allocation of uplink frequency resources of a transmission bandwidth, wherein the allocation is a block interleaved frequency division multiple access (B-IFDMA) allocation including a plurality of interleaved physical resource blocks (PRBs) forming M number of interlaces within the transmission bandwidth, and N number of PRBs within each interlace of the M number of interlaces, with N and M being integers greater than or equal to 1; and encode data for transmission to a base station via a physical uplink shared channel (PUSCH) using the B-IFDMA allocation of uplink frequency resources; and memory coupled to the processing circuitry, the memory configured to store the DCI.

In Example 2, the subject matter of Example 1 includes, wherein each PRB of the N number of PRBs includes 12 sub-carriers in frequency domain.

In Example 3, the subject matter of Examples 1-2 includes, wherein the processing circuitry is to: encode the data for transmission on the PUSCH using a portion of the uplink frequency resources associated with a first interlace of the M number of interlaces, wherein at least a second interlace of the M number of interlaces includes uplink frequency resources for a second UE.

In Example 4, the subject matter of Examples 1-3 includes, wherein the processing circuitry is to: encode uplink control information (UCI) for transmission to the base station on a physical uplink control channel (PUCCH) using the B-IFDMA allocation of uplink frequency resources.

In Example 5, the subject matter of Examples 1-4 includes, wherein each PRB of the N number of PRBs is based on 15 kHz sub-carrier spacing (SCS), the uplink frequency resources are based on 10 interlaces (or M=10) within the transmission bandwidth, with each interlace having 10 PRBs (or N=10) or 11 PRBs (or N=11).

In Example 6, the subject matter of Examples 1-5 includes, wherein each PRB of the N number of PRBs is based on 30 kHz SCS, the uplink frequency resources are based on 5 interlaces (or M=5) within the transmission bandwidth, with each interlace having 10 PRBs (or N=10) or 11 PRBs (or N=11).

In Example 7, the subject matter of Examples 1-6 includes, wherein the transmission bandwidth is one of the following: a 20 MHz bandwidth, a 40 MHz bandwidth, a 60 MHz bandwidth, an 80 MHz bandwidth, and a 100 MHz bandwidth.

In Example 8, the subject matter of Examples 1-7 includes, wherein each interlace of the M number of interlaces includes a plurality of sub-PRBs, wherein a PRB includes 12 sub-carriers in frequency domain and each sub-PRB of the plurality of sub-PRBs includes a fraction (q*PRB) of the PRB, where 0<q<1, with less than 12 sub-carriers.

In Example 9, the subject matter of Examples 1-8 includes, wherein a number of PRBs within a first interlace of the M number of interlaces is different from a number of PRBs within a second interlace of the M number of interlaces.

In Example 10, the subject matter of Examples 1-9 includes, transceiver circuitry coupled to the processing circuitry; and, one or more antennas coupled to the transceiver circuitry.

Example 11 is a non-transitory computer-readable storage medium that stores instructions for execution by one or more processors of a base station (BS) operating in a 5G network, the instructions to configure the one or more processors for New Radio (NR) unlicensed band (NR-U) communications and to cause the BS to: encode downlink control information (DCI) for transmission to a user equipment (UE) via a physical downlink control channel (PDCCH), the DCI providing allocation of uplink frequency resources of a transmission bandwidth, wherein the allocation is a block interleaved frequency division multiple access (B-IFDMA) allocation including a plurality of interleaved physical resource blocks (PRBs) forming M number of interlaces within the transmission bandwidth, and N number of PRBs within each interlace of the M number of interlaces, with N and M being integers greater than or equal to 1; and decode data received from the UE via a physical uplink shared channel (PUSCH) using the B-IFDMA allocation of uplink frequency resources indicated by the DCI.

In Example 12, the subject matter of Example 11 includes, wherein the instructions further configure the one or more processors to cause the BS to: decode the data received from the UE using a portion of the uplink frequency resources associated with a first interlace of the M number of interlaces, wherein at least a second interlace of the M number of interlaces includes uplink frequency resources for a second UE.

In Example 13, the subject matter of Examples 11-12 includes, wherein the instructions further configure the one or more processors to cause the BS to: decode uplink control information (UCI) received from the UE via a physical uplink control channel (PUCCH) using the B-IFDMA allocation of uplink frequency resources.

In Example 14, the subject matter of Examples 11-13 includes, wherein each PRB of the N number of PRBs is based on 15 kHz sub-carrier spacing (SCS), the uplink frequency resources are based on 10 interlaces (or M=) within the transmission bandwidth, with each interlace having 10 PRBs (or N=10) or 11 PRBs (or N=11).

In Example 15, the subject matter of Examples 11-14 includes, wherein each PRB of the N number of PRBs is based on 30 kHz SCS, the uplink frequency resources are based on 5 interlaces (or M=5) within the transmission bandwidth, with each interlace having 10 PRBs (or N=10) or 11 PRBs (or N=11).

Example 16 is a computer-readable storage medium that stores instructions for execution by one or more processors of a user equipment (UE), the instructions to configure the one or more processors for New Radio (NR) unlicensed band (NR-U) communications and to cause the BS to cause the UE to: decode downlink control information (DCI) received via a physical downlink control channel (PDCCH), the DCI providing allocation of uplink frequency resources of a transmission bandwidth, wherein the allocation is a block interleaved frequency division multiple access (B-IFDMA) allocation including a plurality of interleaved physical resource blocks (PRBs) forming M number of interlaces within the transmission bandwidth, and N number of PRBs within each interlace of the M number of interlaces, with N and M being integers greater than or equal to 1; and encode data for transmission to a base station via a physical uplink shared channel (PUSCH) using the B-IFDMA allocation of uplink frequency resources.

In Example 17, the subject matter of Example 16 includes, wherein the instructions further configure the one or more processors to cause the UE to: encode the data for transmission on the PUSCH using a portion of the uplink frequency resources associated with a first interlace of the M number of interlaces, wherein at least a second interlace of the M number of interlaces includes uplink frequency resources for a second UE.

In Example 18, the subject matter of Examples 16-17 includes, wherein the instructions further configure the one or more processors to cause the UE to: encode uplink control information (UCI) for transmission to the base station on a physical uplink control channel (PUCCH) using the B-IFDMA allocation of uplink frequency resources.

In Example 19, the subject matter of Examples 16-18 includes, wherein each PRB of the N number of PRBs is based on 15 kHz sub-carrier spacing (SCS), the uplink frequency resources are based on 10 interlaces (or M=) within the transmission bandwidth, with each interlace having 10 PRBs (or N=10) or 11 PRBs (or N=11).

In Example 20, the subject matter of Examples 16-19 includes, wherein each PRB of the N number of PRBs is based on 30 kHz SCS, the uplink frequency resources are based on 5 interlaces (or M=5) within the transmission bandwidth, with each interlace having 10 PRBs (or N=10) or 11 PRBs (or N=11).

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

Although an aspect has been described with reference to specific example aspects, it will be evident that various modifications and changes may be made to these aspects without departing from the broader scope of the present disclosure. Accordingly, the specification and drawings are to be regarded in an illustrative rather than a restrictive sense. The accompanying drawings that form a part hereof show, by way of illustration, and not of limitation, specific aspects in which the subject matter may be practiced. The aspects illustrated are described in sufficient detail to enable those skilled in the art to practice the teachings disclosed herein. Other aspects may be utilized and derived therefrom, such that structural and logical substitutions and changes may be made without departing from the scope of this disclosure. This Detailed Description, therefore, is not to be taken in a limiting sense, and the scope of various aspects is defined only by the appended claims, along with the full range of equivalents to which such claims are entitled.

Such aspects of the inventive subject matter may be referred to herein, individually and/or collectively, merely for convenience and without intending to voluntarily limit the scope of this application to any single aspect or inventive concept if more than one is in fact disclosed. Thus, although specific aspects have been illustrated and described herein, it should be appreciated that any arrangement calculated to achieve the same purpose may be substituted for the specific aspects shown. This disclosure is intended to cover any and all adaptations or variations of various aspects. Combinations of the above aspects, and other aspects not specifically described herein, will be apparent to those of skill in the art upon reviewing the above description.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single aspect for the purpose of streamlining the disclosure. This method of disclosure is not to be interpreted as reflecting an intention that the claimed aspects require more features than are expressly recited in each claim. Rather, as the following claims reflect, inventive subject matter lies in less than all features of a single disclosed aspect. Thus the following claims are hereby incorporated into the Detailed Description, with each claim standing on its own as a separate aspect.

What is claimed is:

1. An apparatus of a user equipment (UE), the apparatus comprising:
processing circuitry, wherein to configure the UE for New Radio (NR) unlicensed band (NR-U) communications, the processing circuitry is to:
decode downlink control information (DCI) received via a physical downlink control channel (PDCCH), the DCI providing allocation of uplink frequency resources of a transmission bandwidth, wherein the allocation is a block interleaved frequency division multiple access (B-IFDMA) allocation including a plurality of interleaved physical resource blocks (PRBs) forming an M number of interlaces within the transmission bandwidth, and an N number of PRBs within each interlace of the M number of interlaces, with N and M being integers greater than or equal to 1; and
encode data for transmission to a base station via a physical uplink shared channel (PUSCH) using the B-IFDMA allocation of uplink frequency resources; and
memory coupled to the processing circuitry, the memory configured to store the DCI.

2. The apparatus of claim 1, wherein each PRB of the N number of PRBs includes 12 consecutive sub-carriers in frequency domain.

3. The apparatus of claim 1, wherein the processing circuitry is to:
encode the data for transmission on the PUSCH using a portion of the uplink frequency resources associated with a first interlace of the M number of interlaces, wherein at least a second interlace of the M number of interlaces includes uplink frequency resources for a second UE.

4. The apparatus of claim 1, wherein the processing circuitry is to:
encode uplink control information (UCI) for transmission to the base station on a physical uplink control channel (PUCCH) using the B-IFDMA allocation of uplink frequency resources; and
encode a sounding reference signal (SRS) for transmission to the base station using the B-IFDMA allocation of uplink frequency resources.

5. The apparatus of claim 1, wherein each PRB of the N number of PRBs is based on 15 kHz sub-carrier spacing (SCS), the uplink frequency resources are based on 10 interlaces (or M=10) within the transmission bandwidth, with each interlace having 10 PRBs (or N=10) or 11 PRBs (or N=11).

6. The apparatus of claim 1, wherein each PRB of the N number of PRBs is based on 30 kHz SCS, the uplink frequency resources are based on 5 interlaces (or M=5) within the transmission bandwidth, with each interlace having 10 PRBs (or N=10) or 11 PRBs (or N=11).

7. The apparatus of claim 1, wherein the transmission bandwidth is one of the following: a 20 MHz bandwidth, a 40 MHz bandwidth, a 60 MHz bandwidth, an 80 MHz bandwidth, and a 100 MHz bandwidth.

8. The apparatus of claim 1, wherein each interlace of the M number of interlaces includes a plurality of sub-PRBs, wherein a PRB includes 12 consecutive sub-carriers in frequency domain and each sub-PRB of the plurality of sub-PRBs includes a fraction (q*PRB) of the PRB, where 0<q<1, with less than 12 sub-carriers.

9. The apparatus of claim 1, wherein a number of PRBs within a first interlace of the M number of interlaces is different from a number of PRBs within a second interlace of the M number of interlaces.

10. The apparatus of claim 1, further comprising transceiver circuitry coupled to the processing circuitry; and, one or more antennas coupled to the transceiver circuitry.

11. A non-transitory computer-readable storage medium that stores instructions for execution by one or more processors of a base station (BS) operating in a 5G network, the instructions to configure the one or more processors for New Radio (NR) unlicensed band (NR-U) communications and to cause the BS to:
encode downlink control information (DCI) for transmission to a user equipment (UE) via a physical downlink control channel (PDCCH), the DCI providing allocation of uplink frequency resources of a transmission bandwidth, wherein the allocation is a block interleaved frequency division multiple access (B-IFDMA) allocation including a plurality of interleaved physical resource blocks (PRBs) forming M number of interlaces within the transmission bandwidth, and N number of PRBs within each interlace of the M number of interlaces, with N and M being integers greater than or equal to 1; and
decode data received from the UE via a physical uplink shared channel (PUSCH) using the B-IFDMA allocation of uplink frequency resources indicated by the DCI.

12. The computer-readable storage medium of claim 11, wherein the instructions further configure the one or more processors to cause the BS to:
decode the data received from the UE using a portion of the uplink frequency resources associated with a first interlace of the M number of interlaces, wherein at least a second interlace of the M number of interlaces includes uplink frequency resources for a second UE.

13. The computer-readable storage medium of claim 11, wherein the instructions further configure the one or more processors to cause the BS to:
decode uplink control information (UCI) received from the UE via a physical uplink control channel (PUCCH) using the B-IFDMA allocation of uplink frequency resources.

14. The computer-readable storage medium of claim 11, wherein each PRB of the N number of PRBs is based on 15 kHz sub-carrier spacing (SCS), the uplink frequency resources are based on 10 interlaces (or M=10) within the transmission bandwidth, with each interlace having 10 PRBs (or N=10) or 11 PRBs (or N=11).

15. The computer-readable storage medium of claim 11, wherein each PRB of the N number of PRBs is based on 30 kHz SCS, the uplink frequency resources are based on 5 interlaces (or M=5) within the transmission bandwidth, with each interlace having 10 PRBs (or N=10) or 11 PRBs (or N=11).

16. A computer-readable storage medium that stores instructions for execution by one or more processors of a user equipment (UE), the instructions to configure the one or more processors for New Radio (NR) unlicensed band (NR-U) communications and to cause the BS to cause the UE to:
decode downlink control information (DCI) received via a physical downlink control channel (PDCCH), the DCI providing allocation of uplink frequency resources of a transmission bandwidth, wherein the allocation is a block interleaved frequency division multiple access (B-IFDMA) allocation including a plurality of interleaved physical resource blocks (PRBs) forming M number of interlaces within the transmission bandwidth, and N number of PRBs within each interlace of the M number of interlaces, with N and M being integers greater than or equal to 1; and
encode data for transmission to a base station via a physical uplink shared channel (PUSCH) using the B-IFDMA allocation of uplink frequency resources.

17. The computer-readable storage medium of claim 16, wherein the instructions further configure the one or more processors to cause the UE to:
encode the data for transmission on the PUSCH using a portion of the uplink frequency resources associated with a first interlace of the M number of interlaces, wherein at least a second interlace of the M number of interlaces includes uplink frequency resources for a second UE.

18. The computer-readable storage medium of claim 16, wherein the instructions further configure the one or more processors to cause the UE to:
encode uplink control information (UCI) for transmission to the base station on a physical uplink control channel (PUCCH) using the B-IFDMA allocation of uplink frequency resources.

19. The computer-readable storage medium of claim 16, wherein each PRB of the N number of PRBs is based on 15 kHz sub-carrier spacing (SCS), the uplink frequency resources are based on 10 interlaces (or M=10) within the transmission bandwidth, with each interlace having 10 PRBs (or N=10) or 11 PRBs (or N=11).

20. The computer-readable storage medium of claim 16, wherein each PRB of the N number of PRBs is based on 30 kHz SCS, the uplink frequency resources are based on 5 interlaces (or M=5) within the transmission bandwidth, with each interlace having 10 PRBs (or N=10) or 11 PRBs (or N=11).
